(19) United States
(12) Patent Application Publication
(10) Pub. No.: US 2016/0029155 A1
(43) Pub. Date: Jan. 28, 2016

(54) CONTEXT AWARE RELEVANCE ENGINE WITH CLIENT-DRIVEN NARRATIVE

(71) Applicants: Michael A. Kerr, Reno, NV (US); David Stewart, Stateline, NV (US)

(72) Inventors: Michael A. Kerr, Reno, NV (US); David Stewart, Stateline, NV (US)

(73) Assignee: NEXRF, Corp., Reno, NV (US)

(21) Appl. No.: 13/841,515

(22) Filed: Mar. 15, 2013

Related U.S. Application Data
(63) Continuation-in-part of application No. 13/252,159, filed on Oct. 3, 2011.
Application No. 13/252,159 is a continuation-in-part of application No. 13/218,256, filed on Aug. 25, 2011.
Application No. 13/218,256 is a continuation-in-part of application No. 13/153,214, filed on Jun. 3, 2011.
Application No. 13/153,214 is a continuation-in-part of application No. 13/153,238, filed on Jun. 3, 2011.
Application No. 13/153,238 is a continuation-in-part of application No. 13/153,248, filed on Jun. 3, 2011.
Application No. 13/153,248 is a continuation-in-part of application No. 12/821,852, filed on Jun. 23, 2010, now Pat. No. 8,738,024.
Application No. 12/821,852 is a continuation-in-part of application No. 12/413,547, filed on Mar. 28, 2009, now Pat. No. 8,942,995.
Application No. 12/413,547 is a continuation-in-part of application No. 11/948,007, filed on Nov. 30, 2007.
Application No. 11/948,007 is a continuation-in-part of application No. 10/681,034, filed on Oct. 8, 2003, now Pat. No. 8,403,755.
Application No. 10/681,034 is a continuation of application No. 09/899,559, filed on Jul. 5, 2001, now abandoned.
(60) Provisional application No. 61/482,834, filed on May 5, 2011.
(60) Provisional application No. 61/427,753, filed on Dec. 28, 2010.
(60) Provisional application No. 61/427,755, filed on Dec. 28, 2010.
(60) Provisional application No. 61/454,664, filed on Mar. 21, 2011.
(60) Provisional application No. 61/472,054, filed on Apr. 5, 2011.
(60) Provisional application No. 61/376,936, filed on Aug. 25, 2010.
(60) Provisional application No. 61/351,677, filed on Jun. 4, 2010.
(60) Provisional application No. 61/351,770, filed on Jun. 4, 2010.
(60) Provisional application No. 61/352,242, filed on Jun. 7, 2010.
(60) Provisional application No. 61/351,677, filed on Jun. 4, 2010.
(60) Provisional application No. 61/351,770, filed on Jun. 4, 2010.
(60) Provisional application No. 61/352,242, filed on Jun. 7, 2010.
(60) Provisional application No. 61/351,677, filed on Jun. 4, 2010.
(60) Provisional application No. 61/351,770, filed on Jun. 4, 2010.
(60) Provisional application No. 61/352,242, filed on Jun. 7, 2010.
(60) Provisional application No. 61/223,565, filed on Jul. 7, 2009.
(60) Provisional application No. 61/040,661, filed on Mar. 29, 2008.
(60) Provisional application No. 60/872,351, filed on Nov. 30, 2006.
(60) Provisional application No. 60/266,956, filed on Feb. 6, 2001.

(51) Int. Cl. H04W 4/02

(52) U.S. Cl. CPC H04W 4/02

(57) ABSTRACT

A context aware relevance engine with a client-driven narrative is presented as a system for serving relevant content that includes a wireless device, a server, a positioning module, a user profile module, a content module, a ranking module, a content delivery module, a wireless device display, and a responsive input is described. The wireless device wirelessly communicates with a network and the wireless device is configured to download a software application module or a web browser.

### CROSS-REFERENCE

This patent application is a continuation-in-part of patent application Ser. No. 13/252,159 entitled TARGETED CONTENT DELIVERY filed on Oct. 3, 2011, which claims the benefit of provisional patent application 61/482,834 entitled CONTENT RELEVANCE WEIGHTING SYSTEM filed on May 5, 2011, provisional patent application 61/427,753 entitled INTERACTIVE DISPLAY SYSTEM filed on Dec. 28, 2010, provisional patent application 61/427,755 entitled INTERACTIVE DISPLAY SYSTEM filed on Dec. 28, 2010, provisional patent application 61/454,664 entitled USER INTERFACE FOR GEOFENCE-ASSOCIATED CONTENT filed on Mar. 21, 2011, and provisional patent application 61/472,054 entitled CONTENT RELEVANCE WEIGHTING SYSTEM filed on Apr. 5, 2011;

This patent application is a continuation-in-part of patent application Ser. No. 13/218,256 entitled SYSTEM AND METHOD FOR HANDSET POSITIONING WITH DYNAMICALLY UPDATED WI-FI FINGERPRINTING filed on Aug. 25, 2011 that claims the benefit of provisional patent application 61/376,936 filed on Aug. 25, 2010, provisional patent application 61/351,770 filed on Jun. 4, 2010, and provisional patent application 61/352,242 filed on Jun. 7, 2010;

This patent application is a continuation-in-part of patent application Ser. No. 13/153,214 entitled MERCHANT CONTROLLED PLATFORM SYSTEM AND METHOD filed on Jun. 3, 2011 that claims the benefit of provisional patent application 61/351,677 filed on Jun. 4, 2010, provisional patent application 61/351,770 filed on Jun. 4, 2010, and provisional patent application 61/352,242 filed on Jun. 7, 2010;

This patent application is a continuation-in-part of patent application Ser. No. 13/153,238 entitled MERCHANT CONTROL PLATFORM SYSTEM AND METHOD WITH LOCATION-BASED CONTENT DELIVERY filed on Jun. 3, 2011 that claims the benefit of provisional patent application 61/351,677 filed on Jun. 4, 2010, provisional patent application 61/351,770 filed on Jun. 4, 2010, and provisional patent application 61/352,242 filed on Jun. 7, 2010;

This patent application is a continuation-in-part of patent application of patent application Ser. No. 13/153,248 entitled LOCATION POSITIONING ENGINE SYSTEM AND METHOD filed on Jun. 3, 2011 that claims the benefit of the benefit of provisional patent application 61/351,677 filed on Jun. 4, 2010, provisional patent application 61/351,770 filed on Jun. 4, 2010, and provisional patent application 61/352,242 filed on Jun. 7, 2010;

This patent application is a continuation-in-part of patent application Ser. No. 12/821,852 entitled MOBILE AUTONOMOUS DYNAMIC GRAPHICAL USER INTERFACE APPLICATION FRAMEWORK filed on Jun. 23, 2010 that claims the benefit of provisional patent application 61/223,565 filed on Jul. 7, 2009;

This patent application is a continuation-in-part of patent application Ser. No. 12/413,547 entitled MOBILE AUTONOMOUS DYNAMIC GRAPHICAL USER INTERFACE filed on Mar. 28, 2009 that claims the benefit of provisional patent application 61/040,661 filed on Mar. 29, 2008;

This patent application is a continuation in part of non-provisional patent application Ser. No. 11/948,007 entitled PLAYER TRACKING USING A WIRELESS DEVICE FOR A CASINO PROPERTY filed on Nov. 30, 2007 that claims the benefit of provisional patent application 60/872,351 filing Nov. 30, 2006;

This patent application is a continuation-in-part of non-provisional application Ser. No. 10/681,034 entitled WIRELESS BROADBAND GAMING SYSTEM AND METHOD filed on Oct. 8, 2003 which is a continuation of non-provisional application Ser. No. 09/899,559 entitled BIOMETRIC BROADBAND GAMING SYSTEM AND METHOD filed on Jul. 5, 2001, now abandoned, which claims the benefit of provisional application 60/266,956, filed Feb. 6, 2001; and

the above patent applications are hereby incorporated by reference in this patent application.

### FIELD

The present invention relates to a context aware relevance engine with a client-driven narrative that delivers relevant content to a wireless device. More particularly, the present invention relates to a system and method for serving relevant to content to a wireless device that can run a web browser or a downloaded software application module.

### BACKGROUND

SoLoMo (Social, Local and Mobile) is the union of social networking with local-based businesses and companies through the power of mobile marketing. Having a mobile website and presence has become mandatory for local businesses in order to connect to customers in the businesses' immediate area. The magnitude of users and engagement levels on social media sites like Twitter and Facebook have steadily increased over the last few years. As of 2012, Twitter has approximately 140 million United States users and Facebook has 845 million active users monthly.

The power of location-based marketing is the driving force behind this SoLoMo. When customers provide their address or let a company know their location from a tablet or smartphone, they receive location-based marketing through mobile advertisements or local deals on websites like Groupon, Living Social, Google Offers or SCVNGR. It is estimated that 70 million mobile coupons worth a total of $2.4 billion will be used in 2013, a significant increase from 200,000 used in 2009.

Additionally, the smartphone revolution is causing an indelible impact on brick-and-mortar retail stores and casinos. With respect to retail, “showrooming” is proving to be one of the great challenges affecting the brick-and-mortar bottom line. E-commerce sales continue to increase, e.g. +15.8% Q4 2012 sales compared to Q4 2011 sales, even though e-commerce sales only accounted for 5.2% of total sales ($4.4 T in US).

Casino properties are also being impacted. For brick-and-mortar casino properties, the recent 2011 Department of Justice opinion marks the beginning of the Internet Gaming movement in the United States. As a result, brick-and-mortar casino properties have to develop an iGaming strategy that includes “app” development and smartphone integration.

However, the problem with these mobile apps and searchable content is that the end user is being bombarded with too much information. Thus, smartphone users are not spending markedly more time with apps: 39 minutes a day in 2012 and 37 minutes a day in 2011. Apple has 775,000 apps in its app store and Google Play is catching up, but few of those apps capture any meaningful share of consumer attention.

Mobile devices and content continue to multiply, so the question becomes: How can mobile marketers prioritize content in an ocean of too much information? Simply put, marketers must turn to context.

But context is hard to find in a mobile setting. For example, context does not really exist in mobile search. Mobile search is a “pull” based process that requires inputting text, waiting for a response, and repeating this cycle until relevant content is identified. All this takes time and luck because user profile(s) and present conditions are not factored into the search.

Behavioral targeting within mobile search is valuable. Knowing what a customer has recently browsed, watched and bought online is definitely useful. However, behavioral targeting is just about past behavior and, again, fails to take into consideration the conditions and circumstances that are relevant to a mobile user, namely, the present conditions (or values) and a variety of user profiles.

As a gap filling measure marketers have started relying on opinions from “friends” within their social network. However, these opinions are generally not relevant to a user's present activity and current location. They also do not take into consideration the conditions and circumstances that are relevant based on time, user profile, current interests, and recommendations.

Thus, content (including interactive content) must evolve and become context driven or context aware.

### SUMMARY

A system for serving relevant content that includes a wireless device, a server, a positioning module, a user profile module, a content module, a content ranking module, a content delivery module, a wireless device display, and a responsive input is described. The wireless device wirelessly communicates with a network and the wireless device is configured to download a software application module or a web browser.

The server is communicatively coupled to the wireless device via the network and the server authenticates the wireless device or the web browser. The positioning module integrated with the wireless device determines a location for the wireless device or the web browser.

The user profile module integrated with the wireless device may include at least one user attribute that is associated with each particular user. The user profile may also include at least one user attribute that is associated with the wireless device or the web browser. The content module stored on the wireless device serves at least one content link that is associated with a content item.

The ranking content module integrated with the wireless device ranks each content link based on location of the wireless device and the user profile. Additionally, the ranking content module may rank each content link based on user profile and the location of the web browser.

The content delivery module integrated with the wireless device to deliver the ranked content links to the software application module or the web browser. The wireless device display presents the ranked content links in the software application module or as a web page in the web browser.

The responsive input received by the wireless device corresponding to one of the content links results in displaying the corresponding content item. The server periodically updates the software application module or the web browser with an updated positioning module, an updated content module, an updated user profile module, an updated ranking module, or any combination thereof.

A method for serving relevant content is also described. The method includes enabling a wireless device to wirelessly communicate with a network. The wireless device runs at least one of a software application module and a web browser. The method then proceeds to communicatively coupling at least one server to the wireless device via the network, wherein the server authenticates at least one of the wireless device and the web browser. The method determines the location of the wireless device with a positioning module disposed on the wireless device. The method associates a user profile with at least one of the wireless device and the web browser, wherein the user profiles are stored in a user profile module and each user profile includes at least one user attribute. The method enables a content module to communicate at least one content link that describes a content item. The method then proceeds to rank each content link based on location of the wireless device and the user profile. The ranked content links are delivered to either the software application module, the web browser, or both. The wireless device displays the ranked content links. A responsive input is received at the wireless device that corresponds to one of the content links. The responsive input received by either software application module or web browser provides access to the corresponding content item. The wireless device periodically communicates with the server, which sends updates to the wireless device that include at least one of an updated positioning module, an updated content module, an updated user profile module, and an updated ranking module.

### FIGURES

The present invention will be more fully understood by reference to the following drawings which are for illustrative, not limiting, purposes.

FIG. 1 shows a high level system drawing of the CARE platform interfacing with various systems.

FIG. 2 shows an illustrative context aware relevance engine (CARE) platform.

FIG. 3 shows a more general representation of the contextual layers of the CARE platform.

FIG. 4 shows an illustrative cloud-based service that includes the CARE platform.

FIG. 5 shows the electrical components for an illustrative wireless device.

FIG. 6 shows a plurality of sensors that can be used to receive a responsive input that is communicated to the CARE platform.

FIG. 7 shows an illustrative system, in which the CARE platform delivers the dynamic portal content to an illustrative wireless device and enables the wireless device to control a display.

FIG. 8 show an illustrative system, in which the wireless client device generates the dynamic portal.

FIG. 9 shows an illustrative system where an illustrative gaming machine or digital signage generates the dynamic MADGUI portal and communicates the MADGUI to the server, which then passes the MADGUI to the wireless device.

FIG. 10 shows a system where a server generates the dynamic MADGUI portal and communicates the MADGUI to the client device and a networked display that is operatively coupled to a display control module.

FIG. 11A shows a diagram of an illustrative targeted content delivery system according to a first embodiment

FIG. 11B shows a diagram of an illustrative targeted content delivery system according to a second embodiment

FIG. 12 shows an illustrative content item editor of the content administration interface.

FIG. 13 shows an illustrative content association interface.

FIG. 14 shows an illustrative location interface.

FIG. 15 shows an illustrative network object placement interface.

FIG. 16 shows an illustrative geofence creation interface.

FIG. 17 shows an illustrative geofence content association interface.

FIG. 18 shows an illustrative display placement interface.

FIG. 19 shows an illustrative display geofence association interface.

FIG. 20 shows an illustrative system diagram of a beacon network based location detection system for a wireless device.

FIGS. 21A-21D show illustrative examples of wireless device location as determined from beacon signals received by the wireless device.

FIG. 22 shows an illustrative flow chart of a method for delivering targeted content to a user.

FIG. 23 shows an illustrative system diagram of a beacon and sensor network based location detection system for a wireless device.

FIG. 24 shows an illustrative system diagram of a beacon and beacon-enabled-sensor network based location detection system for a wireless device

FIG. 25 shows an illustrative virtual reference point grid.

FIG. 26 shows an illustrative virtual reference point.

FIG. 27 shows an illustrative flow chart of a method for generating virtual reference points.

FIG. 28 shows an illustrative flow chart of a method for determining the location of a wireless device using virtual reference points.

FIG. 29 shows an illustrative relevance interface.

FIG. 30 shows an illustrative database table entry for a user profile.

FIG. 31 shows an illustrative database table entry for an attribute group.

FIG. 32 shows an illustrative database table entry associating a user identification with an attribute group.

FIG. 33 shows an illustrative database table entry associating a content item with an attribute group and storing a relevance weight value for the association.

FIG. 34 shows an illustrative database table entry associating a content item with a location identifier and storing a relevance weight value for the association.

FIG. 35A shows an illustrative database table entry associating a time item with an attribute group and storing a relevance weight value for the association.

FIG. 35B shows an illustrative graph showing a change in relevance weight value for a content item over time.

FIG. 36 shows an illustrative flow chart of a method for adjusting relevance weighting according to a first embodiment is shown.

FIG. 37 shows an illustrative flow chart of a method for adjusting relevance weighting according to a second embodiment.

FIG. 38 shows an illustrative flow chart of a method for adjusting relevance weighting according to a third embodiment

FIG. 39 shows an illustrative flow chart of a method for adjusting relevance weighting according to a fourth embodiment

FIG. 40 shows an illustrative “User Content” page of the device content interface.

FIG. 41 shows an illustrative user content input page of the device content interface.

FIG. 42 shows an illustrative “Info” page of the device content interface.

FIG. 43 shows an illustrative “All” page of the device content interface.

FIG. 44 shows an illustrative map page of the device content interface.

FIG. 45 shows an illustrative user profile interface.

FIG. 46 shows a time series plot of the relevance weight for a particular content link.

FIG. 47 shows the content requests for a particular content link over a particular date range.

FIG. 48 shows a heat map of the request volume by location.

FIG. 49 shows a heat map of the content click through interaction rates by location.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure.

The context aware relevance engine (CARE) described herein serves relevant content to a user and enhances his mobile application experience by “pushing” relevant content to the end user with little or no user input. In the illustrative embodiments presented herein, the content relevance engine creates a “context-aware” experience by combining user profile(s), outdoor positioning, indoor positioning, geofencing, and tracking user interactions with an illustrative context aware relevance engine platform-as-a-service (PAAS) solution.

The context aware relevance engine (CARE) described herein supports a variety of different products or services such as a context aware news feed, which is also referred to as the MADGUI. The context aware news feed is also referred to as a “dynamic portal” that changes based on location and user profile. The CARE platform also supports an interactive digital signage capability and supports proximity-based social networking. Furthermore, the CARE platform supports integration with games of chance, games of skill, or the combination thereof.

For enterprise applications, the context aware relevance engine (CARE) enables the enterprise to control the customer experience and preserve the confidentiality of customer data. Additionally, the CARE platform may be configured to manage mobile content that changes based on indoor location and an extensive user profile. Furthermore, the CARE platform supports API system integration and protects user privacy.

The context aware relevance engine (CARE) can operate as a premises-based solution, a cloud-based solution or as a hybrid platform solution. In the illustrative enterprise embodiment, the context aware relevance engine enables the enterprise to control the customer experience and preserve the confidentiality of enterprise customer data.

In operation, the illustrative context aware relevance engine (CARE) manages mobile content and serves this content based on location (indoor or outdoor) and a user profile.

Serving relevant content in real time based on the user's task is the singular challenge the CARE platform is solving. The limitations in mobile search and mobile social can be overcome by combining user profile, indoor geofencing, outdoor geofencing, local content, and local social into a platform solution that is controlled by the end-user community and the enterprise customer.

The user community and enterprise customer are in the best position to understand the demographic profiles of their community and the CARE platform solution puts the user community and enterprise customer in control. The CARE platform has a strong reliance on indoor positioning because indoor awareness is a necessary element of the context-awareness. Note that end users spend 80% of their waking hours indoors. Indoor location awareness also provides further insight into the end user's activities and tasks. The indoor positioning engine presented herein supports building indoor geofences that are defined by end-users and enterprise customers.

The CARE platform also supports content profiling so that enterprise customers can achieve a high probability match with the user profile and indoor geofence, thereby having a high probability of serving relevant content. The CARE platform integrates with mobile social.

The result is that relevant content is delivered in real time to wireless devices and/or displays. Additionally, real-time feedback can be obtained from the wireless device and/or displays. Furthermore, the CARE platform supports adjusting the content in real-time based on end user feedback.

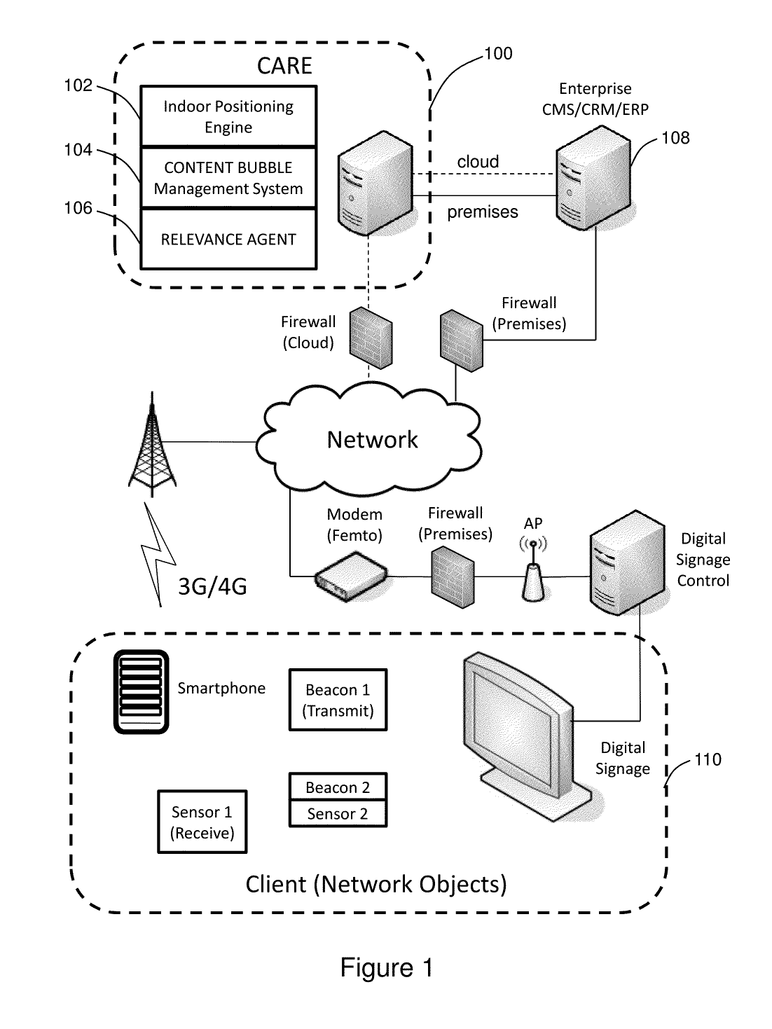

Referring now to FIG. 1, there is shown a high level system drawing of the CARE platform interfacing with various systems. The CARE platform 100 includes a positioning engine 102, a content management system 104, and a ranking module 106. The content management system associates content with a particular geofence, which is referred to as a CONTENT BUBBLE. The ranking module 106 for the illustrative embodiment is referred to as RELEVANCE AGENT.

In the illustrative embodiment, the CARE platform 100 serves real-time, relevant content to a mobile user via a mobile application based on indoor location and outdoor location, an opt-in user profile controlled by the user, content profiling including associating content with indoor geofences, and real-time feedback from users.

The CARE platform 100 is configured to interface with enterprise systems 108 such as accounting systems, enterprise resource planning systems, transactional systems, loyalty programs, customer relations management systems, billing systems, workers compensation systems, medical systems, electronic health record systems, hospital systems, security systems, calendaring systems, social networks, gaming systems, other content management systems, and other such enterprise systems.

The CARE platform 100 can exist as a cloud based system, a premises-based system, or a hybrid cloud system. When interfacing with the public Internet, the CARE platform resides behind either a cloud firewall or a premises based firewall or any combination thereof.

The CARE platform 100 communicates with various client devices, which are also referred to more generally as network objects. A network object also includes passive and/or active electronic devices that can be identified by a networked client.

The illustrative features of the CARE platform include presenting indoor maps that include the indoor position of a particular user; associating local content with particular user profiles; integrating with an existing customer relations management (CRM) system or loyalty system behind the enterprise firewall; enabling mobile users to control their privacy setting from their smartphone client; building rich user profiles with a new set of attributes derived from real-time market surveys; supporting the building of indoor CONTENT BUBBLES (indoor geofences)—so that when a CONTENT BUBBLE is pierced, content links are pushed to the user's mobile application; allowing users within a particular CONTENT BUBBLE to generate their own content; allowing users to post within the CONTENT BUBBLE without having to share these posts with large social networks; ranking property-generated content links in real time based on indoor position, user profile, and feedback from similar users with the ranking module that is also referred to as a RELEVANCE AGENT; ranking user-generated content in real time based on indoor location, user profile and feedback from similar users with the RELEVANCE AGENT; pushing relevant content links to a dynamic portal page referred to as the Mobile Autonomous Dynamic Graphical User Interface (or MADGUI)—the MADGUI™ receives the automated rankings in real time and requires little or no user input; utilizing a link management platform that leverages existing content for seamless integration with the MADGUI™ advertising platform; combining property-driven content with user-generated content based purely on relevancy; controlling digital signage from the MADGUI™ smartphone client, so a user can walk up to a networked display and control the display from the MADGUI™ smartphone client; interfacing with digital signage systems, slot machines, set-top boxes and other such display systems; and generating real time business analytics based on conversions, ratings, indoor positioning, user profiles, and user feedback.

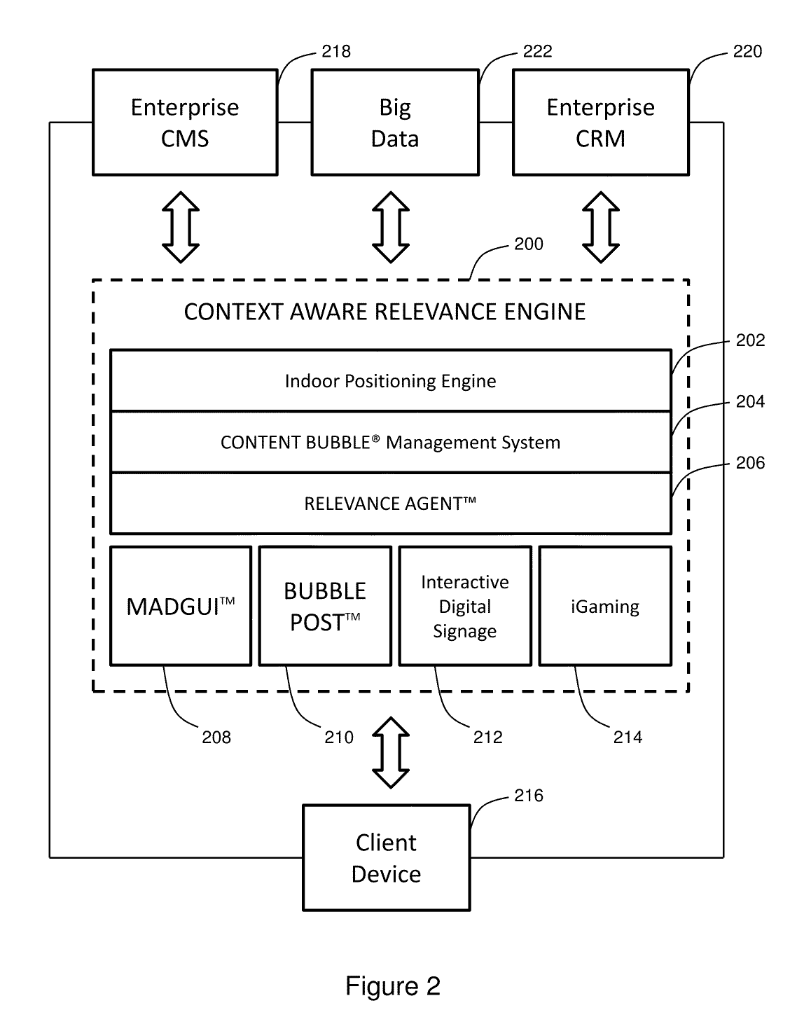

Referring to FIG. 2, there is shown an illustrative context aware relevance engine (CARE) platform. The illustrative CARE platform 200 includes a variety of different modules. The first three modules include an indoor positioning engine 202, a CONTENT BUBBLE Management System 204, and ranking module 206 referred to as a RELEVANCE AGENT.

By way of example, the indoor positioning engine 202 relies on sensor inputs. The sensor inputs may come from the user's smartphone or from an independent sensor grid. After calculating a latitude, longitude and altitude, these coordinates are overlaid on a map. The indoor positioning engine enables content administrators to generate indoor geofences, which are also referred to as a CONTENT BUBBLES.

In the illustrative embodiment, the CONTENT BUBBLE Management System (CBMS) associates content with user profiles and the appropriate CONTENT BUBBLE 204. Thus, when an end user pierces a CONTENT BUBBLE, he or she is automatically served a group of content links that are associated with his or her user profile and location. CONTENT BUBBLES can overlap and some bubbles can be created for a portion of the property or for the entire property.

The third module is a ranking module 206. The illustrative ranking module is a “click-engine” that ranks content based on the content popularity to users having similar demographic profiles. This particular ranking module is referred to as a RELEVANCE AGENT. The RELEVANCE AGENT ranks and re-ranks content based on user profile, indoor location, click-throughs, recommendations, and other user-generated feedback. In general, the ranking module may operate using more sophisticated algorithms that such as used by search engines or social network.

The Mobile Autonomous Dynamic Graphical User Interface (MADGUI) 208 is a self-governing user interface that discovers and reacts to changes with little or no user input. The MADGUI is generated by integrating the indoor positioning engine, the CONTENT BUBBLE Management System, and the RELEVANCE AGENT to determine the most relevant content to push to each user. For example, if a 30-year-old female enters a CONTENT BUBBLE in a woman's clothing store, the MADGUI™ may push a 20% off coupon to entice her to make a purchase.

The MADGUI also lets users post content within a CONTENT BUBBLE and this feature is referred to as a BUBBLE POST 210. The BUBBLE POST 210 can be shared with the user's social network or other nearby users. The BUBBLE POST supports a proximity-based social network. Depending on security concerns, the BUBBLE POST can also be treated as a highly confidential messaging solution that restricts the viewing of the BUBBLE POST by allowing only specific users within a specific CONTENT BUBBLE to view and interact with the BUBBLE POST.

Another product supported by the CARE platform is interactive digital signage 212 that does not loop the same content over and over. The CARE platform satisfies privacy concerns by enabling users to opt-in to behavioral advertising. Since the CARE platform knows the location of the MADGUI client and the location of the digital signage, highly targeted and relevant advertisements can be served up to the digital signage with appropriate user opt-in. Additionally, a unique set of links can be served up to the smartphone so the end user can control what is being viewed on the illustrative HD display from the user's smartphone.

Yet another product supported by the CARE platform includes a gaming module 214. Indoor location information may be integrated into a game, as well as relevant advertisements, and relevant user posts can be communicated to a gaming module. The feedback from the gaming module may be used to improve the content communicated to the gaming module. The game module may include a game of chance, a game of skill, or a combination thereof. By way of example and not of limitation, an internet based gaming module is described in issued U.S. Pat. No. 8,403,755, which is hereby incorporated by reference, that may also be integrated with the CARE platform. The CARE platform operates as a player tracking module that “tracks” more than just coin-in and coin-out. The CARE platform can also be used to track the player's interest and preferences so a personalized and relevant end user experience can be presented to each player.

The output from the CARE platform is communicated to client devices 216 that can be a wired client or a wireless client. In one embodiment, responsive inputs received by the client device 216 may be communicated to the Enterprise CMS 218 and the Enterprise CRM 220. The CMS 218 and the CRM 220 may then proceed to analyze the responsive inputs and modify content, trigger events, user attributes, user profiles, geofences, loyalty rewards, server states and other such operating parameters that are stored on the CARE platform. Additionally, the Enterprise CMS 218 and CRM 220 may also be operatively coupled to a big data module 222 that analyzes a large collection of data sets.

The responsive inputs received client device may also be communicated to the CARE platform and the ranking module can use the responsive inputs to re-rank content based on end user feedback.

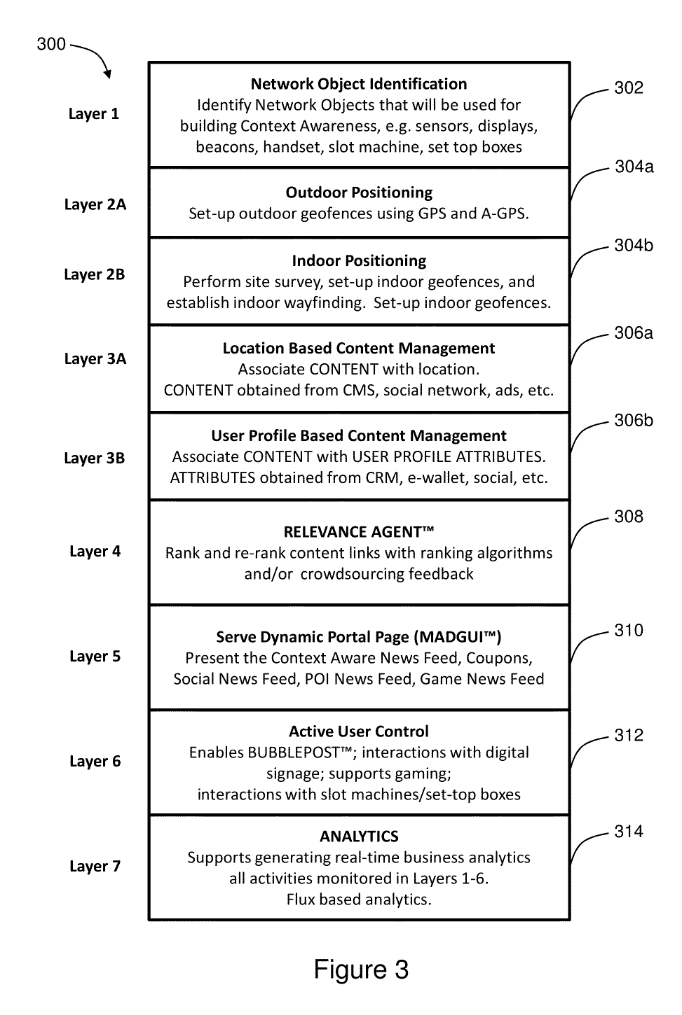

Referring to FIG. 3, there is shown a more general representation of the contextual layers of the CARE platform. The CARE platform operates either in a public/private cloud or behind the enterprise firewall. The MADGUI client UI is autonomous or self-governing so the links change with little or no user input. The CARE platform may also be interpreted as a series of contextual layers that are housed within an integrated platform.

The first contextual layer 302 identifies the network objects that will be used to build contextual awareness. A network object is a client device that has a particular identity, e.g. MAC ID, and can be identified remotely. Generally, the network object is capable of being communicatively coupled to a network such as a WAN, e.g. the Internet. Sometimes the network object is a “beacon” that communicates a beacon identifier, which can then communicated by another network object to a server capable of authenticating the network object. By way of example and not of limitation, network objects include sensors, beacons, displays, wireless devices that access a network, gaming machines, gaming consoles, slot machines, set-top boxes, and other such devices that are capable of accessing a network or devices capable of transmitting signals to networkable devices.

The second contextual layer 304 relates to positioning and is divided into outdoor positioning 304a, i.e. Layer 2A, and indoor positioning 304b, i.e. Layer 2B. The outdoor positioning 304a (Layer 2A) relies on GPS and A-GPS and generally occurs on the client-side wireless device, e.g. a smartphone. Generally, the outdoor positioning includes a navigation module to assist in car navigation.

The indoor positioning 304b includes an indoor positioning engine that is used to determine indoor location of a wireless device. The indoor positioning engine may include indoor wayfinding. In the illustrative embodiment, the indoor positioning engine includes a sensor grid that is used to build reference points similar to RF fingerprints. RF fingerprints captured by a wireless device and compared with the reference points to determine indoor location. RF fingerprinting may be performed with Wi-Fi beacon signals and Bluetooth beacon signs. The result is a latitude, longitude and altitude that can be placed on a property map. The sensor grid, which is one of the network objects, is extensible and supports adding additional sensors (such as IR sensors) or additional beacons (such as weak WiFi or Bluetooth beacons) to improve indoor accuracy.

The second contextual layer 304 also supports the generation of geofences. The geofences may be indoor geofences or outdoor geofences. The geofences or CONTENT BUBBLES may large or small and may be defined by either the end user or the enterprise customer.

The third contextual layer 306 applies a contextual overlay to existing content. In Layer 3A 306a “context” is created by associating location with “content” by either geocoding the content or associating the content with an indoor or outdoor geofence. The content can be retrieved by using a web crawler or by accessing a content management system. The content may be collected from social networks. The process of geocoding the content or associating the content with a geofence can be performed manually or using an automated algorithmic process.

For example, if the content links are generated for the corresponding content, only the content links need to be geocoded—and the wireless device can determine a perimeter within which to grab geocoded content links and to present the geocoded content links according to a ranking module that also resides on the wireless device.

In Layer 3B 306b, the context is created by taking existing content and associating the existing content with a user profile that includes a plurality of user attributes. The user attributes may be obtained from a social website or application, in which the end users elect to share their user attributes. The user attributes may also be obtained from a loyalty program, a customer relations management (CRM) system, an e-wallet, an end user's transactional history, or an end-users own preferences that are integrated into a particular software application.

When Layers 2 and 3 are combined, the result is an automated “check-in” process, in which an end-user can access content directly.

In the illustrative embodiment presented herein, context is created by combining indoor geofences (CONTENT BUBBLE®)) with content at Layer 3A, and associating the content with user attributes corresponding to a user profile in Layer 3B. A descriptive link can then be served up to the user in an automated manner that takes the user to the desired content.

The next contextual layer 308 referred to as Layer 4 includes a ranking module, which is also referred to as a RELEVANCE AGENT, that ranks content links is based on end-user feedback or feedback from the end user community. The content links may be ranked according to user profile, indoor location, click-through rate, recommendation (like, not like), and user-generated feedback. The RELEVANCE AGENT may apply search or ranking algorithms. The RELEVANCE AGENT may also rely on crowd sourcing similar user profiles and positioning to determine link popularity. As described in the further detail below, the RELEVANCE AGENT can generate a unique relevance weight for each content link or content item. Generally, the relevance weight changes as a function of time for a particular set of user attributes.

The fifth contextual layer 310 serves a dynamic portal page, which is also referred to as the MADGUI or a context aware news feed. This Layer 5 is associated with pushing relevant content links to the mobile user with little or no user input. In the illustrative embodiment, the MADGUI is self-governing and changes based on various parameters such as user profile, location of the wireless device, and real-time content rankings from the module. The MADGUI principally pushes relevant content links to the end user and may also include a search string to support “pull” based mobile search.

The sixth contextual layer 312 refers to the end user being in an “active” mode. In Layer 5, the end-user is in a more “passive” mode and the content links are pushed to the end user. In Layer 6, the end user is actively interacting with their wireless device. Generally, the active mode includes having the end user type text into the wireless device, speak into the wireless device, or take a picture with the wireless device. This active user state is referred to as a “local interaction.” In the illustrative embodiment presented herein, the local interaction includes having an end user elect to post content.

By way of example and not of limitation, the end user may decide to “post” content within a CONTENT BUBBLE. In this embodiment, active user control resides on top of the previous contextual layers. When the user shifts to active user control the user may be selecting to give feedback and rate content that has been sent to them. Thus, the active user post can be used to improve one or more of the previous contextual elements.

Another illustrative example of active user control includes enabling a user to interact with digital signage from his wireless device as described in further detail below.

The seventh contextual layer 314 is directed to analytics. Each contextual layer has a corresponding analytic that can be combined with one or more layers. For example, conversions based on indoor location can now be monitored. The number of people and user profiles in a particular geofence can now be monitored remotely without the need for cameras. The popularity of content can be monitored with relevance weighting plotted as a function of time. Active user control can also be monitored based on user profile, location, and context.

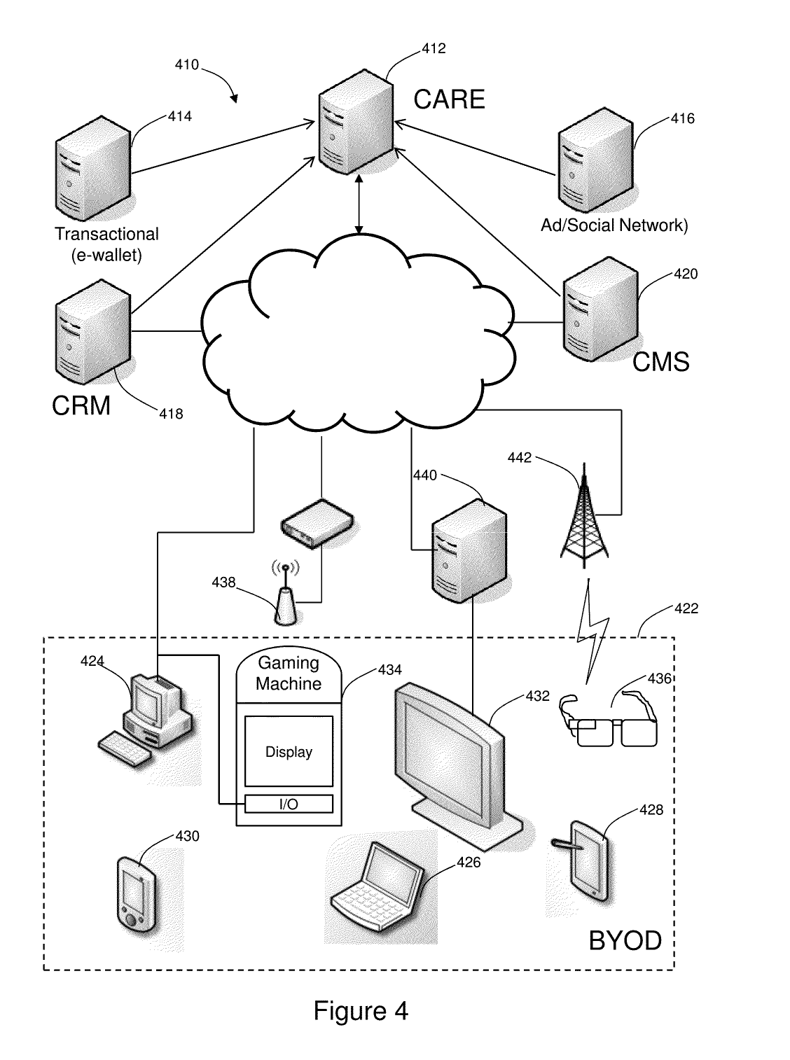

Referring to FIG. 4, there is shown an illustrative cloud-based service that includes the CARE platform. The illustrative cloud service 410 supports the integration of a variety of different cloud services including the CARE platform 412. In the illustrative embodiment the CARE platform integrates with a transactional e-wallet platform 414, a social and advertising network platform 416. Additionally, the CARE platform 412 is configured to integrate with an illustrative premises based customer relations management system 418 that, by way of example and not of limitation, is associated with a loyalty program for an illustrative casino property. Furthermore, the CARE platform 412 is configured to interface with an illustrative premises based Content Management System (CMS) 420 that, by way of example and not of limitations, corresponds to a mobile CMS that stores the mobile content. Additionally, the CARE platform 412 serves up a relevant set of content links to the wireless device, which receives the responsive input and the link (generated by the CARE platform), and takes the user to the mobile content item stored on CMS 420. The “content item” refers to the content associated with a content link, which is served as the context aware news feed or MADGUI.

By way of example and not of limitation, the bring your own device (BYOD) clients 422 includes a personal computer 424, a laptop 426, a tablet computer 428, a smartphone 430, a digital signage display 432, a gaming machine 434 such as a slot machine, a wearable computing device 436 such as GOOGLE GLASS, and other such networkable client devices. The BYOD clients may be operationally coupled to a wide area network (WAN) such as the Internet with a wireless connection.

The wireless BYOD clients may be communicatively coupled to the WAN via a Wi-Fi (or Bluetooth) access point 438 that is communicatively coupled to an illustrative modem 440, which is communicatively coupled to the WAN. The wireless BYOD client may also be communicatively coupled to the WAN using a proprietary carrier network that includes illustrative communication tower 442.

The illustrative cloud service 410 may be embodied as one of four fundamental cloud service models, namely, infrastructure as a service (laaS), platform as a service (PaaS), software as a service (SaaS), and network as a service (NaaS). The cloud service models are deployed using different types of cloud deployments that include a public cloud, a community cloud, a hybrid cloud, and a private cloud.

Infrastructure as a service (laaS) is the most basic cloud service model. IaaS providers offer virtual machines and other resources. The virtual machines, also referred to as instances, are run as guests by a hypervisor. Groups of hypervisors within the cloud operational support system support large numbers of virtual machines and the ability to scale services up and down according to customers' varying requirements. IaaS clouds often offer additional resources such as images in a virtual machine image library, raw (block) and file-based storage, firewalls, load balancers, IP addresses, virtual local area networks (VLANs), and software bundles. IaaS cloud providers supply these resources on demand from their large pools installed in data centers. For wide area connectivity, the Internet can be used or virtual private networks (VPNs) can be used.

Platform as a service (PaaS) enables cloud providers to deliver a computing platform that may include an operating system, a programming language execution environment, a database, and a web server. Application developers can develop and run their software solutions on the PaaS without the cost and complexity of buying and managing the underlying hardware and software layers. With some PaaS solutions, the system resources scale automatically to match application demand so that the cloud end user does not have to allocate resources manually.

Software as a service (SaaS) enables cloud providers to install and operate application software in the cloud. Cloud end users access the software from cloud clients. The cloud end users do not manage the cloud infrastructure and platform that runs the application. The SaaS application is different from other applications because of scalability. Scalability can be achieved by cloning tasks onto multiple virtual machines at run-time to meet the changing work demand. Load balancers in the SaaS application distribute work over a set of virtual machines. To accommodate a large number of cloud end users, cloud applications may be multitenant and serve more than one cloud end user organization. Some SaaS solutions may be referred to as desktop as a service, business process as a service, test environment as a service, communication as a service, etc.

The fourth category of cloud services is Network as a service (NaaS), in which the capability provided to the cloud service end user is to use a network/transport connectivity services, an inter-cloud network connectivity services, or the combination of both. NaaS involves the optimization of resource allocations by considering network and computing resources as a unified whole, and traditional NaaS services which include flexible and extended VPN and bandwidth on demand.

Cloud clients access cloud computing using networked client devices. The cloud clients include, but are not limited to, desktop computers 424, laptops 426, tablets 428 and smartphones 430. Some of these cloud clients rely on cloud computing for all or a majority of their applications so as to be essentially useless without it. Many cloud applications do not require specific software on the client device and instead use a web browser to interact with the cloud application. With Ajax and HTML5, these Web user interfaces can achieve a similar or even better look and feel as native applications. Some cloud applications, however, support specific client software dedicated to these applications.

There are different types of cloud deployment models for the cloud based service, which include a public cloud, a community cloud, a hybrid cloud and a private cloud. In a public cloud, applications, storage, and other resources are made available to the general public by a service provider. These services are free or offered on a pay-per-use model.

The community cloud infrastructure is between several organizations from a community with common concerns, whether managed internally or by a third-party and hosted internally or externally; so the costs are spread over fewer users than a public cloud (but more than a private cloud).

The private cloud infrastructure is operated solely for a single organization, whether managed internally or by a third-party and hosted internally or externally. A private cloud project requires virtualizing the business environment, and it requires that the organization reevaluate decisions about existing resources.

The hybrid cloud is a composition of two or more clouds (private, community or public) that remain unique entities but are bound together, offering the benefits of multiple deployment models. Hybrid cloud architecture requires both on-premises resources and off-site (remote), server-based cloud infrastructure. Although hybrid clouds lack the flexibility, security, and certainty of in-house applications, a hybrid cloud provides the flexibility of in-house applications with the fault tolerance and scalability of cloud based services.

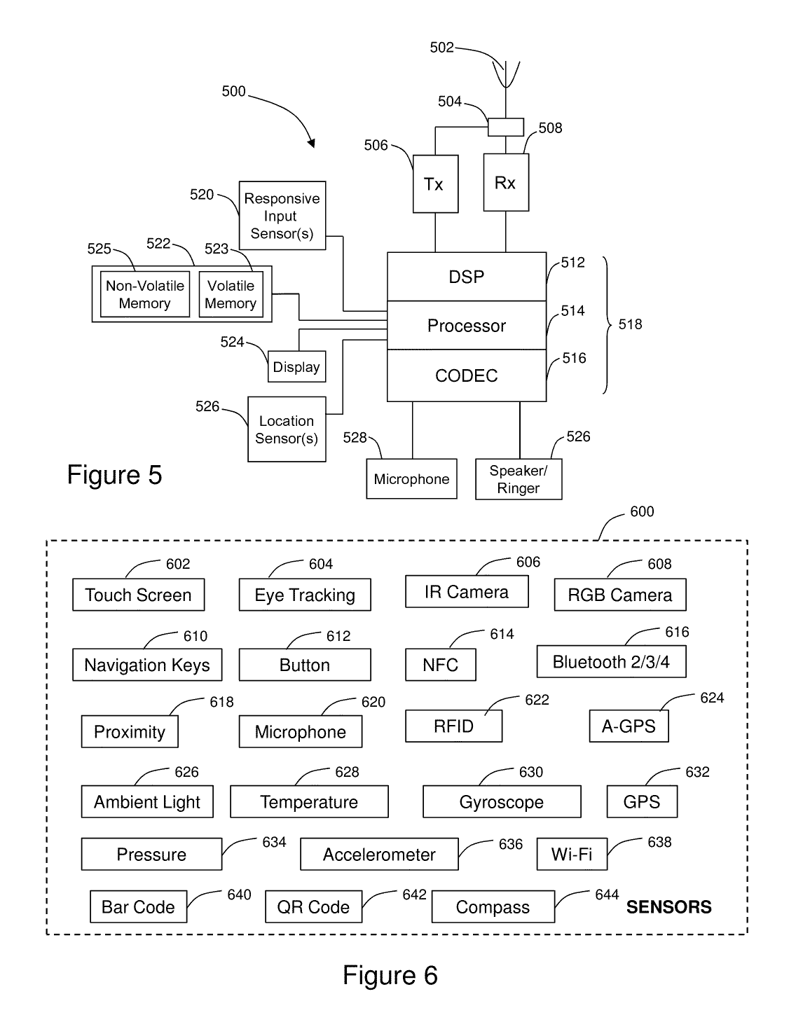

Referring to FIG. 5, there is shown the electrical components for an illustrative wireless device 500. For purposes of this patent, the illustrative wireless device 500 is a multimode wireless device that comprises a first antenna element 502 that is operatively coupled to a duplexer 504, which is operatively coupled to a multimode transmitter module 506, and a multimode receiver module 508.

An illustrative control module 518 comprises a digital signal processor (DSP) 512, a processor 514, and a CODEC 516 that are communicatively coupled to the transmitter 506 and receiver 508. It shall be appreciated by those of ordinary skill in the art that the transmitter module and receiver module are typically paired and may be embodied as a transceiver. The illustrative transmitter 506, receiver 508, or transceiver is communicatively coupled to antenna element 502.

The DSP 512 may be configured to perform a variety of operations such as controlling the antenna 502, the multimode transmitter module 506, and the multimode receiver module 508. The processor 514 is operatively coupled to a responsive input sensor 520 such as a keypad or a touch screen. In operation, the responsive input sensor 520 receives a responsive input after the illustrative dynamic portal or context aware news feed is presented to the end user.

The processor 514 is also operatively coupled to a memory 522, a display 524, and a sensor 526. The sensor 526 may be used to determine an indoor and outside location for the illustrative wireless device.

Additionally, the processor 512 is also operatively coupled to the CODEC module 516 that performs the encoding and decoding operations and is communicative coupled to a speaker 526, and a microphone 528. The CODEC module 516 is also communicatively coupled to the display 524 and provides the encoding and decoding operations for video.

The memory 522 includes two different types of memory, namely, volatile memory 523 and non-volatile memory 525. The volatile memory 523 is computer memory that requires power to maintain the stored information, such as random access memory (RAM). The non-volatile memory 525 can retain stored information even when the wireless communication device 500 is not powered up. Some illustrative examples of non-volatile memory 525 include flash memory, ROM memory, and hard drive memory.

Wireless device 500 may be a mobile handset, mobile phone, wireless phone, portable cell phone, cellular phone, portable phone, a personal digital assistant (PDA), a tablet, a portable media device, a wearable computer such a GOOGLE GLASS, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Referring to FIG. 6, there is shown a plurality of sensors 600 that can be used to receive a responsive input that is communicated to the CARE platform. Additionally, the sensors 600 can also be used to assist in determining the indoor location or the outside location of the wireless device. The sensors may be integrated with a wireless device 500, digital signage 432, a gaming machine 434, a set-top box 1002, a game console 1002, a wired device such as a PC 424, and other such devices that include a memory and a processor that are networkable.

Generally, the touch screen 602 is used to receive a responsive input, however, the touch screen may also be used to indicate a location if a map is presented to the end user that enables the end user to provide a particular indoor location.

Generally, the eye tracking module 604 is also used to receive a responsive input, however, the eye tracking module may also be used to track the end user's eye movements to determine the end user interests that may assist in developing a user profile. The eye tracking module may be associated with a wireless device such as GOOGLE GLASS.

Generally, the infrared (IR) camera 606 may be used to receive a responsive input such as a gesture. The IR camera may also record a background that can be used to determine an indoor or outside location. The IR camera may be associated with a device such as the KINECT for XBOX.

Generally, the RGB camera 608 may be used to receive a responsive input such as monitoring an end user's facial expression or an end user's age. The RGB camera may also record a background that can be used to determine an indoor or outside location. The RGB camera may be associated with a device such as the KINECT for XBOX.

Generally, the navigation keys 610 and button 612 are used to receive responsive input, which may also be related to determining indoor location and outside location.

Generally, the near field communication (NFC) device 614 is used for contactless payment systems. Thus, the completion of a transaction may qualify as a responsive input and the transaction may result in the determination of a particular indoor or outside location.

Generally, a Bluetooth module 616 that can support Bluetooth versions 1, 2, 3, 4 and other future versions may be used to determine indoor location. For example, the iphone 4S and 5 use Bluetooth for determining indoor location. In certain instances, the Bluetooth standard may also be used to receive a responsive input.

Generally, a proximity sensor 618 is associated with a wireless device and is used to detect the presence of nearby objects without any physical contact. Thus, the proximity sensor is generally used to receive a responsive input.

The microphone 620 may be used to determine location by receiving high frequency sounds that are not audible to the human ear, and communicate these high frequency sounds to a location server that can then determine a particular location for an illustrative wireless device. The microphone 620 may also be used to receive a voice command that provides a responsive input.

The RFID module 622 may be used for communicating a particular location or be indicative of a responsive input, such as a check-in with a employee badge having an RFID tag.

The Assisted GPS module 624 (A-GPS) is generally used to provide a location; however, in certain instances when an end user crosses the perimeter of a geofence, it may result in a responsive input.

An ambient light sensor 626 or photosensor detects changes in light, and the changes in light may be generally associated with a responsive input. The temperature sensor 628 detects the temperature, which may be generally associated with a responsive input. The pressure sensor 634 detects the pressure and is generally associated with a responsive input, e.g. change in pressure may indicate change in weather, which may result in modifying the context aware news feed.

The gyroscope module 630 may be used for motion sensing, which can assist in determining location. Additionally, the gyroscope module may also be used to receive a responsive input, e.g. by shaking the wireless device.

The GPS module 632 is generally used to provide a location; however, in certain instances when an end user crosses the perimeter of a geofence, it may result in a responsive input.

The accelerometer module 636 and compass 644 may be used for motion sensing, which can assist in determining location. Additionally, either the accelerometer module or the compass may be used individually to determine a location. In conjunction with the gyroscope module 630, the accelerometer module 636 and compass 644 may be used to determine location. Additionally, the gyroscope module 630, the accelerometer module 636, the compass 644, and any combination thereof may be used to receive a responsive input, e.g. pointing the wireless device in a particular direction.

The Wi-Fi module 638 may be used to connect with access points and to also detect different SSID and beacon signal strengths, which as described herein can be used to determine an indoor location. Additionally, if a geofence is entered, this triggering event may be a responsive input.

The bar code 640 module and the QR code 642 module may be used to determine a location, to provide a responsive input, or the combination thereof.

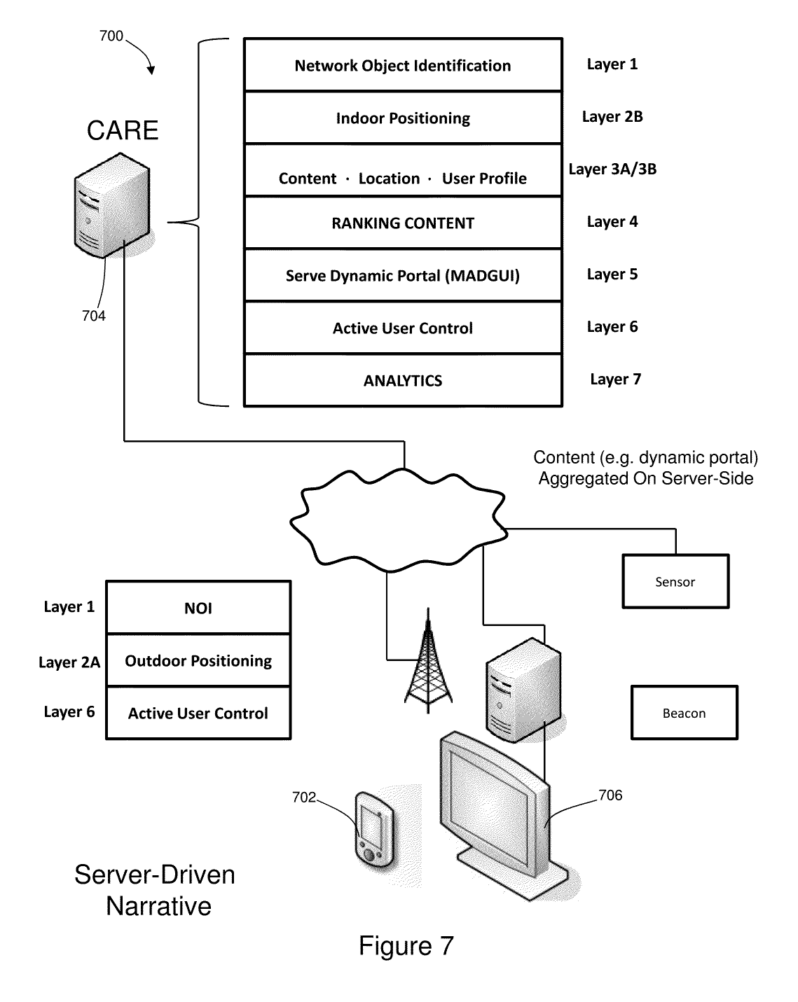

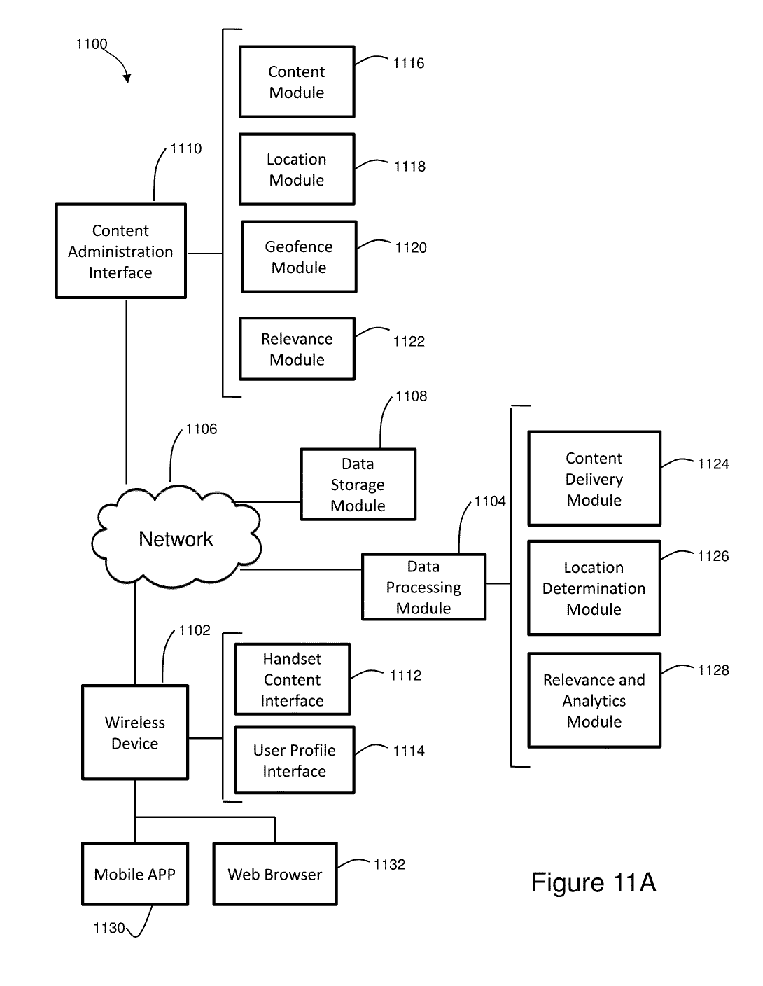

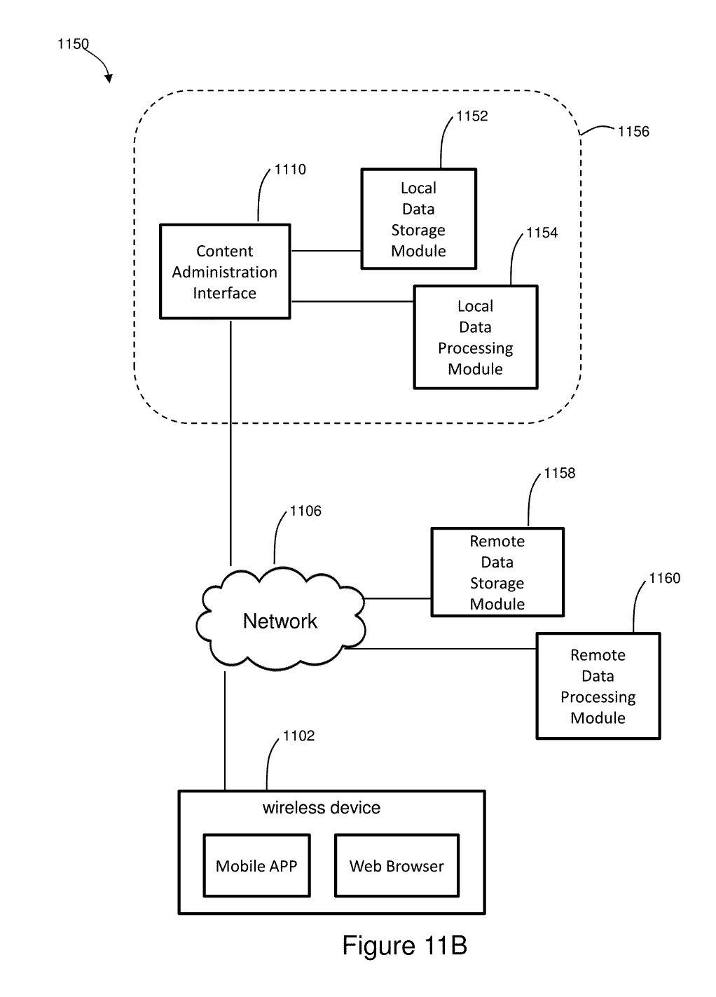

Referring to FIG. 7, there is shown an illustrative system, in which the CARE platform delivers the dynamic portal content to an illustrative wireless device and enables the wireless device to control a display. The illustrative system 700 serves a relevant set of content links or content, e.g. an advertisement, to the wireless device 702 with a server 704. The server 704 is configured to run a variety of different modules that perform operations corresponding to the contextual layers described above in FIG. 3 and in FIGS. 11-49.

The wireless device 702 wirelessly communicates with a network and the wireless device is configured to run a web browser or download a software application module, i.e. a mobile APP. The server 704 is communicatively coupled to the wireless device via the network and the server authenticates the wireless device or the web browser. Additionally, the server 704 is communicatively coupled to display 706 and enables the wireless device to control the display 706, as described in patent application Ser. Nos. 13/251,699 and 13/251,716 that are both entitled INTERACTIVE DISPLAY SYSTEM, and which are hereby incorporated by reference.

In the illustrative embodiment presented in FIG. 7, the MADGUI is generated by the illustrative server 704, which performs the operations of contextual layers 1-7 that include network object identification, indoor positioning, associating content with location, associating content with a user profile, ranking content, serving the MADGUI, receiving active user control and generating analytics.

The illustrative wireless device 702 performs much more limited operations, namely, network object identification, outdoor positioning, and provides active user control.

In this embodiment, the server 704 includes a positioning module that is associated with the contextual layer 2B of the CARE platform. The positioning module associated with the server is configured to determine a location for the wireless device or the web browser.

The user profile module associated with the server 704 includes at least user attribute that is associated with the wireless device or the web browser. The user profile module is referenced in the contextual layer 3B.

The content module associated with the server 704 is configured to communicate at least one content link that is associated with a content item. In the illustrative embodiment, content is associated with location by the location-based content management module that corresponds to contextual layer 3A.

The ranking content module associated with the server 704 ranks each content link based on the location of the wireless device and the user profile. The ranking content module is associated with contextual layer 4. The ranking content module may also rank each content link based on location of the web browser and user profile associated with the web browser.

The content delivery module, corresponding to contextual layer 5, delivers the ranked content links to the web browser or the software application module associated with the wireless device. The wireless device display presents the ranked content links, which is also referred to as the MADGUI. In one embodiment, the illustrative wireless device 702 presents the ranked content links as a web page on the web browser.

The responsive input received by the wireless device corresponding to one of the content links is communicated to the server 704. In the web browser embodiment, the responsive input provides access to the corresponding content item. In the software application module embodiment, the server communicates the content item corresponding to the content link to the software application module.

A method for serving relevant content is also described. The method includes enabling the wireless device 702 to wirelessly communicate with a network. The wireless device 702 is configured to run a software application module, a web browser, or the combination thereof. The wireless device is communicatively coupled to at least one server via the network, wherein the server authenticates at least one of the wireless device and the web browser. The method then proceeds to determine the location of the wireless device with a positioning module associated with a mapping server (not shown). A user profile is associated with at least one of the wireless device and the web browser, wherein a plurality of user profiles are stored in a user profile module and each user profile includes at least user attribute. The method enables a content module to communicate at least one content link that describes a content item. The method also ranks each content link based on the location of the wireless device and the user profile. The ranked content links are delivered to at least one of the software application module and the web browser. The ranked content links are displayed on the wireless device. The method then proceeds to receive a responsive input at the wireless device that corresponds to one of the content links, wherein the responsive input received by at least one of the software application module and web browser provides access to the corresponding content item.

In one illustrative embodiment, the positioning module can determine the indoor location of the wireless device. The ranking module can rank each content link based on the indoor location of the wireless device. The content delivery module delivers the ranked content links to the wireless device as a plurality of content links that change autonomously based on the indoor location of the wireless device.

In another illustrative embodiment, the ranking module ranks each content link based on the user profile for the wireless device. The content delivery module delivers the ranked content links to the display as a plurality of content links that change autonomously based on the user profile associated with the wireless device.

In yet another illustrative embodiment, the responsive input is received by the user profile module and the user attribute is updated based on the responsive input and the ranking module adjusts the ranking of each content link based on the responsive input. Additionally, the content delivery module delivers the ranked content links to the display as a plurality of content links that change autonomously based on the responsive input.

In a further illustrative embodiment, the server is configured to communicate with a plurality of wireless devices and each wireless device has a corresponding user profile, so when a plurality of responsive inputs are generated by the plurality of wireless devices, the responsive inputs received by the user profile module updates the user attribute for each user profile, and the ranking module adjusts the ranking of each content link based on the responsive inputs from the plurality of wireless devices, and the content delivery module delivers the ranked content links to the display as a plurality of content links that change autonomously based on the responsive inputs from the plurality of wireless devices.

In another illustrative embodiment, the software application module includes a news feed that receives a plurality of content links, which change based on the location of the wireless device and the user profile associated with the wireless device.

In a further illustrative embodiment, the content item served to the wireless device after receiving the responsive input includes a plurality of second level content links that do not change based on the location of wireless device, but do change autonomously based on the user profile associated with the wireless device.

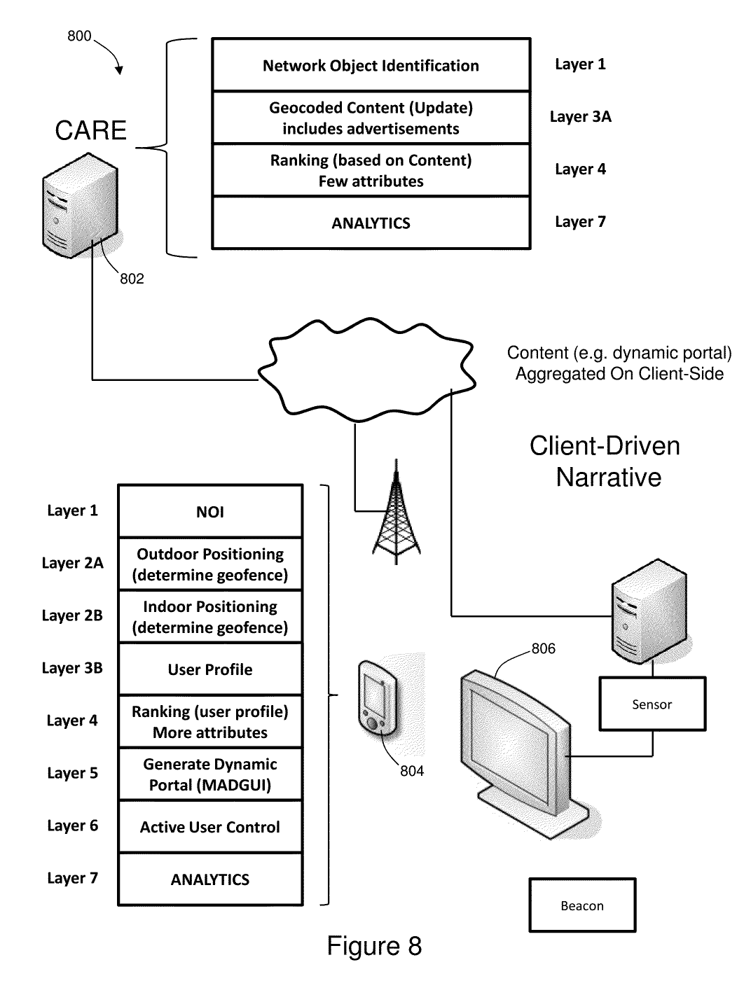

Referring to FIG. 8, there is shown an illustrative system, in which the wireless client device generates the dynamic portal. The illustrative system 800 includes a server 802 that communicates geocoded content items, content links, or both to wireless device 804. Additionally, the server 802 performs network object identification of all the wireless devices so that the server can update each of the wireless devices with the geocoded content. In the illustrative embodiment, the server 802 ranks the geocoded content based on a limited set of attributes associated with the user profile. The server 802 maintains analytics to track advertisements that are communicated to wireless handset.

In the illustrative system 800, the client device drives the development of the MADGUI narrative. The wireless device effectively performs most of the operations of the contextual layers, except for layer 3A in which the geocoded content is centralized at the server 802. More specifically, the client device 802 performs the network object identification, the outdoor positioning using GPS, and the indoor positioning using sensors integrated into the wireless device and mapping data stored on the wireless device. Furthermore, the client server 802 has stored thereon a user profile module and ranks the geocoded content based on parameters such as breaking the geofence and the user attributes corresponding to the user profile module. The resulting MADGUI is presented on the wireless device and the active user controls enable the wireless device to receive the responsive input and track the responsive inputs to build analytics, which can be further used to update the user profile.

Additionally, the server 802 is communicatively coupled to display 806 and enables the wireless device to control the display 806, as described in patent application Ser. No. 13/251,699 and 13/251,716 that are both entitled INTERACTIVE DISPLAY SYSTEM, and which are hereby incorporated by reference.

In another illustrative embodiment of the client driven narrative of FIG. 8, the server 802 is communicatively coupled to the wireless device 804 via the network and the server authenticates the wireless device or the web browser. The positioning module integrated with the wireless device determines a location for the wireless device or the web browser. The user profile module integrated with the wireless device may include at least one user attribute that is associated with each particular user. The user profile may also include at least one user attribute that is associated with the wireless device or the web browser. The content module stored on the wireless device serves at least one content link that is associated with a content item. The ranking content module integrated with the wireless device ranks each content link based on location of the wireless device and the user profile. Additionally, the ranking content module may rank each content link based on user profile and the location of the web browser. The content delivery module integrated with the wireless device to deliver the ranked content links to the software application module or the web browser. The wireless device display presents the ranked content links in the software application module or as a web page in the web browser. The responsive input received by the wireless device corresponding to one of the content links results in displaying the corresponding content item. The server periodically updates the software application module or the web browser with an updated positioning module, an updated content module, an updated user profile module, an updated ranking module, or any combination thereof.

In one illustrative embodiment, the positioning module can determine the indoor location of the wireless device. The ranking module can rank each content link based on the indoor location of the wireless device. The content delivery module delivers the ranked content links to the wireless device as a plurality of content links that change autonomously based on the indoor location of the wireless device.

In another illustrative embodiment, the ranking module ranks each content link based on the user profile for the wireless device. The content delivery module delivers the ranked content links to the display as a plurality of content links that change autonomously based on the user profile associated with the wireless device.

In yet another illustrative embodiment, the responsive input is received by the user profile module and the user attribute is updated based on the responsive input and the ranking module adjusts the ranking of each content link based on the responsive input. Additionally, the content delivery module delivers the ranked content links to the display as a plurality of content links that change autonomously based on the responsive input.

In a further illustrative embodiment, the server is configured to communicate with a plurality of wireless devices and each wireless device has a corresponding user profile, so when a plurality of responsive inputs are generated by the plurality of wireless devices, the responsive inputs received by the user profile module updates the user attribute for each user profile, and the ranking module adjusts the ranking of each content link based on the responsive inputs from the plurality of wireless devices, and the content delivery module delivers the ranked content links to the display as a plurality of content links that change autonomously based on the responsive inputs from the plurality of wireless devices.

In another illustrative embodiment, the software application module includes a news feed that receives a plurality of content links that change based on the location of the wireless device and the user profile associated with the wireless device.

In a further illustrative embodiment, the content item served to the wireless device after receiving the responsive input includes a plurality of second level content links that do not change based on the location of wireless device, but do change autonomously based on the user profile associated with the wireless device.

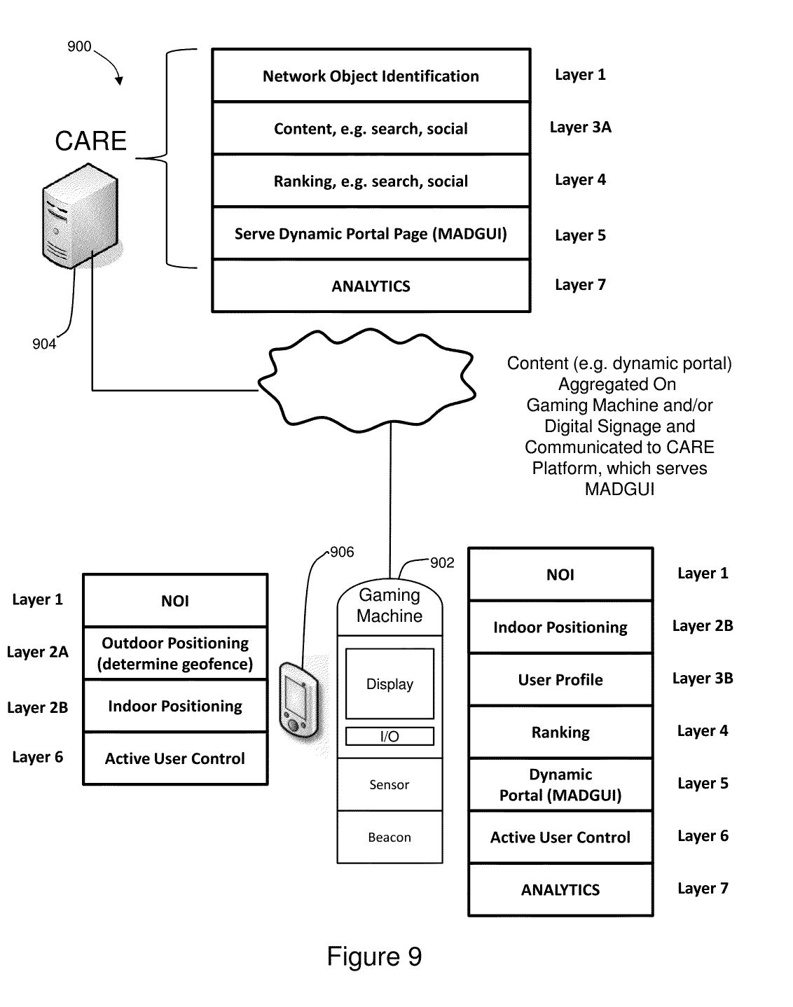

Referring to FIG. 9, is shown an illustrative system 900, in which an illustrative gaming machine or digital signage generates the dynamic MADGUI portal and communicates the MADGUI to the server, which then passes the MADGUI to the wireless device.

In FIG. 9, the illustrative gaming machine 902 supports a picture-in-picture (PIP) technology that enables the gaming machine or kiosk to perform as digital signage. The gaming machine 902 is also communicatively coupled to a casino loyalty program that has an extensive user profile with multiple user attributes. The illustrative gaming machine 902 also includes a transactional component that allows the gaming machine to perform transactions. The illustrative gaming machine is configured to run a digital signage downloadable software application module and a digital signage web browser.

The gaming machine 902 performs a variety of operations including network object identification, assisting in determining indoor positioning, accessing a user profile, ranking content based on location and user profile, generating the illustrative MADGUI content links, providing active user control, and generating analytics.

In the system 900, the illustrative gaming machine 902 generates the dynamic MADGUI portal and communicates the MADGUI to the server 904, which proceeds to add additional content to the MADGUI. By way of example and not of limitation, the additional content introduced by server 904 may be associated with preserving user privacy and so the server 904 may provide anonymizing services such as anonymizing responses to ranked content links communicated by the wireless device. Additionally, the server 904 may be provide additional services that the end user would like to integrate into their MADGUI feed such as e-mails received, social network notifications, RSS feeds, and other such content the end user would like to integrate with the MADGUI feed generated by the gaming machine 902.

Alternatively, the gaming machine 902 may bypass server 904 and communicate directly with the wireless device 906.

The wireless device 906 operates as a thin client and performs limited operations such as providing positioning information and providing the user with an interface for active user control

In another embodiment, the gaming machine 902 is a slot machine, in which the slot machine runs a slot machine downloadable software application module, a slot machine web browser, or both. The responsive input received by the wireless device corresponding to one of the content links displays the corresponding content item on the wireless device, slot machine display, or both devices. Additionally, the server 904 periodically updates the wireless device and the slot machine with at least one of an updated positioning module, an updated content module, an updated user profile module, and an updated ranking module.

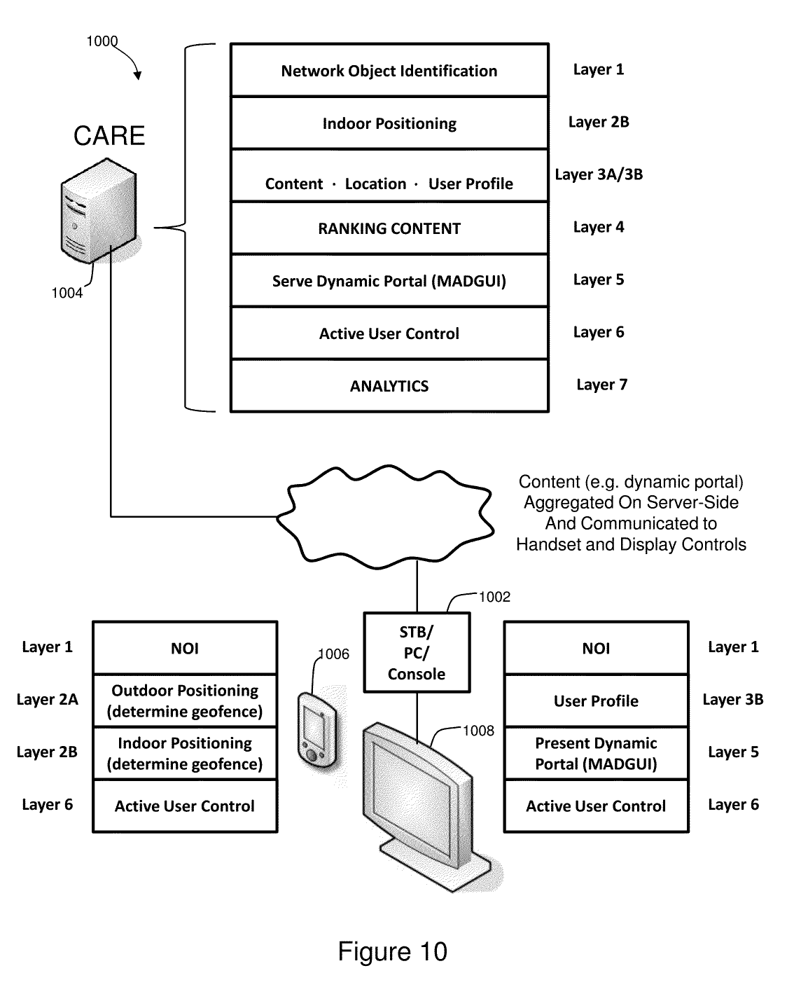

Referring to FIG. 10, there is shown an illustrative interactive display system 1000, in which a server generates the dynamic MADGUI portal and communicates the MADGUI to the client device and a display that is operatively coupled to a display control module. The display control module is configured to communicate with a network, and the display control module is configured to receive at least one of a downloadable software application module and a web browser. The illustrative display control module 1002 includes, but is not limited to, a set-top box, a personal computer, and a gaming console.

The server 1004 is communicatively coupled to the wireless device 1006 and the display control module 1002 via the network. The server 1004 authenticates the wireless device 1006 and display control module 1002.

In the illustrative embodiment, the MADGUI is generated by the illustrative server 1004, which performs the operations of contextual layers 1-7 that include network object identification, indoor positioning, associating content with location, associating content with a user profile, ranking content, serving the MADGUI, receiving active user control, and generating analytics.

In one embodiment, the server 1004 is configured to perform operations that include assisting with determining the indoor positioning of the wireless device, accessing a user profile that corresponds to the wireless device, ranking content links based on the location of the wireless device and the user profile, and serving the ranked content links to the wireless device and the display control module.

The wireless device 1006 is configured to wirelessly communicate with a network and the wireless device is configured to receive at least one of a wireless device downloadable software application module and a wireless device web browser. The illustrative wireless device 1006 performs much more limited operations, namely, network object identification, outdoor positioning, indoor positioning, and provides active user control.

In the illustrative embodiment, the wireless device is configured to provide a user interface that is configured to receive a responsive input to the ranked content links presented on the wireless device, wherein the responsive input is communicated to the display control module, which results in the content item being presented on the display.

The display control module 1002 also performs limited operations, namely, network object identification, accessing user profile, presenting dynamic portal content, and providing active user control.

For example, an interactive program guide may be generated by the display control module 1002 that is presented on display 1008. The same or substantially similar interactive program guide may also be presented on the wireless handset 1006.

In yet another embodiment, a set-top box that is communicatively coupled to a display, e.g. a television. The set-top box is communicatively coupled to the network and runs a set-top box downloadable software application module, a set-top box web browser, or both. The responsive input received by the wireless device corresponding to one of the content links results in displaying the corresponding content item on the wireless device, a set-top box display communicatively coupled to the set-top box, or both. The server periodically updates the wireless device and the set-top box with at least one of an updated positioning module, an updated content module, an updated user profile module, and an updated ranking module.

Referring now to FIGS. 11 through 49, there is shown a more detailed embodiment of the system 700 presented in FIG. 7 above. The structural and functional elements of the components and modules presented in FIGS. 11 through 49 may be adapted to the alternative systems presented in FIGS. 8, 9 and 10. Thus, those skilled in the art having the benefit of this disclosure may apply the detailed description provided in FIGS. 11 through 49 to the alternative systems presented in FIGS. 8, 9 and 10.

Referring now to FIG. 11A, a diagram of an illustrative targeted content delivery system according to a first embodiment 1100 is shown. Wireless device 1102 receives content transmitted from data processing module 1104 via network 1106. The content is stored in data storage module 1108. A content administration interface 1110 allows a content administrator to create content and content associations to define how the content will be targeted.

Wireless device 1102 may be a mobile handset, mobile phone, wireless phone, portable cell phone, cellular phone, portable phone, a personal digital assistant (PDA), a tablet, a portable media device, or any type of mobile terminal which is regularly carried by a user and has all the elements necessary for operation in a wireless communication system. The wireless communications include, by way of example and not of limitation, CDMA, WCDMA, GSM or UMTS or any other wireless communication system such as wireless local area network (WLAN), Wi-Fi or WiMAX. The wireless device comprises a device content interface 1112. The device content interface is a graphical user interface that displays content on a display of the wireless device. The device content interface may also be configured to receive user input, such as feedback pertaining to the displayed content and user-created content. The device content interface may be an application running on a processor of the wireless device. In other embodiments, the device content interface is accessed via network 106, for example, using an internet browser application running on a processor of the wireless device.

In some embodiments, wireless device 1102 comprises user profile interface 1114. The user profile interface allows the user of the wireless device to input user profile information comprising one or more user attributes. The user profile interface and the content interface may be components of a single application or may be separate applications.

The wireless device 1102 is capable of running a downloadable mobile application 1130, a web browser 1132, or the combination thereof. The web browser 1132 may operate using a virtual machine and may rely substantially on content stored on the network. The downloadable mobile application may rely substantially less on content stored on the network and substantially more on the content stored on the wireless device. Note, this characterization of the web browser 1132 and mobile app 1130 is dependent on the particular type of mobile browser and mobile application.

Network 1106 may be a local area network (“LAN”), wide area network (“WAN”), or any other network to facilitate communication among computers and wireless communication devices.

Content administration interface 1110 is an application used by a content administrator to manage content. Typically, a content administrator is affiliated with a premises or service for which the content is generated. In some embodiments, the content administration interface application is run on a processor of a computer or other computing device located on or affiliated with the premises. The content administration interface application may also be run on a processor of a computer or other computing device that is remote from the premises and accessed over network 1106, for example, via an internet browser. Content items generated with the content administration interface are stored in memory. Typically, content items are stored in a data storage module 1108. In some embodiments, the content administration interface 1110 and content data storage module 1108 reside on a single computing device, in which case it is not necessary for the content administration interface and content database to communicate via network 1106.

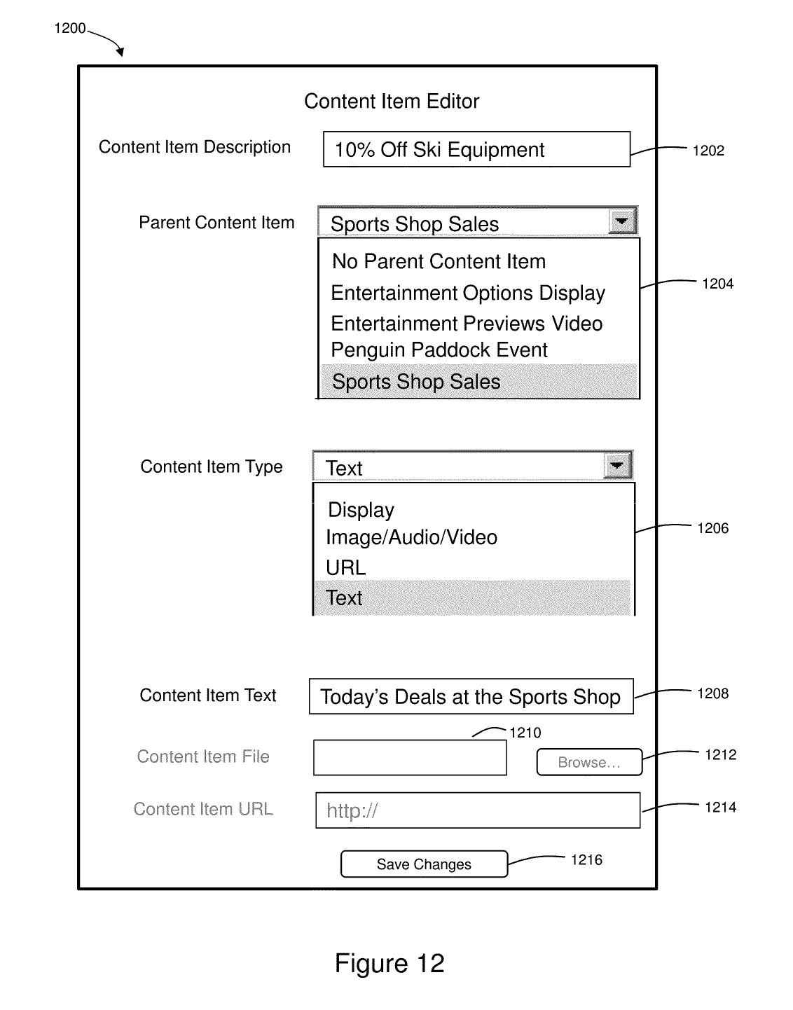

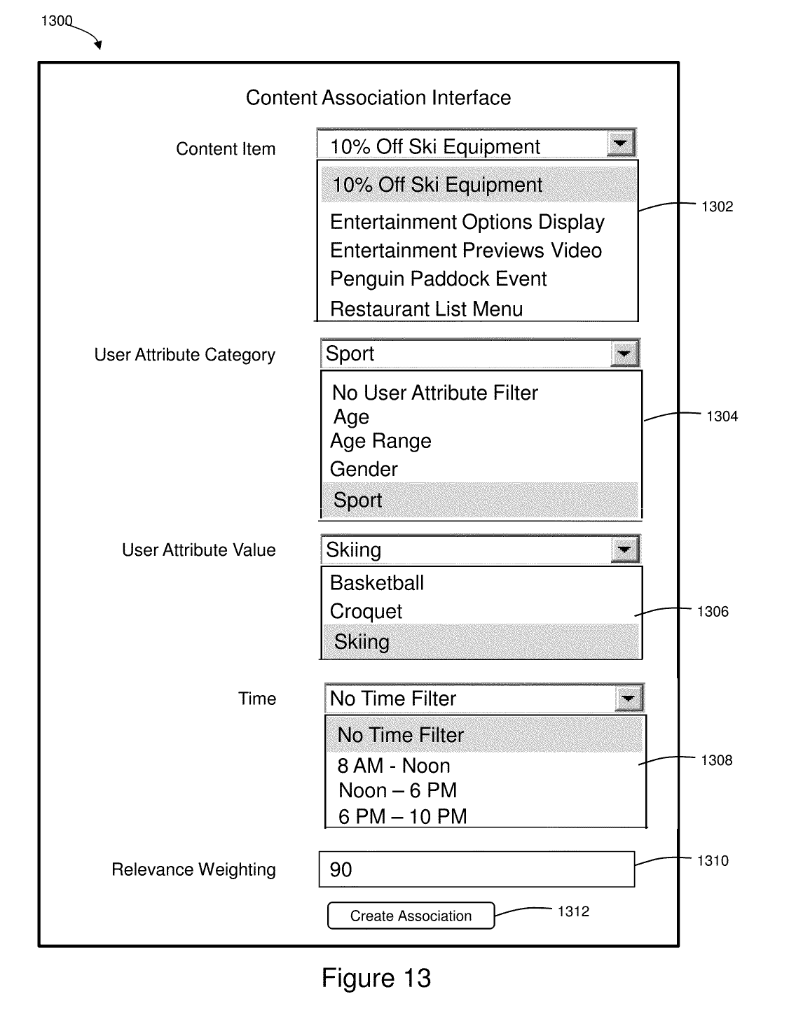

Content administration interface 1110 comprises content module 1116. The content association module allows the content administrator to generate content items and define associations between content items and various parameters. For example, the content association module may be used to create an association between a content item and a user attribute as defined in a user profile. An illustrative content item editor interface and content association interface of the content module are shown in FIGS. 12 and 13, respectively.

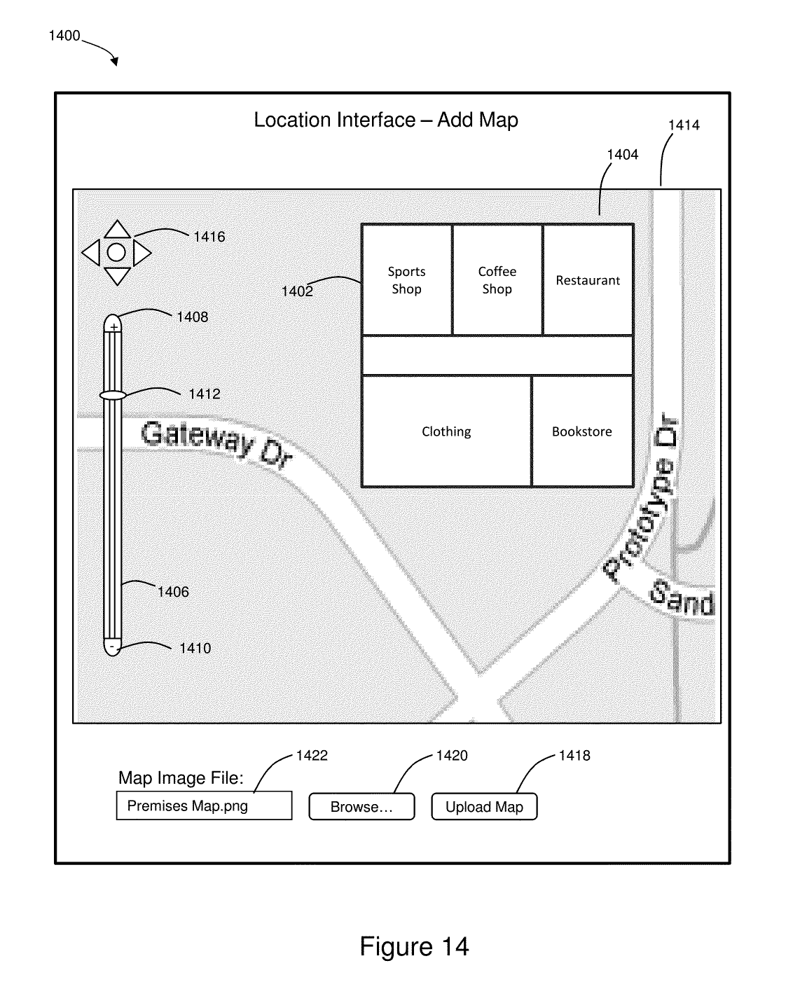

Content administration interface 1110 may further comprise location module 1118. The location module of the content interface allows the content administrator to indicate information required for determination of the position of the wireless device. For example, the location module may be a Geographic Information System (GIS) interface that allows the content administrator to indicate the geographic location of a premises map. In one embodiment, the location module is a GIS interface allowing the content administrator to indicate the location of network objects, such as Wi-Fi beacons, relative to a premises map. In another embodiment, the location module is a GIS interface allowing the content administrator to indicate the location of Wi-Fi beacons and Wi-Fi sensors relative to a premises map. The location of the wireless device relative to the premises may be determined based on the known location of the beacons as indicated with the GIS interface and information derived from beacon signals received by the wireless device. An illustrative location interface of the location module is shown in FIG. 14.

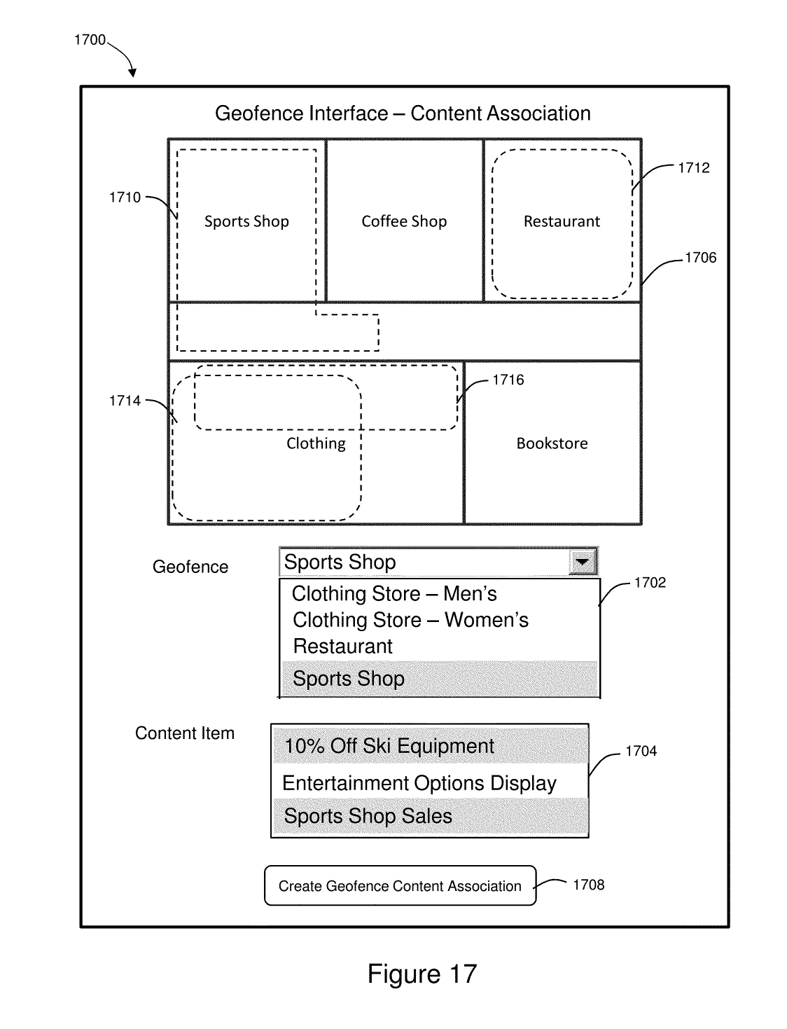

The content administration interface may further comprise geofence module 1120. The geofence module allows the content administrator to indicate the location of a geofence relative to a map, such as a premises map. A geofence, also referred to as a “content bubble,” is a virtual geographic boundary line delineating a geographic area. An illustrative geofence creation interface of the geofence module is shown in FIG. 6. In some embodiments, the content administrator uses the content association module to create associations between content items and geofences. An illustrative geofence content association interface of the geofence module is shown in FIG. 17. The location of the wireless device is determined by location determination module 1126 using information transmitted from wireless device 1102. In some embodiments, if the wireless device is located within a geofence, content delivery module 1124 transmits content associated with the geofence to wireless device 1102.

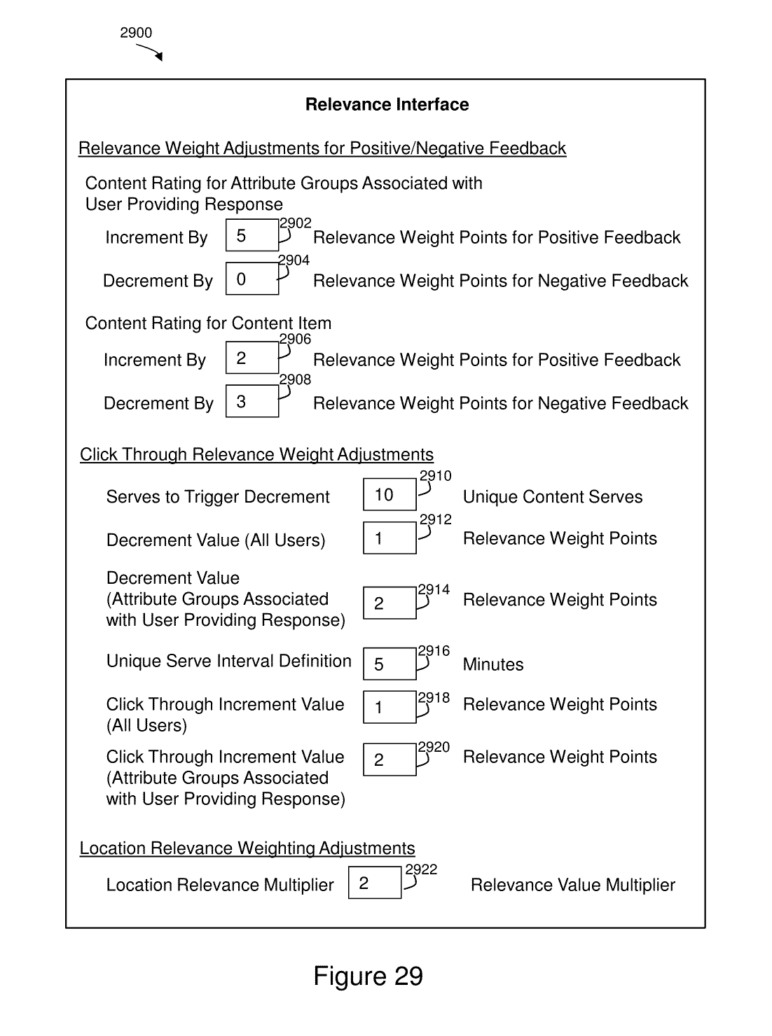

The content administration interface may further comprise relevance module 1122. In some embodiments, a relevance weight value is associated with a content item. The relevance weight value may be adjusted based on user response to the content item, for example, feedback provided for the content item, selection of the content item, or lack of response to the content item. The relevance module allows the content administrator to adjust parameters affecting how the relevance weight is adjusted. Typically, the relevance module allows the content administrator to enter or change numerical point values by which a relevance weight is to be incremented or decremented in response to user behavior. An illustrative relevance interface of the relevance or ranking module is shown in FIG. 29.

Data storage module 1108 stores content items and information used for targeted delivery of content items. The data storage module may store, for example, user profile data, map data, geofence definition data, locations of network objects, relevance weight parameters, and associations between content items and parameters used for content targeting. In an illustrative embodiment, data storage module 1108 comprises one or more databases communicatively coupled to network 1106.

Data processing module 1104 comprises one or more applications used for targeted delivery of content. In some embodiments, data processing module 1104 runs on a processor of a server or other computing device communicatively coupled to network 1106.

Content delivery module 1124 of data processing module 1104 determines one or more content items to transmit to wireless device 1102. In some embodiments, content is targeted based on one or more of user profile, location, time, date, and relevance weight. The content delivery module may transmit content to the wireless device on a periodic basis, such as one second intervals to one minute intervals, e.g. five second intervals. Alternatively or additionally, content delivery module 1124 transmits content items to the wireless device when the device content interface 1112 is initiated, in response to a request for content placed via device content interface 1112, or when the determined location of the wireless device is updated by location determination module 1126.

Location determination module 1126 of data processing module 1104 determines a location of the wireless device based on information received from or regarding wireless device 1102. The location determination module may further determine whether the wireless device is located within a geofence. The determined location may be used by content delivery module 1124 to determine which content items to transmit to wireless device 1102.

In some embodiments, the wireless device transmits a location message comprising the signal strength, e.g., a received signal strength indicator (RSSI), and identification, e.g., a Media Access Control address (MAC address) of each beacon signal detected the device. The beacon is any device communicatively coupled to a network and capable of transmitting a signal that can be received by the wireless device using Wi-Fi, Bluetooth, or other wireless standards such as an access point or femtocell. Location determination module 1126 uses the information in the location message to determine the location of the wireless device based on known locations of the beacons. In other embodiments, the location message comprises location information such as a zip code, city, Global Positioning System (GPS) or other geographical coordinates. In a further alternative embodiment, the user indicates the location of the wireless device, for example, by using the wireless device to capture an image of the environment or of a code such as a QR code. The image is compared to a database of images to determine the location of the device. The user may alternatively select a location indicator from a menu displayed on the wireless device. It will be recognized that other methods may be used to communicate information regarding the location of the wireless device.

The wireless device may transmit location messages at predefined intervals, such as one second intervals to one minute intervals, e.g. five second intervals. The content delivery module 1124 may transmit new content item data each time the location message is received. In this manner, the content item data displayed on the wireless device is updated as the location of the user changes, such that some or all of the content item data displayed to the user is relevant to the user's location. In some embodiments, content item data is not updated until the content item has been displayed on the device for a predetermined period of time.

In an alternative embodiment, the remote server may interpret the location message to determine whether the wireless device is located within a predefined distance of an access point. The distance between the access point and the wireless device may be determined on the basis of a threshold signal strength. When the signal strength exceeds a predefined threshold, the remote server transmits at least one content item associated with the location indicated by the signal identifier of the access point.

Relevance and analytics module 1128 of data processing module 1104 adjusts the relevance weight value associated with a content item based on user response to the content item. The relevance and analytics module may further log changes in the relevance weight value for a content item in association with one or more parameters such as time, location, and user profile information to allow analysis of user response to content items.

Referring now to FIG. 11B, a diagram of an illustrative targeted content delivery system 1150 according to a second embodiment is shown. In the second embodiment, local data storage module 1152 and local data processing module 1154 are communicatively coupled to content administration interface 1110. For example, a local server may comprise memory for local data storage, the memory communicatively coupled to a processor for running applications of the local data processing module and content administration interface. In other embodiments, the content administration interface, local data processing module, and local data storage module are located on one or more computing devices communicatively coupled by a network, such as a local area network. In some embodiments, the local server or local area network are located behind a firewall 1156. “Local” as used herein indicates an association with a particular premises or service.

Remote data storage may be used in addition to or as an alternative to local data storage 1152. Remote data processing module 1160 may be used in addition to or as an alternative to remote data processing. Local data storage module 1152 and remote data storage module 1158 perform one or more of the functions of data storage module 1108 described with reference to FIG. 11A. Similarly, local data processing module 1154 and remote processing module 160 perform one or more of the functions of data processing module 1104 described with reference to FIG. 11A. In one embodiment, when local data processing module 1154 is overwhelmed, remote data processing module 160 is used for overflow data processing.

In some embodiments, local data storage module 1152 and local data processing module 1154 are communicatively coupled to an anonymizing server. Data transmitted from the local data storage module and the local data processing module pass through the anonymizing server en route to network 1106. Similarly, remote data storage module 1158 and remote data processing module 1160 may be communicatively coupled to an anonymizing server. Data transmitted from the remote data storage module and the remote data processing module pass through the anonymizing server en route to network 1106.

Referring to FIG. 12, an illustrative content item editor of the content administration interface is shown. The content item editor is a graphical user interface that allows the content administrator to create and edit content items. A content item is information transmitted to a wireless device and shown on a display of the device. A content item may be, for example, text, video, audio, one or more images, a menu, an application, a link to a uniform resource locator (URL), a link to another content item, or information to be shown on a display in proximity to the wireless device. The content item editor comprises content item description entry field 1202. In the illustrative example shown in FIG. 12, the content administrator has entered the description “10% Off Ski Equipment” for the content item.

In some embodiments, a parent content item may link to one or more child content items. When the parent content item is selected from the wireless device content interface, the child content items of the parent content item may be displayed. In the illustrative content editor, the content item “Sports Shop Sales” has been selected from drop down menu 1204 as the parent content item for the content item “10% off Ski Equipment.”

The content item type may be specified, as indicated at drop down menu 1206. In the illustrative example, content item type “Text” has been selected for content item “10% Off Ski Equipment.” The text “Today's Deals at the Sports Shop” has been entered in content item text input box 1208. This is the text that will be displayed in the device content interface when content item “Sport Shop Sales” is transmitted to the wireless device. In other embodiments, the text in the content item description is used as the content item text. The content item file text box 1210, browse button 1212, and content item URL input box 1214 are shown in grey text to indicate that these entry fields are not available when the selected content item type is “Text.” When the content item type as selected in content item type drop down menu 1206 is “Display,” the file to be shown on the display may be selected for upload using browse button 1212. Similarly, when the content item type is “Image/Audio/Video,” the file to be shown on the display may be selected for upload using browse button 1212. The file name of the selected file is shown in content item file text box 1210. When the content item type is “URL,” the URL may be entered in content item URL input box 1214.

When the content administrator has completed the content item entry, the content administrator may select save changes button 1216 to record the entry. If the content item is new, the new content item will be saved in memory. In some embodiments, a new entry is created in a database table of one or more of data storage module 1108, local data storage module 1152 and remote data storage module 1158. If the content item has been changed, the database table is updated to reflect the change.

Referring now to FIG. 13, an illustrative content association interface 1300 is shown. The content association interface is a graphical user interface used to create associations between content items and one or more parameters such as time, user attributes, and relevance weighting. “Association” indicates a connection between data stored in computer memory. Typically, the connection exists in a database table. For example, when a content item is associated with a user attribute, an entry may be created in a database table comprising fields for user identification and user attribute identification. Content items transmitted to the wireless device may be filtered in accordance with the content associations such that the content items displayed on the device are targeted at the user of the wireless device. For example, when an association between a content item and a user attribute has been created, the content item may be delivered to wireless devices of a user described by the user attribute. The user attribute is information about a user that is provided by a user (e.g., through user profile interface 1114) or collected about the user.

In the illustrative content item editor shown in FIG. 13, the content administrator creates an association between a content item and a user attribute. To create an association between the content item and the user attribute, the content administrator selects a content item, a user attribute category, and a user attribute value. In some embodiments, a content association may be created by selecting a content item and a user attribute value. The content administrator has selected the content item “10% Off Ski Equipment” from content item drop down menu 1302. User attribute category “Sport” has been selected from drop down menu 1304. Drop down menu 1306 may be populated with user attribute values associated with the user attribute category selected from drop down menu 1304. When attribute category “Sport” is selected from the user attribute category drop down menu, the user attribute value drop down menu is populated with user attribute values describing different sports. The content administrator has selected user attribute value “Skiing” from the user attribute value drop down menu 1306.

If the content administrator does not wish to create an association between a content item and a user attribute, the content administrator may use the content association interface to indicate that content is not to be filtered by user attribute. For example, the content administrator may select “No User Attribute Filter” from user attribute category drop down menu 1304.

The content association interface may allow a content administrator to associate a time with the content item. The time may be a time, date, time range, date range, day of the week, or other indication of time. In the illustrative example shown in FIG. 13, the content administrator has selected “No Time Filter” from time drop down menu 1308. When a time option other than “No Time Filter” is selected, an association is created between the content item and the time selection. In this manner, content items transmitted to the wireless device may be filtered according to time. For example, if the time range “8 AM-Noon” is selected, the content item may be transmitted to a wireless device only during the indicated time range.

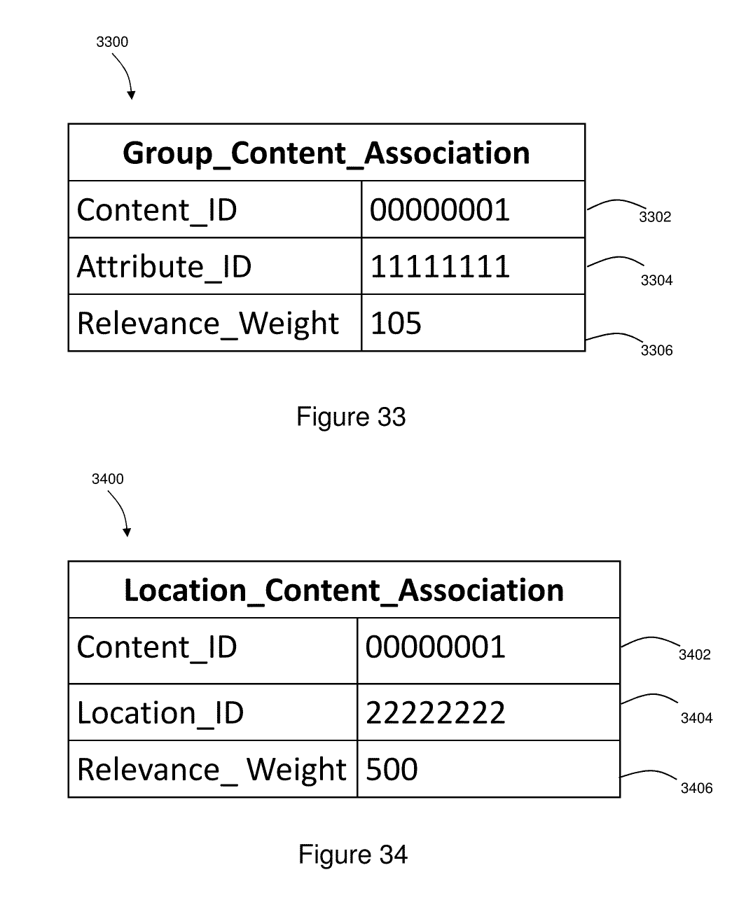

In some embodiments, when an association between a content item and a user attribute value is created, a relevance weighting may be applied to the association. Typically, when a content association having a relevance weighting is created, an entry is made in a database table comprising fields for a content identification, a user attribute identification, and a relevance weight value. An illustrative database table in which an association between a content item and a user attribute is made is shown in FIG. 33. Similarly, when an association between a content item and a time is created, a relevance weighting may be applied to the association. A relevance weight value of 90 has been entered in relevance weighting input box 1310. In some embodiments, only content items having a relevance weight exceeding a preset value are transmitted to the wireless device. The relevance weight value may be adjusted by relevance and analytics module 1128 based on user response to the content item.

Referring now to FIG. 14, an illustrative location interface 1400 is shown. A content administrator may indicate the location of premises map 1402 relative to a street map 1404 using a GIS interface. Magnification bar 1406 allows adjustment of the magnification of street map 1404 to the appropriate scale for placement of the premises map. Magnification bar 1406 comprises increase magnification indicator 1408, decrease magnification indicator 1410, and sliding magnification control 1412. The content administrator may slide the sliding magnification control 1412 in the direction of the increase magnification indicator 1408 to increase the level of magnification of the map and may slide the sliding magnification control 1412 in the direction of the decrease magnification indicator 1410 to reduce the level of magnification of the map. To change the position of the street map 1404 within map window 1414, navigation control 1416 is used. Navigation control 1416 comprises an up arrow, a down arrow, a left arrow and a right arrow. To move the street map in the desired direction, the arrow pointing in the desired direction is selected. Navigation may additionally or alternatively be accomplished by mouse clicking on street map 1404, holding down the mouse button, and moving the mouse to slide the map in the desired direction. It will be recognized that other methods for adjusting street map magnification and street map position within the map window may be used.

To indicate the location of the premises, premises map image 1402 is placed on the street map and positioned relative to the street map. The content administrator selects a map image file to insert over the street map. For example, the content administrator may select browse button 1420 to open a dialog box allowing the content administrator to choose a map image file from a file directory. When an image file has been selected, the name of the image file may appear in a text box as shown at 1422. The content administrator may then upload the selected map, for example, by selecting upload map button 1418. After the map is uploaded, it appears within map window 1414. The premises map image 1402 may be resized and rotated with mouse controls or other interface controls. The content administrator places the premises map image 1402 in the appropriate position relative to street map 1404. For example, the content administrator may place the premises map image by mouse clicking on the premises map image, holding down the mouse button, and dragging the premises map image to the desired position. It will be recognized that other methods for selecting a map image and positioning it at a desired location on a street map may be used. The position of premises map 1402 is stored in computer memory. For example, a set of coordinates representing the longitude and latitude of the corners of the premises map may be derived from the placement location of the premises map relative to the street map. The set of coordinates may be stored in a database table, such as a database table of data storage module 1108. The level of magnification and position of street map 1404 within map window 1414 may also be stored in computer memory to allow the view shown in map window 1414 to be reproduced at a later time. The image file or a string representing a path to the image file may also be stored in computer memory.

In an alternative embodiment, in lieu of a GIS interface, geographical coordinates (e.g., latitude and longitude) or other location information defining the boundaries of the premises are entered at a text prompt and stored in computer memory.

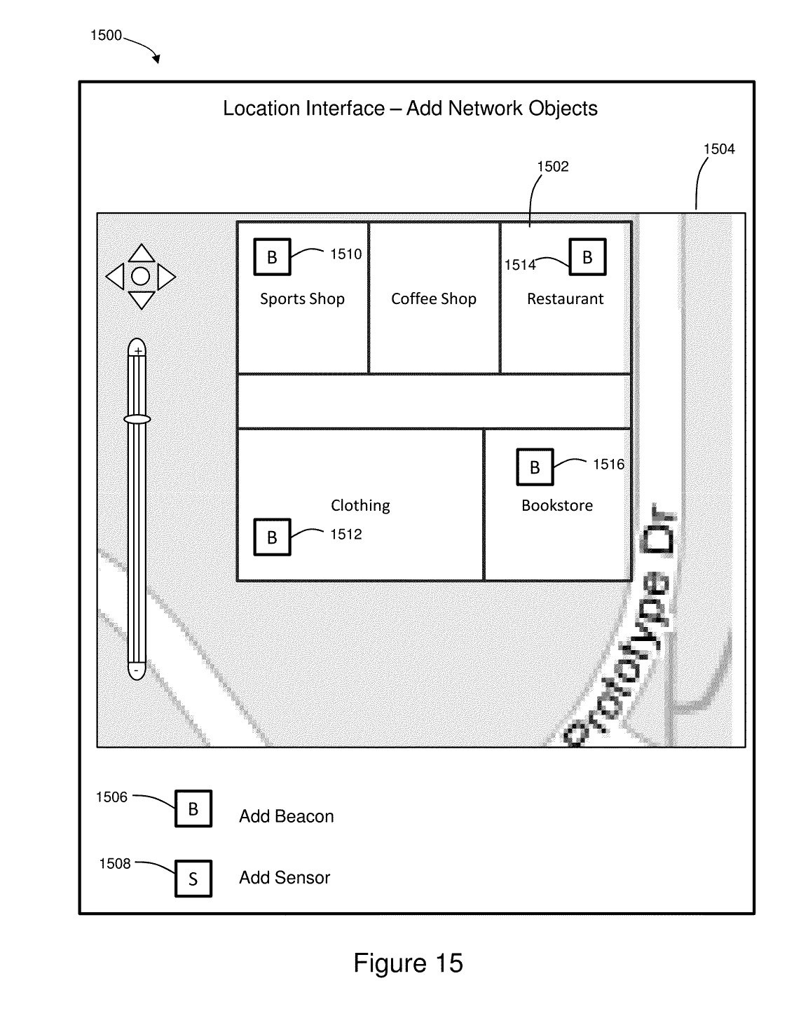

Referring to FIG. 15, an illustrative network object placement interface 1500 is shown. The network object placement interface allows the content administrator to place network object icons on the premises map to indicate the location of the network objects on the premises. The network objects that may be placed on the map include beacons and sensors. In some embodiments, sensors capable of detecting beacon signals are used by location determination module in determining the location of the wireless device. When beacon icon 1506 is selected, a beacon icon appears in map window 1504. The beacon icon may then be placed in a position on the premises map corresponding to the location of the beacon on the physical premises content administrator then drags the beacon icon to the desired location on merchant premises map 1502. For example, the beacon icon may be mouse dragged into place on the premises map. It will be recognized that alternative interface tools may be used to indicate the position of beacons on a premises by placing beacon icons on a premises map. In the illustrative example shown in FIG. 15, beacons 1510, 1512, 1514 and 1516 have been placed on premises map 1502 using the interface. To add a sensor icon to the premises map, the content administrator selects sensor icon 1508 and moves the sensor icon to the position on premises map 1502 corresponding to the location of the sensor on the premises. It will be recognized that a variety of other methods for indicating the location of network objects on a premises map may be used. The geographical coordinates of network objects placed on the premises map are stored in computer memory, for example, in data storage module 1108.

In some embodiments, the interface allows the content administrator to assign an identifier to each network object placed on the premises map using the interface. The network object identifier is stored in association with the location of the network object.

In an alternative embodiment, in lieu of a GIS interface, geographical coordinates or other location information defining the locations of network objects are entered at a text prompt and stored in computer memory.

In another embodiment, a local positioning system is be used in lieu of a geographical positioning system, and stored location coordinates for network objects, geofences, premises maps, virtual reference points, displays, and other system components are defined with respect to an arbitrary point on a premises.

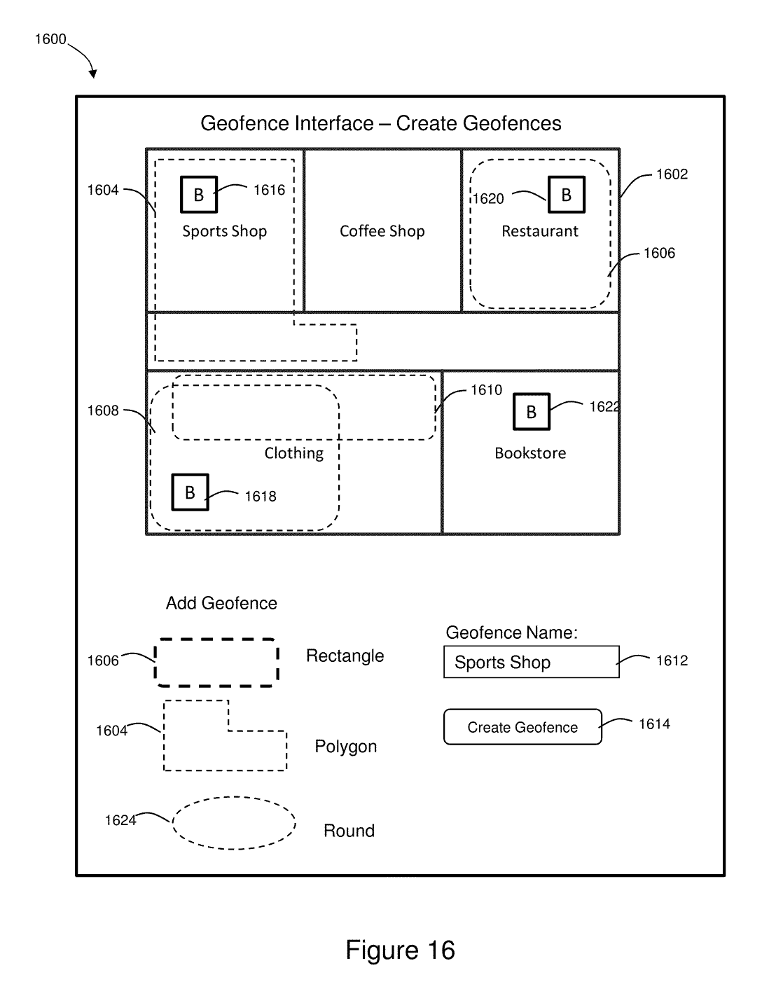

Referring now to FIG. 16, an illustrative geofence creation interface 1600 is shown. A shape drawing tool allows the content administrator to define variously shaped geofences relative to the premises map. When the wireless device location is determined to be within one of the geofences, content associated with the geofence is transmitted to the wireless device to define a content bubble. The content administrator may create a geofence having a rectangular shape by selecting rectangle geofence shape 1606. When the rectangle geofence shape is selected, a rectangular geofence appears on premises map 1602. The rectangle geofence shape may be resized and repositioned as desired. Similarly, the content administrator may create a polygon shaped geofence by selecting polygon geofence shape 1604 and the content administrator may create a round shaped geofence by selecting round geofence shape 1606. When a geofence shape is selected, the content administrator may be prompted to enter a geofence identifier in text input box 1612. After the geofence has been sized and positioned as desired, the content administrator selects the create geofence button 1614 to save the location of the created geofence to computer memory such as data storage module 1108. For example, coordinates indicating the locations of the corners of a rectangle geofence shape or polygon geofence shape or the central point and radius of a circle geofence shape may be stored. In the illustrative example shown in FIG. 16, polygon geofence shape 1604 and rectangle shape geofences 1606, 1608 and 1610 have been created. In some embodiments, the geofence interface shows the locations where beacons have been placed for reference. Beacons 1616, 1618, 1620 and 1622 are shown in the illustrative example of FIG. 16.

Referring to FIG. 17, an illustrative geofence content association interface 1700 is shown. The content administrator may use the geofence content association interface to create an association between a geofence and one or more content items. To create the association, the content administrator selects a geofence identifier from geofence drop down menu 1702 and one or more content items from content item list 1704. Premises map 1706 showing the locations of geofences created with the geofence creation interface may be displayed for reference. After creating the geofence content association, the content administrator selects Create Geofence Content Association button 1708 to save the association. The geofence identifier is stored in association with the selected content items in computer memory, for example, in data storage module 1108. In FIG. 7, geofences 1710, 1712, 1714 and 1716 have been defined, corresponding to the Sports Shop, Restaurant, Clothing-Women's and Clothing-Men's Clothing, respectively. In the illustrative example shown in FIG. 17, the content administrator has created an association between the “Sports Shop” geofence, as indicated at 1702, and the content items “10% Off Ski Equipment” and “Sports Shop Sales” content items, as indicated at 1704.

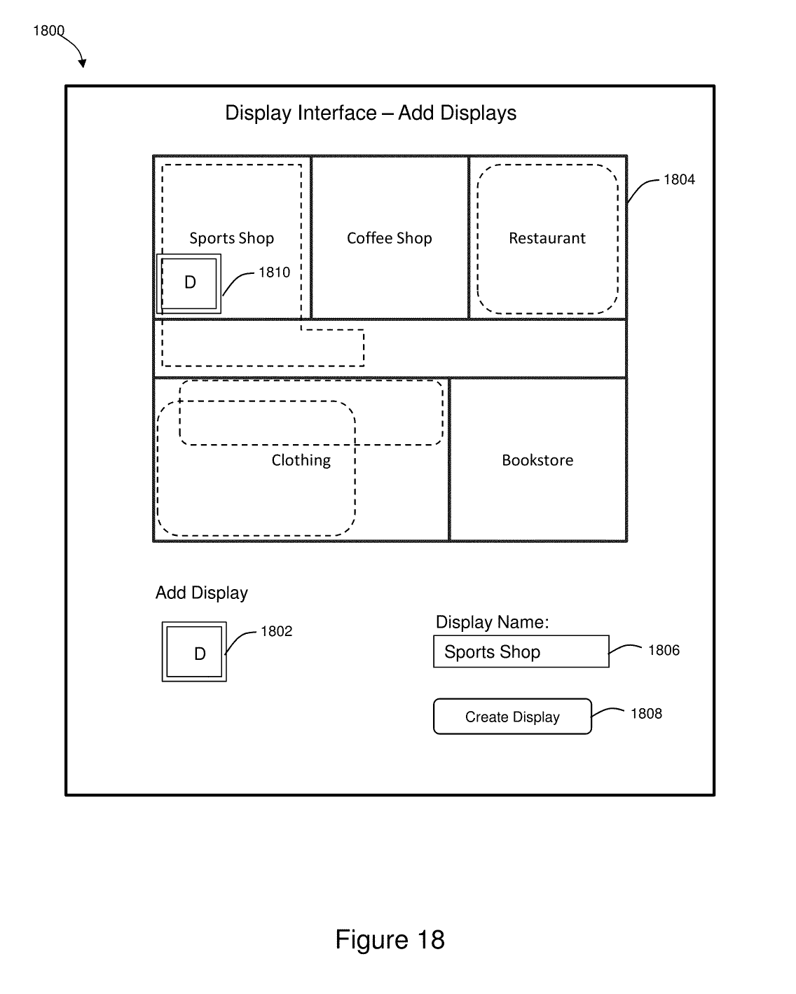

Referring to FIG. 18, an illustrative display placement interface 1800 is shown. Content items include display content items having video, images, text, or other display content to be shown on a display in proximity to the wireless device. In some embodiments, the display is associated with a geofence in which the display is located. When the wireless device is located within the geofence, display content items may be transmitted to the wireless device and shown on the display associated with the geofence. When the content administrator selects display icon 1802, a display icon appears overlaid on premises map 1804. The display icon is moved to the location on the premises map corresponding to the location of the display on the premises. When a display is selected, the content administrator may be prompted to enter a display identifier in text input box 1806. After the display has been placed, the content administrator selects the create display button 1808 to save the location of the created display to computer memory such as data storage module 1108. For example, coordinates indicating the location of the display may be stored. In the illustrative example shown in FIG. 18, display 1810 having display identifier “Sports Shop” has been created. In some embodiments, the display interface shows the locations where geofences have been placed for reference.

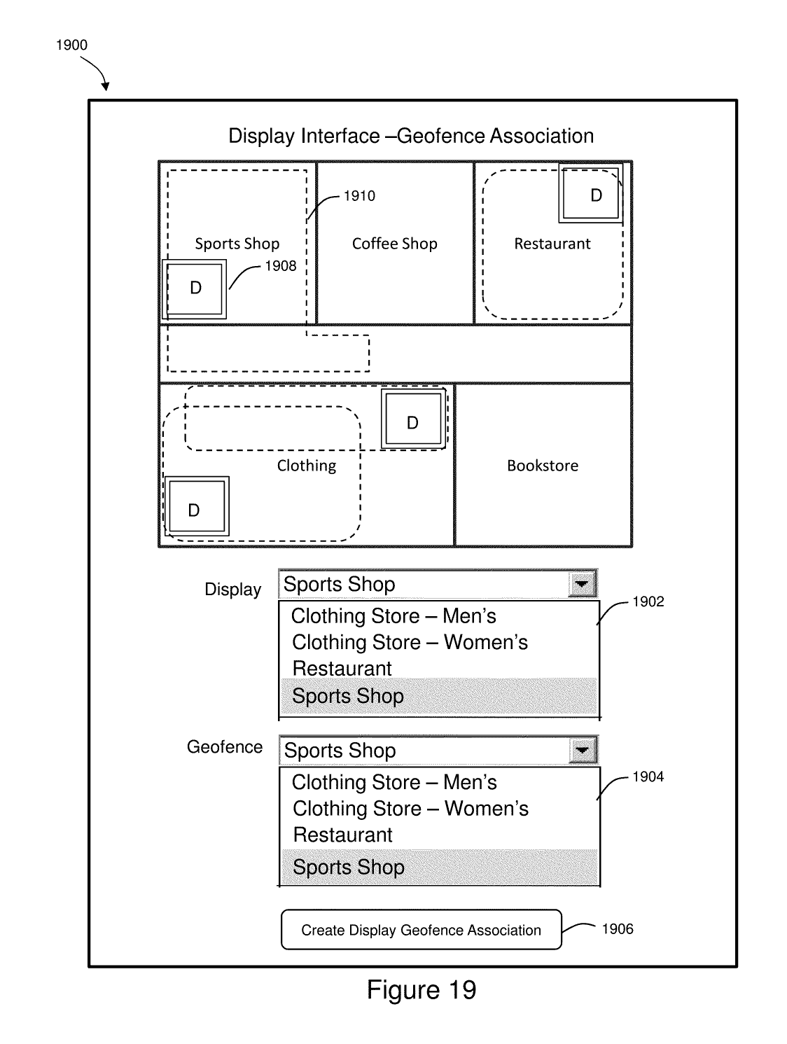

Referring to FIG. 19, an illustrative display geofence association interface 900 is shown. To create a display geofence association, a display is selected from display menu 1902 and a geofence is selected from drop down menu 1904. Create Display Geofence Association button 1906 is selected to store the display geofence association in computer memory. In the illustrative example shown in FIG. 19, display 1908 having display identifier “Sports Shop” has been associated with geofence 1910 having geofence identifier “Sports Shop.”

Storing the location of the display allows the content administrator to view the locations of the displays on the premises map. However, it will be realized that creation of displays and display geofence associations may be performed without storing display locations.

In some embodiments, a content item is associated with a display. For example, a content item list similar to the content item list 1704 of FIG. 17 is used in lieu of geofence drop down menu 1904 of FIG. 19. When a wireless device is located within a predefined distance of the display, as determined by location determination module 1126, content items associated with the display may be transmitted to the wireless device.

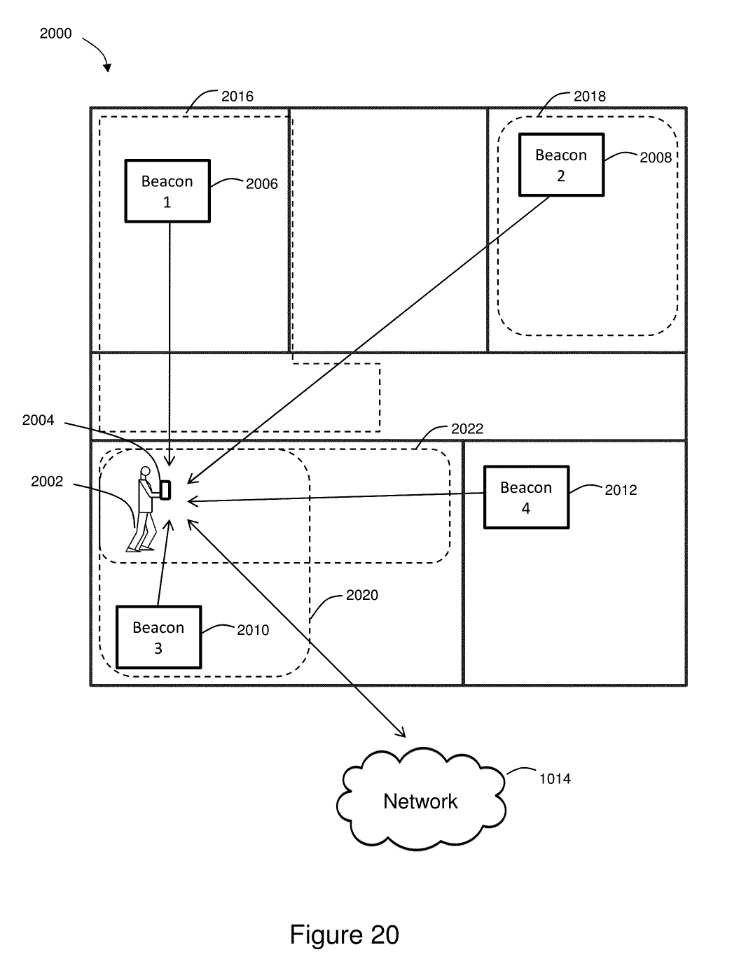

Referring now to FIG. 20, a system diagram 2000 of a beacon network based location detection system for a wireless device is shown. User 2002 carries wireless device 2004. The wireless device receives signals from one or more beacons in its vicinity. In the illustrative example, wireless device 2004 receives signals from beacons 2006, 2008, 2010 and 2012. The wireless device sends a location message to data processing module 1104 via network 2014 indicating the signal strength and signal identifier of each beacon signal detected by the wireless device. Location determination module 1126 uses the location message to determine the location of the wireless device. Using the information contained in the location message, the location determination module determines whether the wireless device is located in one or more of geofences 2016, 2018, 2020 and 2022. If the wireless device is located within a geofence, the wireless device may receive content associated with the geofence via network 2014.

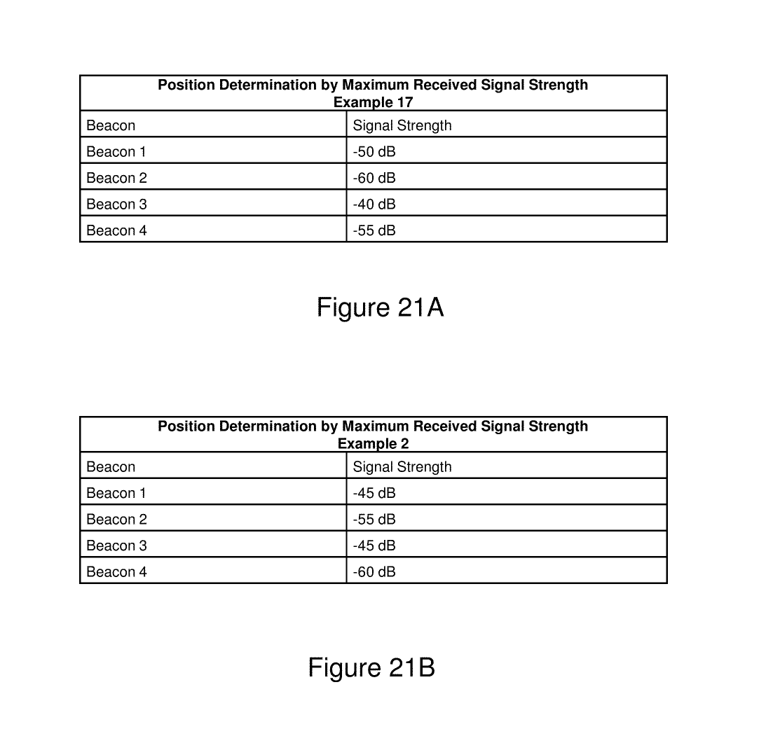

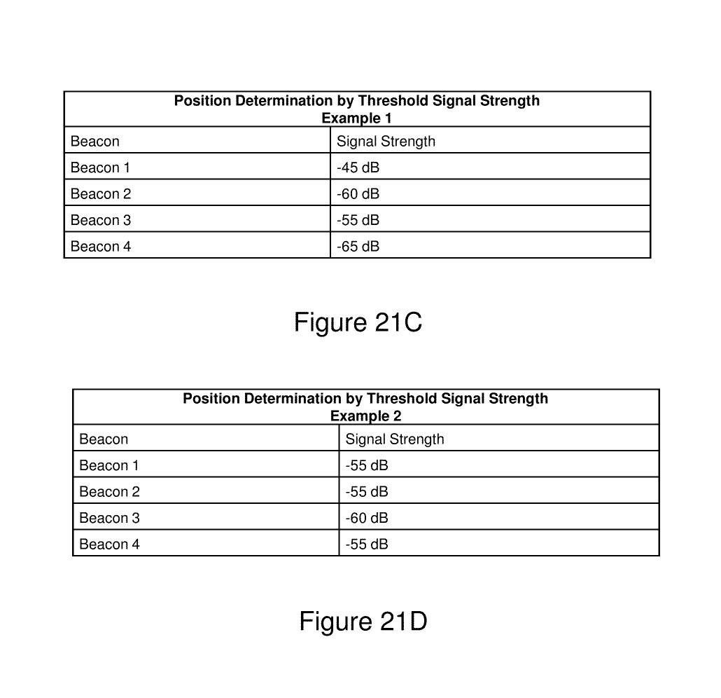

Referring now to FIGS. 21A-21D, illustrative examples of wireless device locations as determined from received beacon signals are shown. The tables of FIGS. 21A-21D indicate the determined location of a wireless device relative to the geofences shown in FIG. 20.

In FIGS. 21A-21B, the location of the wireless device is determined according to the maximum signal strength received from the beacons detected by the wireless device. In FIG. 21A, the wireless device has received signals from Beacons 1, 2, 3 and 4 having signal strengths of −50 dB, −60 dB, −40 dB and −55 dB respectively. Because Beacon 3, shown at 2010 in FIG. 20, has the greatest signal strength as received at the wireless device and Beacon 3 is located within geofence 2020, location determination module 1126 determines the wireless device to be within geofence 2020 as indicated in FIG. 20. The wireless device may receive content associated with the bounded areas indicated by geofence 2020.

To determine the location of the wireless device based on beacon signal strength, the location determination module compares the geographical coordinates of the beacon to the geographical coordinates of the extent of the geofence. In an alternative embodiment, associations between the beacons and geofences may be stored in computer memory.

In FIG. 21B, the wireless device has received signals from Beacons 1, 2, 3 and 4 having signal strengths of −45 dB, −55 dB, −45 dB and −60 dB respectively. Because the wireless device has received the same signal strength from both Beacon 1 and Beacon 3, none of the beacons has the highest signal strength. In this case, the wireless device is determined to be at a location which is an average distance between the two beacons having the greatest signal strength. The wireless device will be determined to be at a location which is the arithmetical average of the geographical coordinates of Beacon 1 and Beacon 3. The wireless device is thus determined to be located within geofence 2016, as geofence 2016 includes a position located halfway between Beacons 1 and 3.

In FIGS. 21C-21D, the location of the wireless device is determined by comparing the strength of beacon signals received at the wireless device to a threshold signal level, such as −50 dB. In FIG. 21C, the wireless device has received signals from Beacons 1, 2, 3 and 4 having signal strengths of −45 dB, −60 dB, −55 dB and −65 dB respectively. Assuming a threshold signal level of −50 dB, only the signal from Beacon 1 exceeds the threshold. Because Beacon 1, shown at 2006 in FIG. 20, has the only signal exceeding the threshold level, the wireless device is determined to be within geofence 2016. If more than one signal level exceeds the threshold level, the device may be determined to be located within the geofence in which the beacon having the highest detected signal strength is located.

In FIG. 21D, the wireless device has received signals from Beacons 1, 2, 3 and 4 having signal strengths of −55 dB, −55 dB, −60 dB and −55 dB respectively. Assuming a threshold signal level of −50 dB, none of the signals received from Beacons 1, 2, 3 and 4 exceed the threshold signal level. Thus, the location of the wireless device relative to the geofences shown in FIG. 20 cannot be determined and the wireless device is determined to be located within none of the geofences.

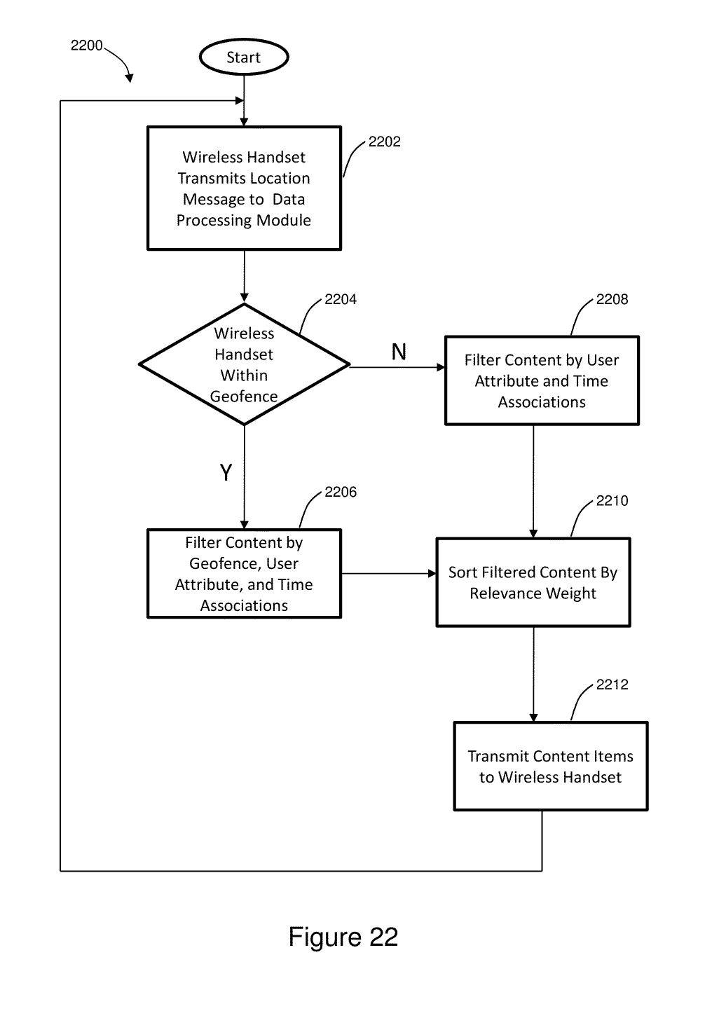

Referring now to FIG. 22, an illustrative flow chart 2200 of a method for delivering targeted content to a user is shown. The method begins at bock 2202, in which the wireless device 1102 transmits a location message to data processing module 1104 via network 1106. The method proceeds to decision diamond 2204, at which location determination module 1126 determines whether the wireless device is located within a geofence. If the wireless device is within a geofence, the method proceeds to block 2206, at which content delivery module 1124 filters content items stored in data storage module 1108 according to geofence, user attribute and time associations created with the interfaces shown in FIGS. 13 and 17. If the wireless device is not within a geofence, the content delivery module filters content items according to user attribute and time associations, as indicated at block 2208. The filtered content is then sorted by relevance weight, as indicated at block 2210. In some embodiments, only content items having a relevance weight exceeding a threshold value are transmitted to the wireless device. In other embodiments, a preset number of highest ranking content items are transmitted to the wireless device. If the number of content items resulting from the filtering process is fewer than a preset number of content items to be transmitted to the wireless device, unfiltered content items may be sorted by relevance weight and added to the content items to be transmitted to the wireless device. The method then proceeds to block 2212, at which content delivery module 1124 transmits the selected content items to the wireless device 1102 via network 1106.

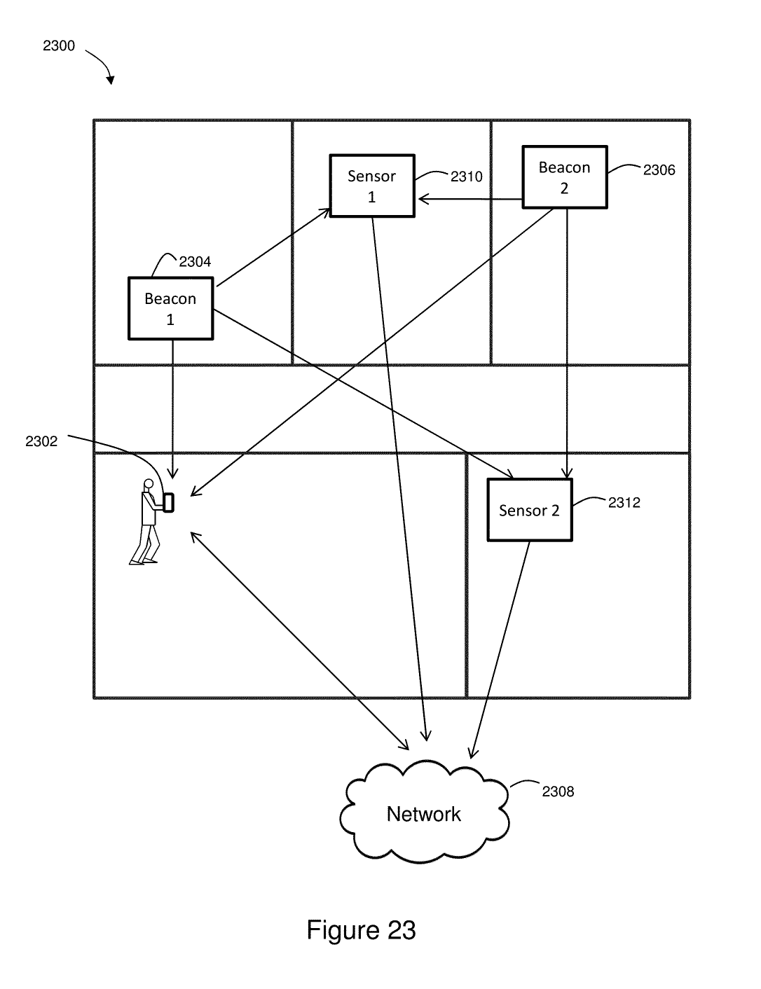

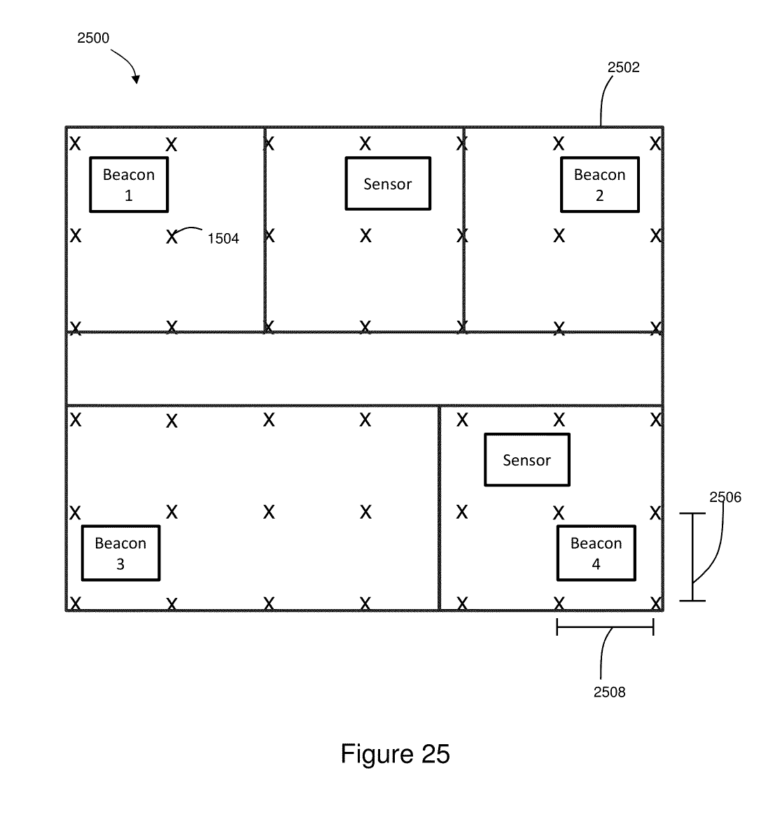

Referring now to FIG. 23, a system diagram 2300 of an illustrative beacon and sensor network based location detection system for a wireless device is shown. The beacon and sensor network comprises a plurality of beacons and one or more sensors. Wireless device 2302 receives signals from one or more of beacons 2304 and 2306. The wireless device sends a location message to data processing module 1104 via network 2308 indicating the signal strength and signal identifier of each beacon signal detected by the wireless device. Sensors 2310 and 2312 also receive signals from one or more of beacons 2304 and 2306. Each sensor transmits a message comprising a signal strength and signal identifier of each beacon signal detected by the sensor to data processing module 1104 via network 2308. The presence of the sensors in the beacon and sensor based location detection system allows the location determination module to take into account changes in the beacon network. Sensors may be able to detect when a beacon is no longer functioning or when a beacon has changed location. The location module may change the stored location of the beacon based on a change in signal strength received from the beacon at one or more sensors. A report to the content administrator may be issued by the data processing module when a change in beacon status is detected. In some embodiments, the sensors are used in building a system of virtual reference points to provide increased accuracy in detection of the location of the wireless device, as described in more detail below with reference to FIGS. 25-28. In this way, sensors may allow the location detection module to take into account changes in the RF environment resulting from temperature, humidity, number of people, number of RF radiators, obstructions and other such variables affecting or causing changes to the RF environment.

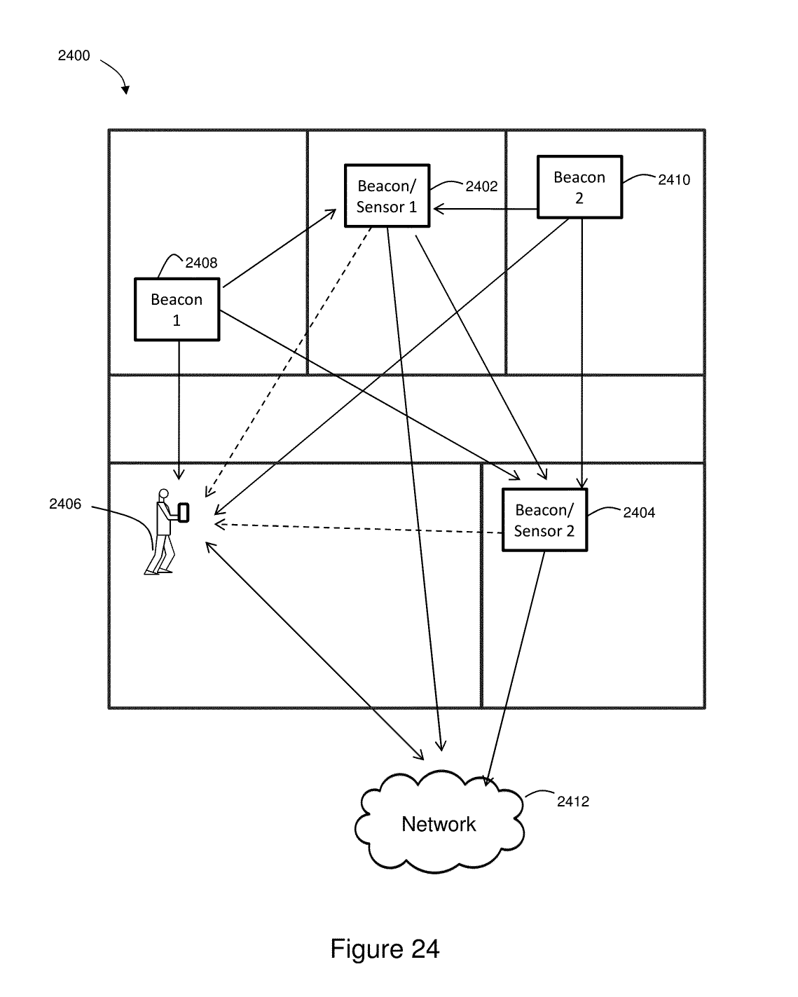

Referring now to FIG. 24, a system diagram 2400 of a beacon and beacon-enabled-sensor network based location detection system for a wireless device is shown. The beacon and beacon-enabled-sensor network comprises a plurality of beacons and one or more beacon-enabled-sensors. Illustrative network objects 2402 and 2404 are beacon-enabled-sensors that are able to transmit and receive signals. The beacon-enabled-sensors may operate in sensing mode and beacon mode simultaneously, or may alternate between modes. In some embodiments, the sensors are configured to periodically switch between sensing mode and beacon mode. The sensors may switch between sensing mode and beacon mode in response to a command provided via the network from a user interface. In some embodiments, the switch between sensing mode and beacon mode may be triggered by information received by sensors capable of detecting, for example, temperature, humidity, number of people, number of RF radiators, and other such variables affecting or causing changes to the RF environment. Wireless device 2406 receives signals from one or more of beacons 2408 and 2410 and beacon-enabled-sensors 2402 and 2404. The wireless device sends a location message to data processing module 1104 via network 2412 indicating the signal strength and signal identifier of the signal from each beacon and beacon-enabled-sensor detected by the wireless device. Beacon-enabled-sensor 2402 receives a signal from one or more of beacons 2408 or 2410 and beacon-enabled-sensor 2404. Beacon-enabled-sensor 2404 receives signals from one or more of beacons 2408 or 2410 and beacon-enabled-sensor 2402. Each beacon-enabled-sensor transmits a message comprising a signal strength and signal identifier of each beacon signal detected by the sensor to data processing module 1104 via network 2412.

Referring now to FIG. 25, an illustrative VRP grid 2500 overlaid on a premises map is shown. The location of the wireless device relative to the premises is determined based on the relationship between the beacon signal profile received at the wireless device and beacon signal profiles calculated at virtual reference points (VRPs). A beacon signal profile, also referred to as a fingerprint, is a set of data comprising the signal strength of each beacon signal received by the wireless device. VRPs are theoretical signal profiles calculated at intervals throughout the premises. Typically, the VRPs are calculated for points in a grid spanning the premises as shown in FIG. 25. VRPs may also be calculated for the area surrounding or proximate to premises 2502. The VRP locations for premises 2502 are represented by Xs, such as the X shown at 2504. Each VRP comprises a theoretical signal strength for each beacon associated with the premises and data indicating a location, such as geographical coordinates. The distance between VRPs in the grid is the interval distance. In some embodiments, a first interval distance is a y-axis interval distance 2506 and a second interval distance is a x-axis interval distance 2508. In other embodiments, the x-axis interval distance is equivalent to the y-axis interval distance and a single interval distance is used.

If a beacon stops emitting a signal, is moved, an obstruction is placed in the vicinity of the beacon, or other changes to the RF environment occur such that the signal profile for the beacon changes on the premises, the sensors are capable of detecting the change. The VRPs may be updated, periodically or in response to a change in a beacon sensor profile received at one or more sensors.

In some embodiments, the VRPs may be shown as a layer in an interface such as the network object placement interface 1500. A VRP layer in the network object placement interface would provide feedback to the content administrator on the accuracy of the location detection system. The user could use the feedback to, for example, reposition sensors and beacons to optimize the location detection system. The VRP layer may also allow the user to indicate VRP locations.

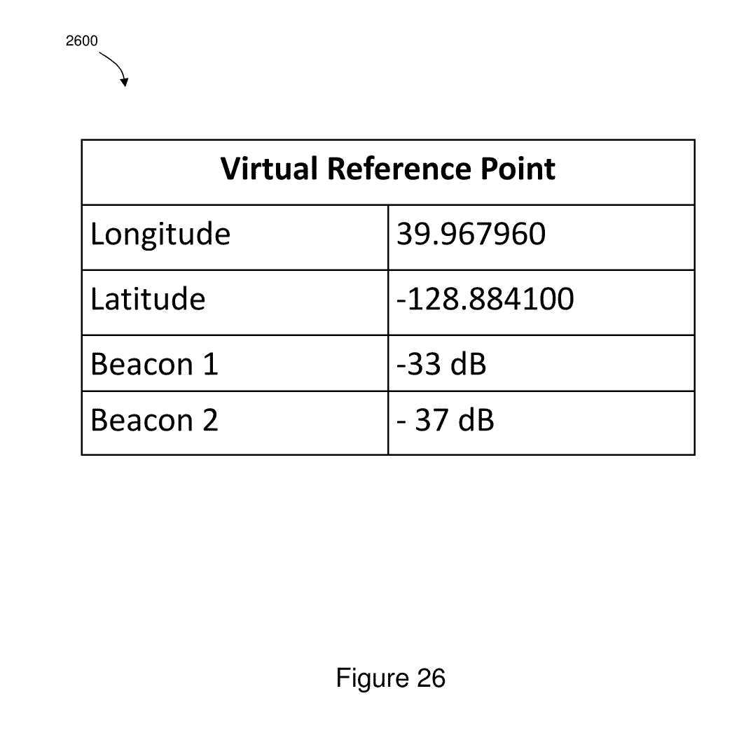

Referring to FIG. 26, an illustrative VRP 2600 is shown. The VRP comprises location coordinates, such as a longitude value and a latitude value indicating the location of the VRP. The VRP further comprises a signal identifier and an RSSI for each beacon associated with the premises. For example, in the illustrative VRP shown, the signal identifier is “Beacon 1” and the RSSI corresponding to Beacon 1 is −33 dB.

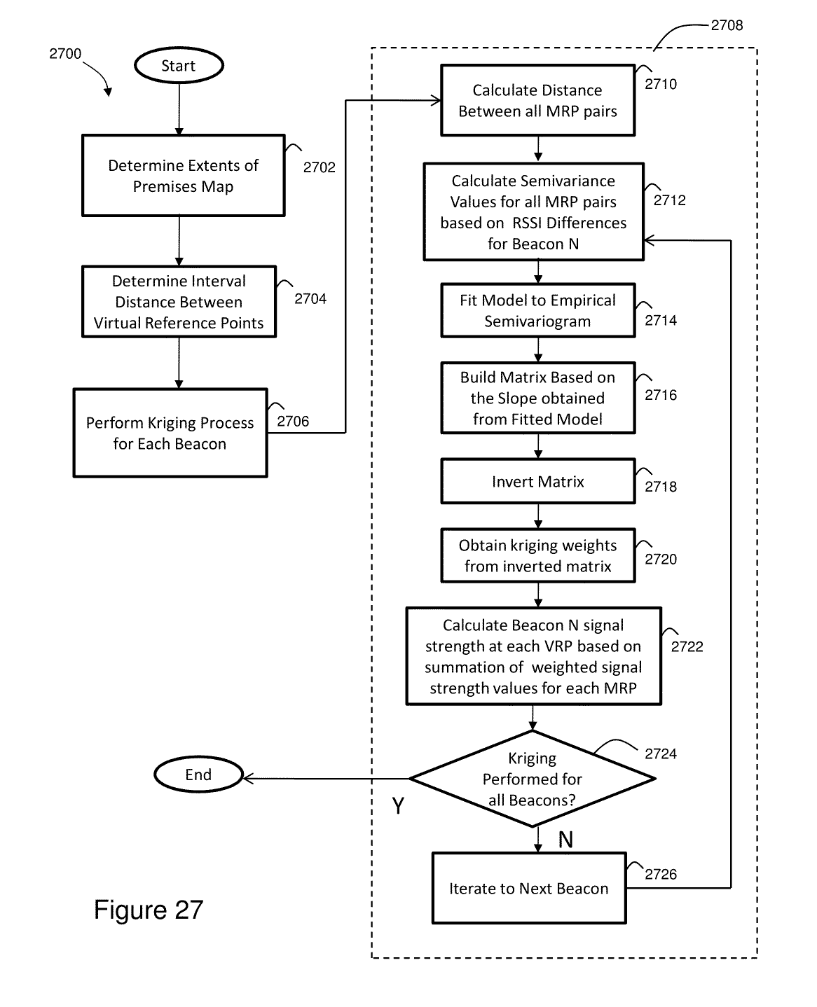

Referring to FIG. 27, an illustrative flow chart of a method for generating VRPs is shown. VRPs are typically calculated by location determination module 126. VRPs may be calculated periodically, for example, once a second, once a minute, hourly, daily, weekly or monthly. In some embodiments, the VRPs are calculated in response to user activity, such as a user request to calculate VRPs placed via content administration interface 1110. The method starts at block 2702, at which the extents of the premises map are obtained from data storage module 1108. The extents of the premises map may be determined from the placement of the map image via the location interface as illustrated in FIG. 14. The method then proceeds to block 2704, at which the interval distance between VRPs is determined. The interval distance is the distance between adjacent VRPs, such as the horizontal or vertical distance between adjacent Xs as shown in FIG. 25. In some embodiments, a first interval distance and a second interval distance are used, wherein a first interval distance is an x-axis interval distance and a second interval distance is a y-axis interval distance. The locations of all VRPs for the premises are generated in a grid similar to the VRPs shown in FIG. 25 based on the specified interval distance(s). The user is able to set the interval distance(s) via content administration interface 1110. In some embodiments, VRPs may be individually placed by the user, for example, using the GIS interface.

The method continues to block 2706, at which a kriging process is performed for each beacon associated with the premises. Kriging is an interpolation method based on the spatial correlation of data. The kriging process as shown within the box indicated at 2708 is performed iteratively for each beacon until it has been performed for all of the beacons associated with the premises. At block 2710, the Euclidian distances between every pair of measured reference points associated with the premises are determined. In other words, the distance between every measured reference point and every other measured reference point is calculated. A measured reference point (MRP) may be a sensor fingerprint or a fingerprint obtained by other measurement means. The calculated distances are stored in system database 1108. The kriging process continues at block 2712, where semivariance values for all MRP pairs are calculated based on the difference in RSSI values the MRPs received from Beacon N. For example, in the first iteration of the kriging process, N=1, so the RSSI value for beacon 1 at the first MRP is compared to the RSSI value for beacon 1 at a second MRP, and the calculation is repeated for each pair of MRPs associated with the premises. At block 2714, an empirical semivariogram based on the values calculated in blocks 2710 and 2712 is fit to a model such as a linear least squares regression (LLSR). At block 2716, a matrix is created based on the slope obtained from the fitted model and the distances calculated in block 2710. The matrix is then inverted as indicated at block 2718. The weights to be used for predicting signal strength values at the VRPs are obtained from the inverted matrix, as indicated at block 2720. The signal strength for beacon N is then calculated at each VRP based on the summation of weighted signal strength values for each MRP, as indicated at block 2722. The method proceeds to decision diamond 2724, at which it is determined whether steps 2712-2722 have been performed for all beacons. If not, the method iterates to the next beacon as indicated at block 2726. When steps 2712-2722 have been performed for all beacons, the method ends.

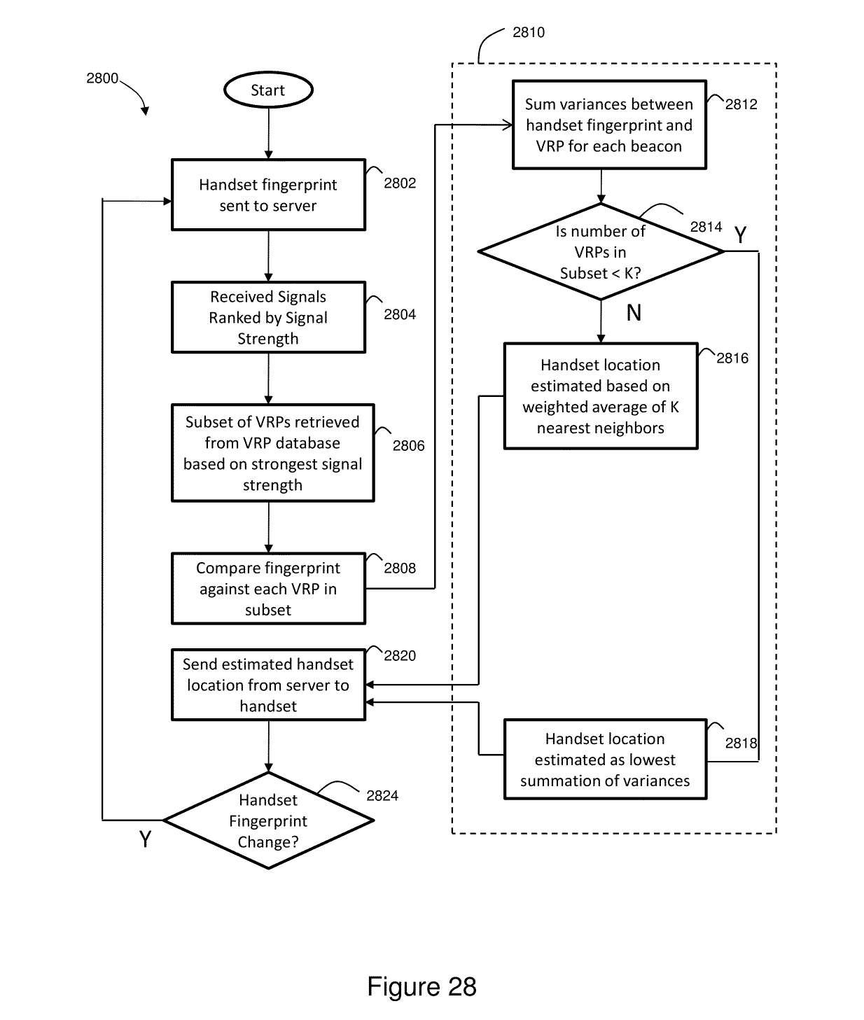

Referring to FIG. 28, an illustrative method for determining the location of a wireless device using VRPs is shown. The location of the wireless device is determined by location determination module 1126. The method begins at block 2802, at which a device fingerprint comprising the signal identification and signal strength of each beacon in range of the device is sent from the wireless device to data processing module 1104. The method continues to block 2804, at which the signals received by the device are ranked by signal strength. The method continues to block 2806, at which a subset of the VRPs are selected from the set of VRPs associated with the premises. The subset of VRPs are those VRPs with a greatest received signal strength from a beacon matching the beacon from which the device received the greatest signal strength. The method continues to block 2808, at which the signals of the device fingerprint are compared to the signals of the subset of VRPs. A K-nearest neighbor algorithm as illustrated at 2810 may be used to determine the outcome of the comparison.

At bock 2812, for each VRP in the subset of VRPs, the variance between the signal level received at the device and the estimated signal level at the VRP is determined for each beacon. At decision diamond 2814, it is determined whether the number of VRPs in the subset is less than an integer value K. If the number of VRPs in the subset is greater than or equal to K, the device location may be estimated to be at a location between the K nearest VRPs. For example, the location of the device may be determined to be at a location that is a weighted average of the nearest neighbors, such that the neighbors having a lower summation of variances contribute more to the average, as indicated at block 2816. If the number of VRPs in the subset is less than K, the device location is estimated to be the location of the VRP having the lowest summation of variances between beacon levels as received at the wireless device and beacon levels estimated at the VRP, as indicated at block 2818. Once the wireless device location has been estimated, the method proceeds to block 2820, at which the estimated location is used to filter content items according to location. For example, the location determination module 1126 may determine whether the wireless device is located within a geofence. If the wireless device is located in a geofence, content items are filtered to return content items associated with the geofence. If the wireless device fingerprint changes, indicating a change in device location, the method begins again at block 2802.

Referring now to FIG. 29, an illustrative relevance interface 2900 is shown. A relevance weight value may be stored in association with a user attribute and a content item, for example, in a database table of data storage module 1108. Additionally, a relevance weight value may be stored in association with a location and a content item. Relevance weight values may be applied to other parameters in association with a content item, for example, a time value or time range. The relevance weight value may be adjusted according to user response to the content item. Relevance interface 2900 allows a content administrator to change the amount by which a relevance value is changed as a result of particular user responses to content items.

In some embodiments, a content administrator may modify a relevance weight value stored in association with a content item and an attribute group for all attribute groups associated with a user. Attribute groups for a user may include information provided by the user, such as a location of the user, a user interest, an age of the user or an age group to which the user belongs. In some embodiments, the attribute groups include information collected about a user, for example, information from the user's transaction history with a merchant. An attribute group is stored in computer memory in association with a user identification, for example, in a database table. A user may provide a response to a content item, for example, by selecting a thumbs up or thumbs down icon displayed in proximity to the content item on the wireless device, giving the content item a rating on a scale, providing a ranking or score for the content item, or selecting or not selecting the content item. When the user provides a user response to a content item, relevance and analytics module 1128 searches data storage module 1108, for example, by performing a database search, to determine each attribute group associated with the user. The relevance and analytics module may then locate the database record in which the content item that received the user response is associated with an attribute group of the user. The relevance and analytics module alters the relevance weight value stored in association with the content item and the attribute group. The process is repeated for each attribute group associated with the user. Although attribute groups are used in the illustrative example, it will be recognized that the relevance weight value may be adjusted for a location or other parameter stored in association with the content item in response to user feedback.

At text input box 2902, the content administrator may enter a number by which the relevance weight value is to be increased when positive feedback is received for a content item. For example, the number entered in 2902 may be applied when a “thumbs up” input is received by device content interface 1112. In the illustrative example shown in FIG. 29, the content administrator has entered the number 5 at text input box 2902, which will result in the relevance weight value associated with the content item and each attribute group associated with a user being increased by 5 when the user provides positive feedback for the content item. Similarly, at text input box 2904, a content administrator may enter a number by which the relevance weight value is to be decreased when negative feedback is received for a content item. For example, the number entered in 2904 may be applied when a “thumbs down” input is received by device content interface 1112. In the illustrative example shown in FIG. 29, the content administrator has entered the number 0 at text input box 2902, indicating that no changes are to be made to the relevance weight value associated with the content item and each attribute group associated with a user when the user provides negative feedback for the content item.

It will be recognized that the numbers shown in the text boxes of FIG. 29 are merely illustrative. Number input in the text box may include numbers consuming up to the maximum storage size allowed for a numeric data type of the database used. In some embodiments, negative numbers may be entered in the text input boxes. Floating point numbers may also be used. The numerical input may be limited to a preset numerical range enforced by the application. The text input boxes may be populated with default values before being altered by a content administrator. The numbers indicated in the text input boxes are stored in computer memory.

In some embodiments, the content administrator may indicate a number by which a relevance weight value is to be adjusted for the content item. For example, in every database record in which a relevance weight value is associated with the content item, the relevance weight value is adjusted. In another embodiment, the relevance weight value is adjusted for all attribute groups stored in association with the content item. In an alternative embodiment, the relevance weight value is adjusted for all locations stored in association with the content item. In a further embodiment, the relevance weight value is adjusted for another parameter stored in association with the content item. At text input box 2906, the content administrator has indicated that in all records in which a content item is associated with a relevance weight value, the relevance weight value is to be increased by 2 points when positive feedback is received. At text input box 2908, the content administrator has indicated that in all records in which a content item is associated with a relevance weight value, the relevance weight value is to be decreased by 3 points when negative feedback is received.

The relevance interface may further allow the content administrator to adjust the relevance weight value associated with content items based on whether or not a content item was selected by a user. Selection of a content item may occur when a user clicks a content item button or otherwise indicates interest in a content item displayed on the device content interface. For example, if a content item is transmitted by content delivery module 1124 in excess of a predetermined number of times without being selected, the relevance weight value may be decremented. At text input box 2910, the content administrator may enter a number of serves required before a decrement occurs. At text input boxes 2912-2914, the content administrator may enter a number of relevance weight points by which the relevance weight value is decremented when then number of serves occurs without the content item being selected. In some embodiments, the decrement occurs regardless of whether the content item has been selected.

Text input box 2912 indicates a decrement value for all users. For every database record associating a relevance weight value with the content item, the relevance weight value is decremented by the number indicated in box 2912 when the content item is served the number of times indicated in box 2910 without being selected. Text input box 2914 indicates a decrement value for attribute groups associated with the user who provided a response to a content item. When the number of serves indicated in box 2910 is reached, all attribute groups associated with the user are identified, then the relevance weight value stored in association with the content item and each of the attribute groups is adjusted by the value indicated in box 2914. Although not indicated in FIG. 29, the relevance weight value stored in association with other parameters, such as location, may be adjusted in response to the number of times a content item is served.

In some embodiments, when counting up to the number specified in box 2910 to determine when “Serves to Trigger Decrement” has been reached, serves are counted at an interval indicated in input in box 2916. In the illustrative example, the content administrator has indicated that a serve of a content item is only to be counted once in each five-minute interval. If a serve has been counted during a five-minute interval, a serve is not counted again until the next five-minute interval begins. In this manner, processing associated with counting serves of content items can be reduced. In some embodiments, the unique serve interval definition 2916 indicates a period of seconds or other time interval.

At 2918, the content administrator may specify the number of relevance weight points by which the relevance weight value is to be increased when a user selects a content item. When a user “clicks through” or otherwise selects or indicates interest in a content item using the device content interface, for every database record in which a relevance weight value is associated with a content item, the relevance weight value is increased by the amount specified in text input box 2918. At 2920, the content administrator may specify the number of relevance weight points by which the relevance weight value is to be increased for all attribute groups associated with the user that selected the content item. When a user selects a content item using the device content interface, for every database record in which an attribute group of the user is associated with a content item, the relevance weight value of the association is increased by the amount specified in text input box 2920.

The content administrator may use text input box 2922 to indicate a value by which a relevance weight value for an association between a location and a content item is to be adjusted when a content item is transmitted to a wireless device at the location. For example, a content item is transmitted to a wireless device located within a geofence because the content item is associated with the geofence, as described with reference to FIG. 17. When the content item is transmitted, the relevance weight value for the association between the content item and the geofence is multiplied by the value indicated in text input box 2922. In another embodiment, when the content item is selected, the relevance weight value for the association between the content item and the geofence is multiplied by the value indicated in 2922. In a further alternative embodiment, an incremental relevance weight point adjustment is used in lieu of a multiplicative adjustment for content item-location associations.

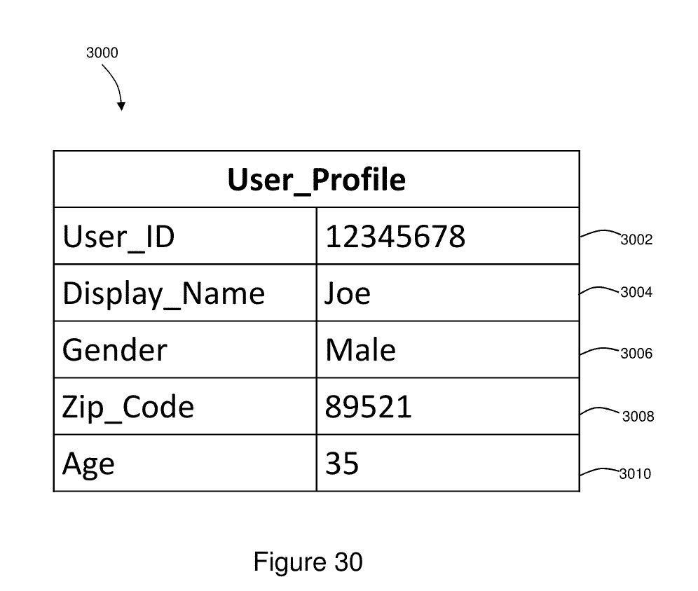

Referring now to FIG. 30, an illustrative database table entry 3000 for a user profile is shown. The terms “database table entry,” “entry,” “database record” and “record” are used interchangeably herein. The table may be populated by the user with information provided via a user profile interface 1114 on the wireless device 1102. In some embodiments, the user enters user profile information using an interface on a home computer or other device having access to network 1106. User profile information may alternatively or additionally be generated based on information collected about the user by a third party, such as a merchant's transaction history with the user. User profile information is transmitted via network 1106 to a database, such as a database of data storage module 1108. The user profile information may be stored in the database in a database table, such as the User_Profile database table 3000. The User_Profile table comprises the field user_ID 3002. User_Profile table 3000 may comprise additional fields such as Display_Name 3004, Gender 3006, Zip_Code 3008 and Age 3010. In some embodiments, a birthday or an age range is stored for the user rather than an age of the user.

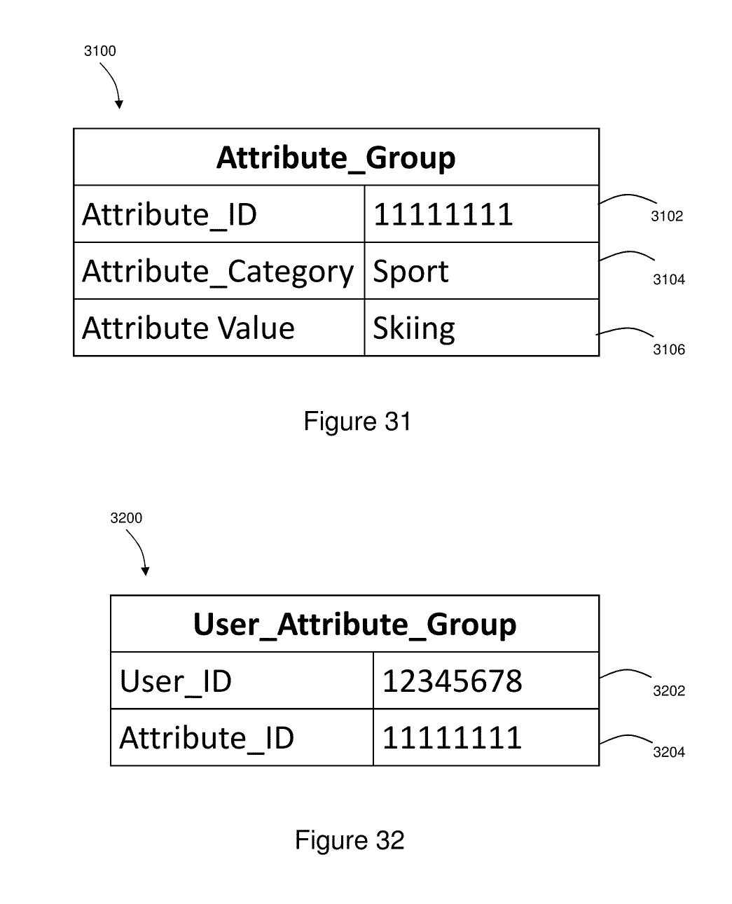

Referring to FIG. 31, an illustrative database table entry 3100 for an attribute group is shown. The Attribute_Group table stores a unique identifier for each attribute group available to be associated with a user. The Attribute_Group table is stored in a database, such as a database of data storage module 1108. The Attribute_Group table comprises fields Attribute_ID 3102 and Attribute_Value 3106. The illustrative Attribute_Group table additionally comprises field Attribute_Category 3104. According to the illustrative entry in the Attribute_Group table, the attribute with the Attribute_ID number 11111111 is an attribute with attribute category “sport” and attribute value “skiing.” If the user indicates skiing as an interest, the attribute ID for skiing may be associated with the user ID in a User_Attribute_Group database table as indicated in FIG. 32.

Referring to FIG. 32, an illustrative database table entry 3200 associating a user identification with an attribute group is shown. The User_Attribute_Group table comprises fields User_ID 3202 and Attribute_ID 3204. The illustrative entry in the User_Attribute_Group table associates user ID “12345678” with attribute id “11111111,” indicating that user “Joe” having user ID 12345678 (as indicated in FIG. 30) is associated with the attribute skiing, identified by attribute ID 11111111. The table entry may have been created with Joe indicated an interest in skiing using a user profile interface or other user interface. Alternatively, a merchant or other content administrator may have determined that Joe is interested in skiing based on, for example, Joe's purchases of skiing equipment from the merchant, and created the User_Attribute_Group table entry shown accordingly.

Referring to FIG. 33, an illustrative database table entry 3300 for associating a content item with an attribute group and storing a relevance weight value for the association is shown. The Group_Content_Rating table comprises fields Content_ID 3302, Attribute_ID 3304 and Relevance_Weight 3306. Content_ID has value “00000001,” indicating a unique identification for a content item. In an illustrative example, content item 00000001 is text advertising a sale on ski equipment. In the illustrative entry, content 00000001 in association with attribute 11111111 (skiing) has a relevance weight value of 105.

By way of illustration, user Joe (having user ID 12345678) has indicated an interest in skiing, resulting in the User_Attribute_Group entry shown in FIG. 32. In the illustrative example, content item 00000001 is the content item “10% Off Ski Equipment” indicated at 1202 in FIG. 12. When Joe provides positive feedback for content item 00000001, all attribute groups associated with Joe and the content item may receive an adjustment to the relevance weight value according to preset adjustment values or relevance weight adjustment values set in Relevance Interface 2900. If, for example, an initial relevance weight value of 100 is used for the association between Content_ID 00000001 (e.g., the skiing advertisement content item) and Attribute_ID 11111111 (e.g., skiing), the positive feedback results in a point increase, for example, a five point increase, resulting in an adjusted relevance weight value of 105.

Referring to FIG. 34, an illustrative database table entry 3400 for associating a content item with a location identifier and storing a relevance weight value for the association is shown. The Location_Content_Rating table comprises fields Content_ID 3402, Location_ID 3404 and Relevance_Weight 3406. Location_ID has value “22222222,” indicating a unique identification for a location.

In some embodiments, the Location_ID is a unique identification associated with a geofence. For example, a database in data processing module 104 may store a set of coordinates corresponding to the area bounded by a geofence is association with a unique Location_ID.

In alternative embodiments, Location_ID may be associated with a zip code, city, GPS coordinates, or a distance range surrounding any of the preceding (e.g., a 300 foot radius surrounding a set of GPS coordinates). Location_ID may alternatively indicate a location determined by scanning a code, such as a QR code, with the wireless device. In a further alternative embodiment, Location_ID corresponds to a location determined using a photograph of the environment taken with the wireless device and an image recognition application.

By way of illustration, content item 00000001 is the content item “10% Off Ski Equipment.” In one example, the wireless device displaying the content item is located in geofence 1710 encompassing the Sports Shop as shown in FIG. 17. Content item “10% Off Ski Equipment” has been associated with the Sports Shop geofence, as indicated in FIG. 17. When the content item “10% Off Ski Equipment” is transmitted to a wireless device located within the Sports Shop geofence, the relevance weight value associated with the location and the content item is multiplied by the point value indicated at location relevance multiplier text input box 2922 of FIG. 29. If, for example, an initial relevance weight value of 100 is used for the association between Content_ID 00000001 (“10% Off Ski Equipment”) and Location_ID 22222222 (the Sports Shop geofence), the relevance weight value is multiplied by the location relevance multiplier 5, resulting in an adjusted relevance weight value of 500.

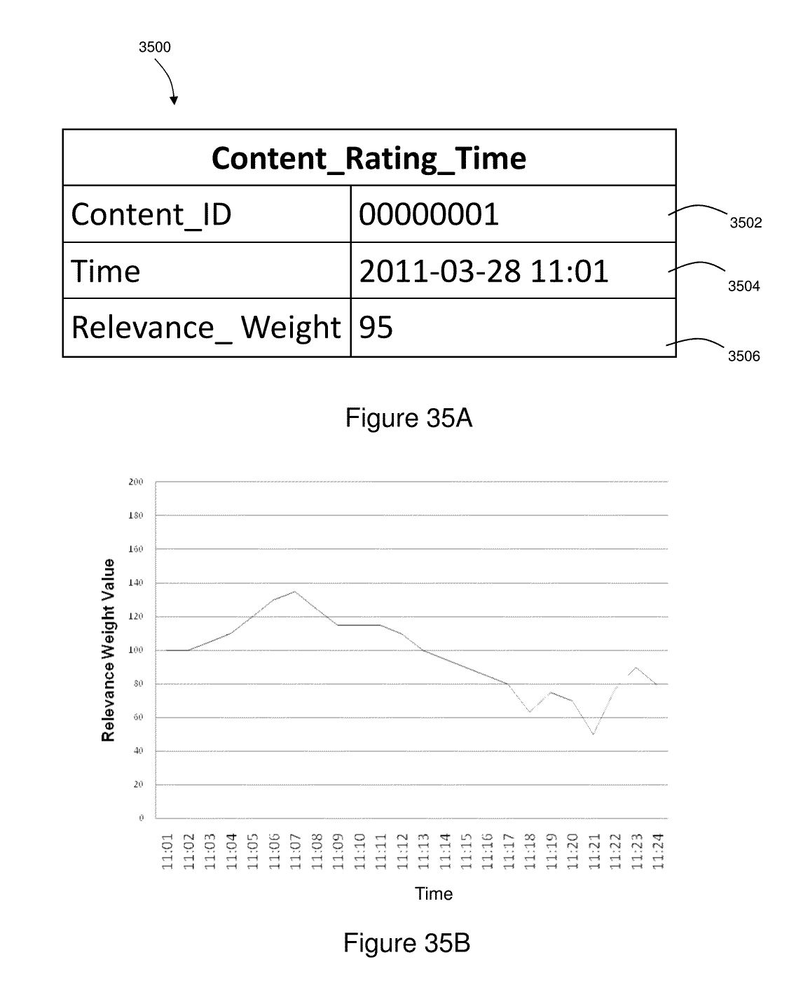

Referring now to FIG. 35A, an illustrative database table entry 2500 associating a time item with an attribute group and storing a relevance weight value for the association. The Content_Rating_Time table comprises fields Content_ID 3502, Time 3504 and Relevance_Weight 3506. Each time the relevance weight for a content item changes, the relevance weight value and time may be logged such that a record of the change in relevance weight for the content item over time as shown in FIG. 35B may be created. The Content_Rating_Time table may further comprise an Attribute_ID or Location_ID field to allow the change in relevance weight value over time to be analyzed for a particular attribute group or location.

Referring to FIG. 35B, a graph showing a change in relevance weight value for a content item over time is shown. The graph shown in FIG. 35B may be created from the entries in the Content_Rating_Time table 3500. The change in relevance weight value over time may be useful to content administrators in assessing the success of content items.

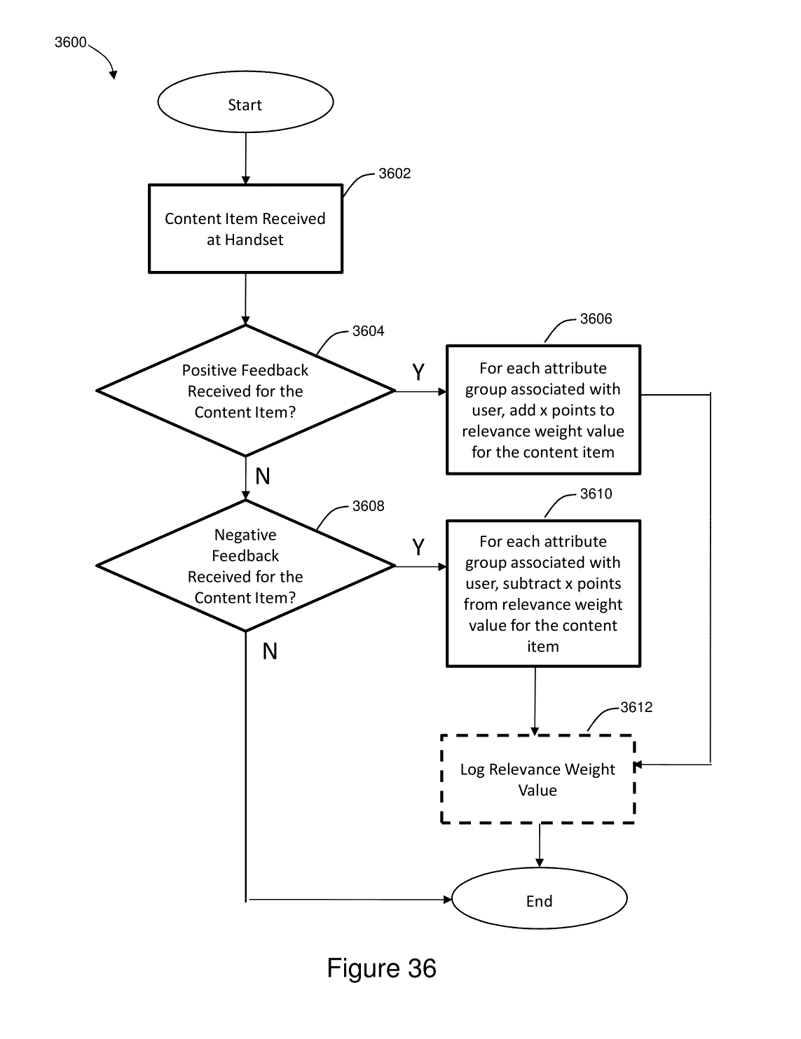

The flow charts of FIGS. 36-39 indicate illustrative methods performed by relevance and analytics module 1128 to adjust the relevance weight values associated with content items.

Referring now to FIG. 36, an illustrative flow chart of a method for adjusting relevance weighting according to a first embodiment is shown. The method begins at block 3602, at which a content item is received at the wireless device 1102. The content item may be one of a plurality of content items displayed on the device. At decision diamond 3604, relevance and analytics module 1128 determines whether positive feedback has been received from the wireless device. If positive feedback has been received for a content item, the method proceeds to block 3606. At block 3606, for each attribute group associated with the user who provided the positive feedback, a point value x, such as the point value indicated at text input box 2902 of FIG. 29, is added to the value of the Relevance_Weight field of the Group_Content_Rating entry having a Content_ID value matching the content item identifier and an Attribute_ID value matching the attribute identifier.

For example, if user 12345678 (display name “Joe”) provides positive feedback for the content item having content identifier 00000001, all attribute groups associated with user 12345678 are located. Accordingly, the User_Attribute_Group table is queried to return all entries for user 12345678. Since the attribute having attribute identifier 11111111 is associated with user 12345678 in the User_Attribute_Group table, the relevance weight associated with Attribute_ID 11111111 will be modified for the selected content item. In the Group_Content_Rating table, the value of Relevance_Weight is adjusted for the entry having Content_ID 00000001 and Attribute_ID 11111111. Because positive feedback was provided, a point value is added to the current value of Relevance_Weight. For example, using the relevance point value entered in text input box 2902, when positive feedback is provided, 5 points are be added to the current value of Relevance_Weight.

If no entry exists in Group_Content_Rating table having an Attribute_ID matching an attribute of the user providing feedback and a Content_ID of the content item for which feedback was received, a new entry is created in Group_Content Rating when the feedback is received. The new entry has a Content_ID matching the identifier of the content item for which feedback was received and an Attribute_ID matching the identifier of an attribute of the user providing feedback. When a new entry is created, the new entry may have a Relevance_Weight value that is a default value.

Alternatively, the new entry may have a Relevance_Weight value that is the sum of a default value and the point value modification resulting from the user feedback.

If additional attribute entries were located for user 12345678 in the User_Attribute_Group table, the Relevance_Weight value is adjusted for the additional attributes. The process of creating new records (where necessary) and modifying the Relevance_Weight value is continued until the relevance weight has been adjusted for each attribute group associated with the user.

In some embodiments, the method proceeds to optional block 3612, at which the adjusted relevance weight value is logged. For example, an entry in a database table such as Content_Rating_Time may be made.

If no positive feedback is received for a content item, the method proceeds to decision diamond 3608, at which it is determined whether negative feedback has been received for the content item. If negative feedback has been received, the method proceeds to block 3610. At block 3610, for each attribute group associated with the user who provided the negative feedback, a point value is subtracted from the value of the Relevance_Weight field of the Group_Content_Rating entry having a Content_ID value matching the content item identifier and an Attribute_ID value matching the attribute identifier. If no entry in the Group_Content_Rating table exists for the Content_ID and Attribute_ID, a new entry is created as described above. The method then proceeds to optional step 3612 at which the relevance weight value is logged.

In some embodiments, the addition operation described at 3606 is applied to adjust the relevance weight value of a content item in association with a location in which a wireless device is located. In lieu of adding x points to the relevance weight value for the content item for each attribute group, x points are added to the relevance weight value for the association of content item with the location of the wireless device. Similarly, the subtraction operation described at 3610 may be applied to adjust the relevance weight value of a content item in association with a location in which a wireless device is located. The addition and subtraction operations described in 3606 and 3610 may be similarly applied to adjust the relevance weight value of a time or other parameter stored in association with a content item.

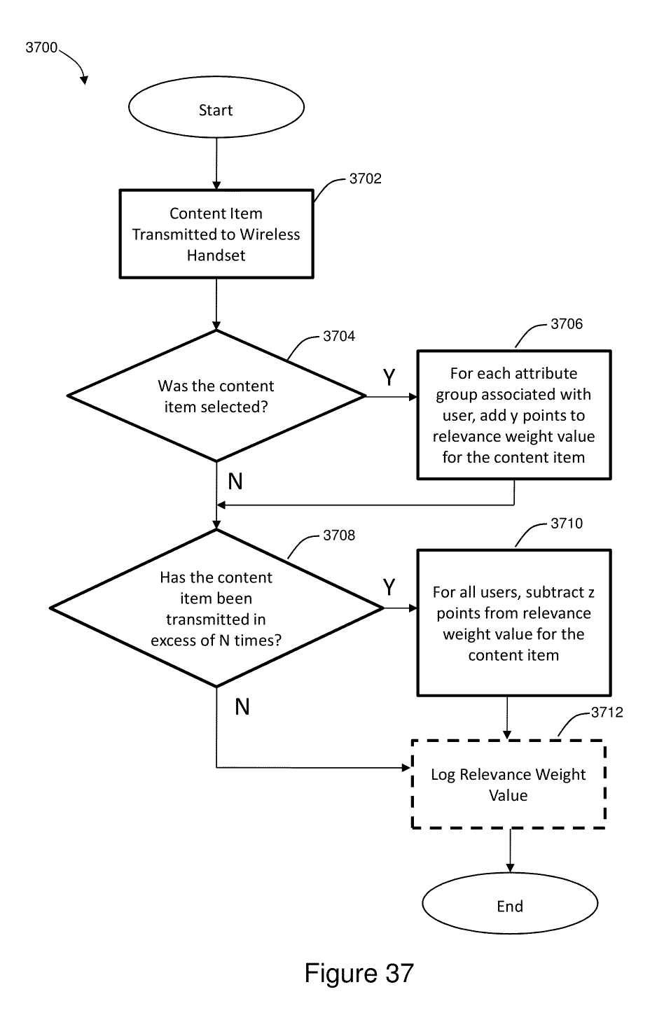

Referring now to FIG. 37, an illustrative flow chart of a method for adjusting relevance weighting according to a second embodiment is shown. The method begins at block 3702, at which a content item is transmitted to the wireless device 1102. The content item may be one of a plurality of content items displayed on the device. At decision diamond 3704, relevance and analytics module 1128 determines whether the content item was selected. A user may select a content item by, for example, clicking a content item button. If the content item is selected, the method proceeds to block 3706. At block 3706, for each attribute group associated with the user who provided the positive feedback, a point value y, such as the point value indicated at text input box 2920 of FIG. 29, is added to the value of the Relevance_Weight field of the Group_Content_Rating entry having a Content_ID value matching the content item identifier and an Attribute_ID value matching the attribute identifier. Point value y may be any point value, for example, 2 points. If no entry in the Group_Content_Rating table exists for the Content_ID and Attribute_ID, a new entry is created as described above

The method proceeds to block 3708, at which the relevance weight adjustment module determines whether a content item has been transmitted by content delivery module 1124 in excess of N times. N may be, for example, a number of times a content item is delivered from content delivery module 1124 to a particular wireless device or to all wireless devices capable of receiving the content. N may be a preset value or a value entered into a relevance interface, such as the unique content serves value indicated at text input box 2910 of FIG. 29. If the content item has been transmitted in excess of N times, z points are subtracted from the value of the Relevance_Weight field of the Group_Content_Rating entry having a Content_ID value matching the content item for all users. Point value z may be any point value, such as the decrement value indicated at text input box 2912 of FIG. 29.

To adjust the Relevance_Weight field for all users, an attribute group having a predetermined Attribute_ID, for example, Attribute_ID 00000000, may be associated with every contact ID. For example, each time a new User_ID is created, User_Attribute_Group may receive an entry associating the new User_ID with Attribute_ID 00000000. The Relevance_Weight value may be adjusted for the Group_Content_Rating entry having a Content_ID value matching the delivered content item and Attribute_ID 00000000. In this manner, the relevance weight is adjusted for all users when a content item has been transmitted in excess of N times.

The method proceeds to optional step 3712 at which the relevance weight value is logged.

In some embodiments, the addition operation described at 3706 is applied to adjust the relevance weight value of a content item in association with a location in which a wireless device is located. In lieu of adding y points to the relevance weight value for the content item for each attribute group, y points are added to the relevance weight value for the association of content item with the location of the wireless device. Similarly, the subtraction operation described at 3710 may be applied to adjust the relevance weight value of a content item in association with a location in which a wireless device is located. The addition and subtraction operations described in 3706 and 3710 may be similarly applied to adjust the relevance weight value of a time or other parameter stored in association with a content item.

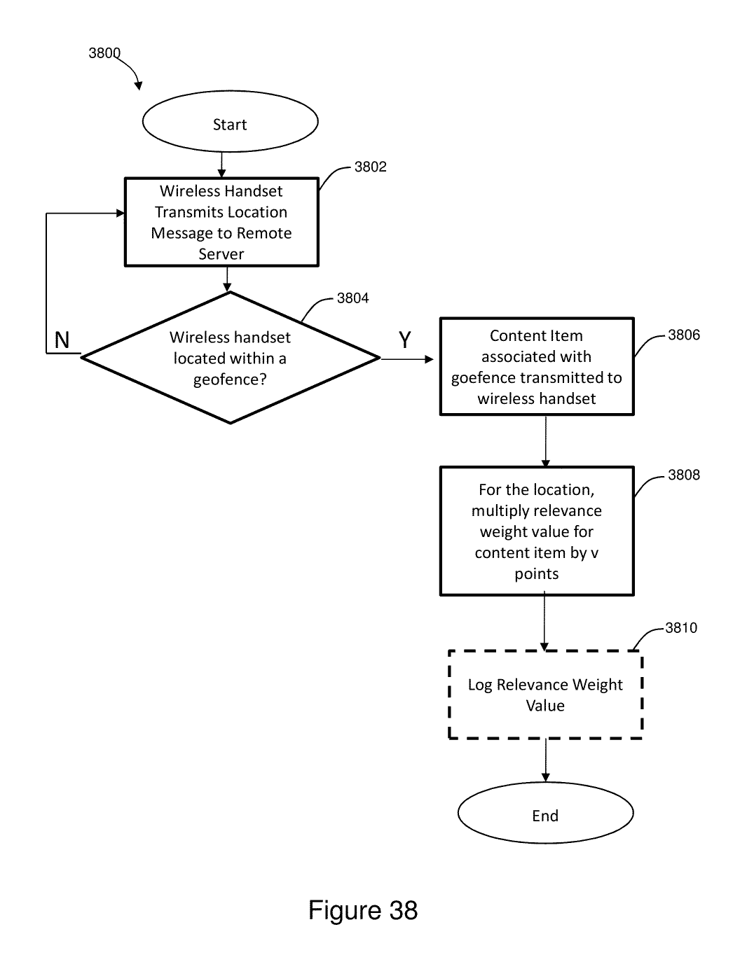

Referring now to FIG. 38, an illustrative flow chart indicating a method for adjusting relevance weighting according to a third embodiment is shown. The method begins at block 3802, at which a wireless device transmits a location message to data processing module 1104. The location message comprises information about the location of the wireless device. The location is identified by unique identifier Location_ID. At decision diamond 3804, location determination module 1126 uses the location message to determine if wireless device 1102 is within a geofence. If the wireless device is located within a geofence, one or more content items associated with the geofence are displayed on the device content interface, as indicated at block 3806. The method proceeds to block 3808, at which at which a point value v is multiplied by the value of the Relevance_Weight field of the Location_Content_Rating entry having a Content_ID value matching the content item identifier and an Location_ID value matching the location identifier. Point value v may be any point value, for example, such as the point value indicated at text input box 2922 of FIG. 29.

In some embodiments, the relevance weight associated with the content item and the location is reset to a default value or an initial value stored prior to a multiplication of the relevance weight by point value v. For example, when the Relevance_Weight field of the Location_Content_Rating is changed, the initial value of Relevance_Weight prior to the change and the time of the change is logged. When a time period such as 5 minutes, a half hour, an hour or a day has elapsed since the change, the Relevance_Weight is reset to the initial value. In another embodiment, if location determination module 1126 determines that no wireless devices are located within a geofence, all entries in which the relevance weight is associated with the location are reset to an initial or default value.

If no entry exists in Location_Content_Rating table having an Attribute_ID matching an attribute of the user providing feedback and a Content_ID of the content item for which feedback was received, a new entry is created in Location_Content_Rating when the feedback is received. The new entry has a Content_ID matching the identifier of the content item for which feedback was received and a Location_ID matching the identifier of an attribute of the user providing feedback. When a new entry is created, the new entry may have a Relevance_Weight value that is a default value. Alternatively, the new entry may have a Relevance_Weight value that is the sum of a default value and the point value modification resulting from the user feedback.

In some embodiments, the method proceeds to optional block 3808, at which the adjusted relevance weight value is logged. For example, an entry in a database table such as Content_Rating_Time may be made.

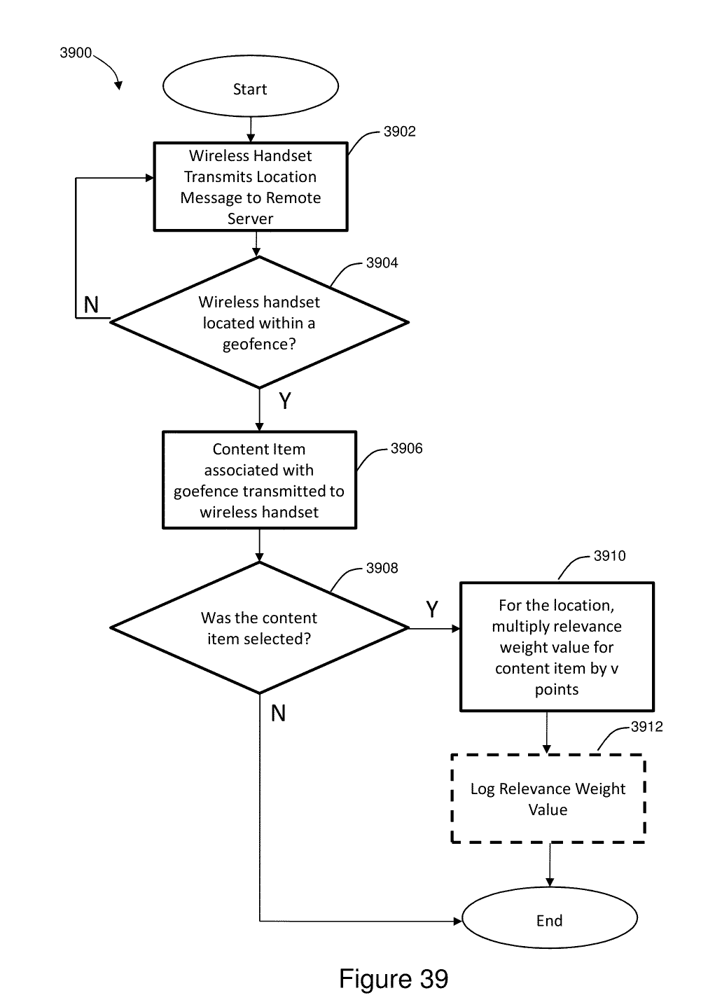

Referring now to FIG. 39, an illustrative flow chart indicating a method for adjusting relevance weighting according to a fourth embodiment is shown. The method begins at block 3902, at which a wireless device transmits a location message to data processing module 1104. The location message comprises information about the location of the wireless device. The location is identified by unique identifier Location_ID. The location message comprises information about the location of the wireless device. The location is identified by unique identifier Location_ID. At decision diamond 3904, location determination module 1126 uses the location message to determine if wireless device 1102 is within a geofence. If the wireless device is located within a geofence, one or more content items associated with the geofence are displayed on the device content interface, as indicated at block 3906. The method proceeds to decision diamond 3908, at which the relevance and analytics module determines if a content item transmitted to the wireless device was selected. If a content item was selected, a point value v is multiplied by the value of the Relevance_Weight field of the Location_Content_Rating entry having a Content_ID value matching the content item identifier and an Location_ID value matching the location identifier, as indicated at block 3910. Point value v may be any point value, for example, such as the point value indicated at text input box 2922 of FIG. 29.

In some embodiments, the method then proceeds to optional step 3912 at which the relevance weight value is logged.

In some embodiments, the relevance weight associated with the content item and the location is reset to a default value or an initial value stored prior to a multiplication of the relevance weight by point value v. For example, when the Relevance_Weight field of the Location_Content_Rating is changed, the initial value of Relevance_Weight prior to the change and the time of the change is logged. When a time period such as 5 minutes, a half hour, an hour or a day has elapsed since the change, the Relevance_Weight is reset to the initial value. In another embodiment, if location determination module 1126 determines that no wireless devices are located within a geofence, all entries in which the relevance weight is associated with the location are reset to an initial or default value.

The multiplication operation described at 3808 and 3910 may be applied to adjust a relevance weight value for a content item stored in association with a time, all users or each attribute group associated with a user. Similarly, the reset operation described above may be applied to adjust a relevance weight value for a content item stored in association with a time, all users or each attribute group associated with a user.

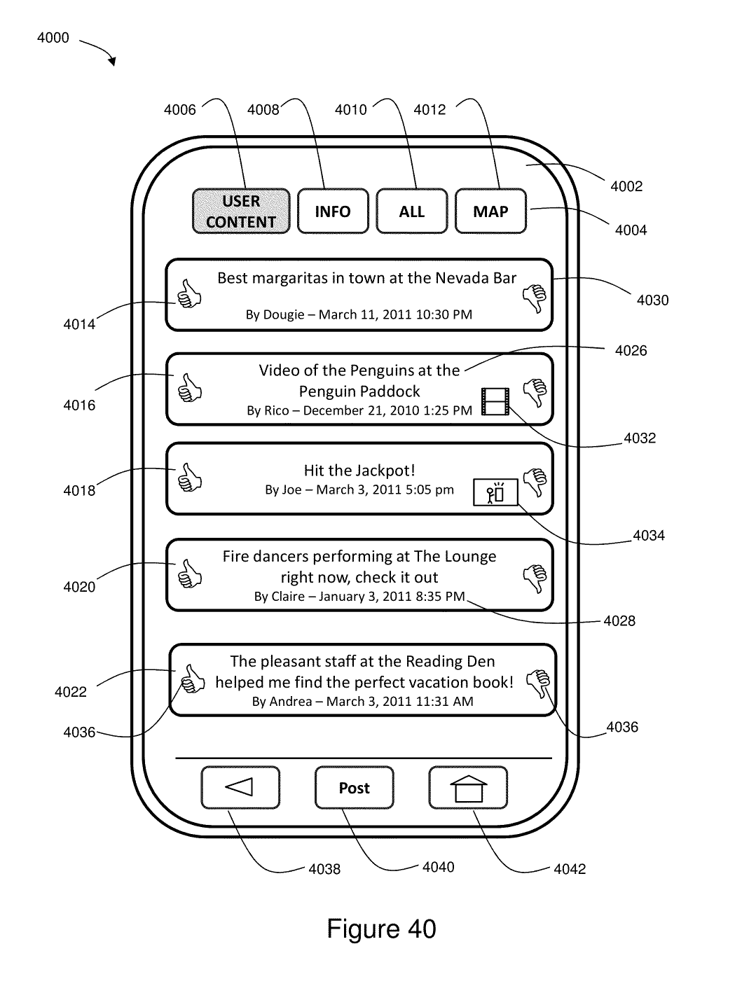

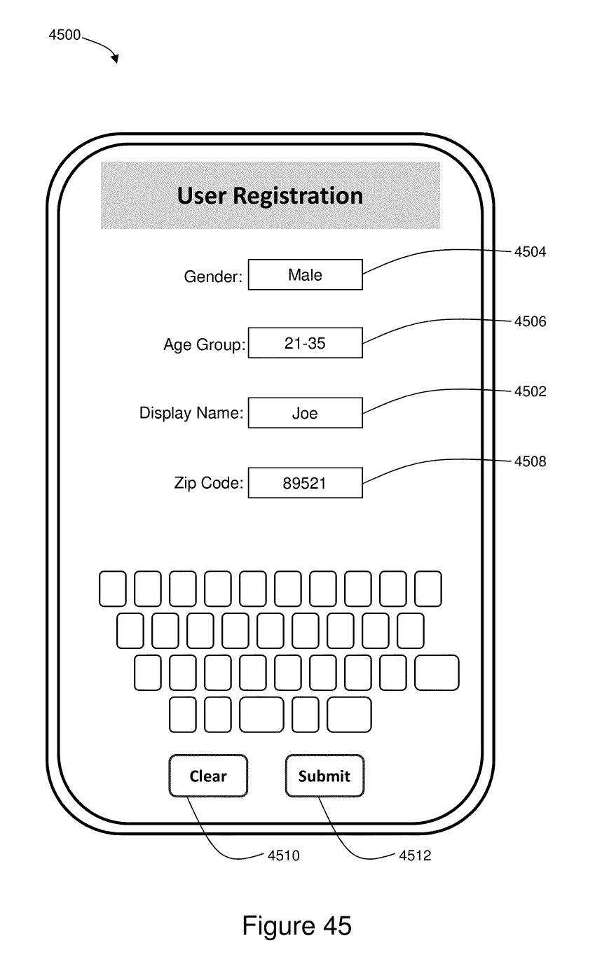

FIGS. 40-44 show an illustrative device content interface 1112 of wireless device 1102. The device content interface may comprise one or more pages to organize content items and other interface features. FIG. 45 shows an illustrative user profile interface 1114 of wireless device 1102.

Referring now to FIG. 40, an illustrative “User Content” page of the device content interface is shown. Illustrative user interface 4000 is shown displayed a wireless device having a touchscreen-type interface 4002, however, it will be appreciated that the user interface may be displayed on any handheld wireless device having a display and a user input means (such as keypad, touchscreen interface, or stylus). Top menu bar 4004 comprises top menu items “User Content” 4006, “Info” 4008, “All” 4010, and “Map” 4012. In the illustrative user interface, the top menu items are selectable items such as virtual buttons that are activated when the user touches the button on a touchscreen or selects the button with a pointing device. In FIG. 40, user content button 4006 is highlighted, indicating that user content is the selected item from the top menu. When the user content menu item is selected, the user interface displays the user content page. The user content page comprises one or more user-created content items. Illustrative user-created content items 4014-4022 are displayed on the illustrative user content page.

The user-created content item comprises user input text, such as the text shown at 4026. The user-created content item may also comprise a timestamp 4028. Timestamp 4028 comprises information about when the user-created content item was posted. The timestamp may be displayed as a time, date, or combination of time and date. The timestamp may further comprise the username of the user that posted the user-created content item.

In some embodiments, the user-created content items are displayed in the user interface as clickable buttons. When the user-created content item button 4030 is selected, the display may show additional content associated with the user-created content item, such as a child content item of a selected parent content item. The user-created content item may link to content such as video, audio, images, and external website links. In some embodiments, an icon is shown proximate to the user-created content item to indicate a type of additional content associated with the user-created content item. For example, icon 4032 is a video icon indicating that the user may access video by clicking user-content item 4016. When the additional content is graphical content such as an image or video, a thumbnail of the image or video may be shown. The additional content of content item 4018 is an image, as indicated by thumbnail 3034. Typically, when a parent content item is selected, the wireless device transmits a request to data processing module 1104 for all child content items of the parent content item. The child content items are then displayed in the user interface.

A feedback input may be displayed proximate to or in conjunction with each user-created content item. The feedback input allows a user to react to the content items displayed. The feedback input may be displayed, for example, as “thumbs up” and “thumbs down” symbols displayed on a user-created content item button, as shown at 4036. The thumbs up and thumbs down input prompts are operable separately from the content item button. When a user selects a feedback input prompt, the wireless device transmits a feedback message to data processing module 1104 indicating that a positive feedback response (“thumbs up”) or negative feedback response (“thumbs down”) was selected. The feedback message may also comprise information about the user, such as a username or user identification. Alternative feedback input means, such as a system that allows a user to ranks the content, score the content or rate a content item on a scale, such as a scale of one to ten or a scale of one to five, may be used.

The feedback input may be stored in data storage module 1108. Typically, the feedback input is used to modify a relevance weight value stored in association with the content item. The relevance weight may be used to rank content to be displayed in the user interface. The content items transmitted from the remote server to the wireless device may be filtered by relevance weight value such that a predetermined number of highest ranked content items are returned or such that only those content items exceeding a predetermined threshold are returned. The content administrator may set the relevance weight threshold using the content administration interface.

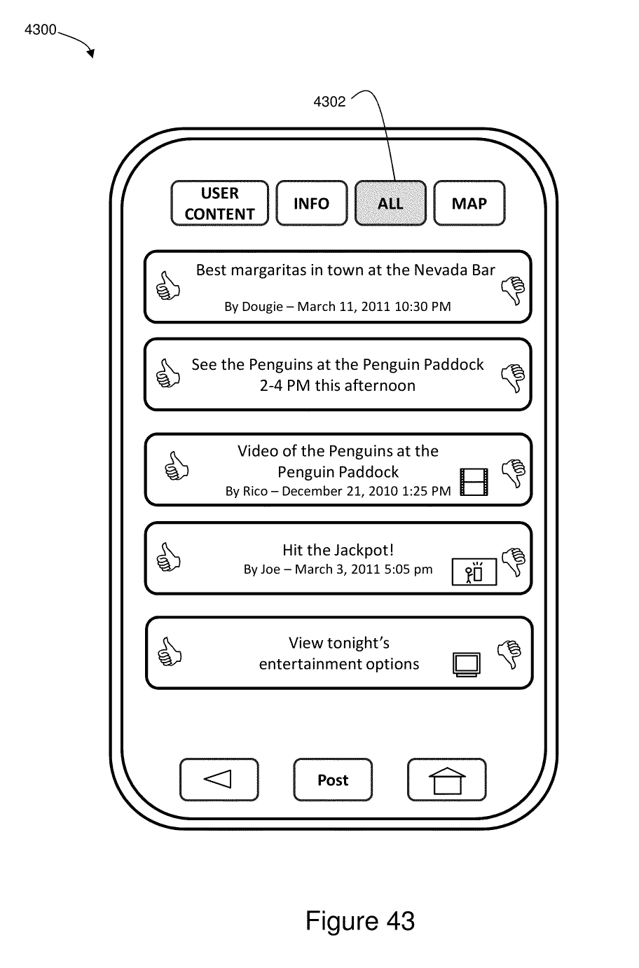

User interface controls 4038-4042 may be displayed on one or more pages of the user interface. When back control 4038 is selected, the page displayed prior to the current page is displayed. When home control 4042 is selected, the main page of the user interface is displayed. For example, if the all content page (selected with button 4010 and shown in FIG. 43) is the main page of the user interface, the all content page will be shown when the home control is selected. When post control 4040 is selected, the user content input page is shown.

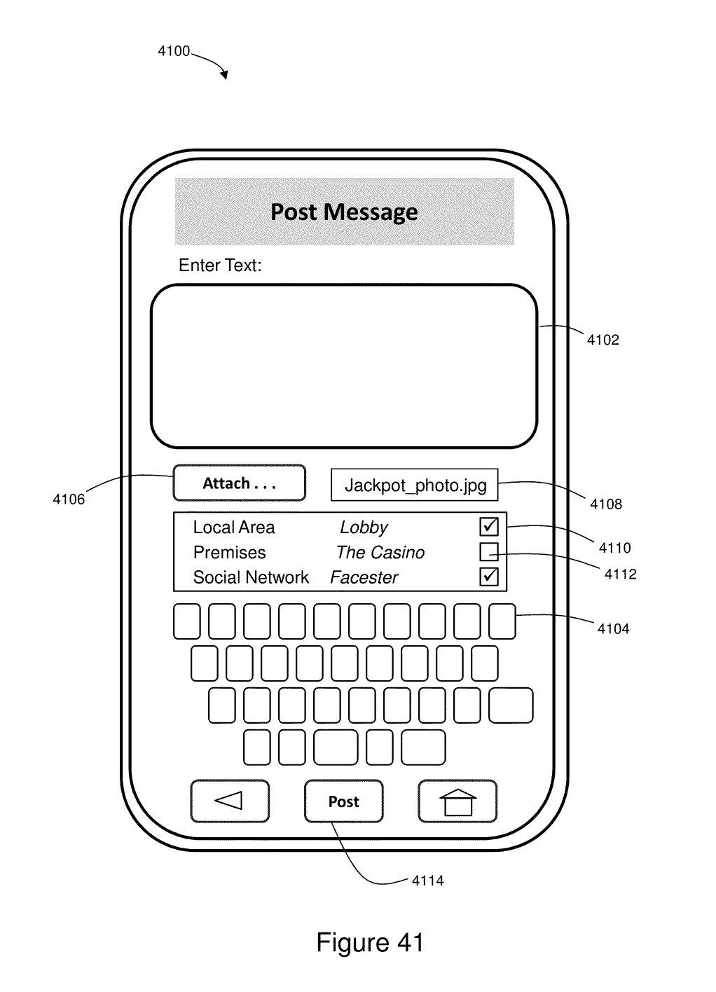

Referring now to FIG. 41, an illustrative user content input page 4100 of the device content interface is shown. User content input page comprises input window 4102. The user may enter text in the input window using an alphanumeric input, such as a keyboard, keypad, or the touchscreen alphanumeric interface shown at 4104. The user content input page may further comprise an attachment prompt such as the attach button shown at 4106. When the user activates the attach button, the user is prompted to enter the additional content, for example, by selecting a file or entering a URL. The file may be, for example, an image, video, audio, or other media supported by the user interface application. After the additional content is selected, the URL or name of the content file may be displayed, for example, in an additional content box as shown at 4108. The additional content is stored as a child content item of the user-created content item.

In some embodiments, one or more additional content items may be attached to a content item. The additional content box may display a list of items when more than one additional content items are attached to a content item.

When the user selects post button 4114, the user-created content item and additional content are transmitted to and stored in data storage module 1108. The user identification may be stored in association with the user-created content item. The user-created content item may be automatically stored in association with the geofence in which the device is located. Alternatively, the user may designate one or more destinations with which the user content item is to be associated. At 4110, the user is presented with the option of posting the user-created content item to 1) the geofence or “Local Area” in which the device is located, identified as “Lobby,” 2) the entire premises, identified as “The Casino” or 3) a social network, identified as “Facester.” The premises may comprise one or more geofences. In some embodiments, the user is presented with the option to designate one or more social networks to which the user-created content item is to be posted. The user may select posting destinations by selecting the checkbox 4112 located adjacent to the desired posting destination. When the user has finished entering content and designating posting destinations, the user may post the content by activating post button 4114.

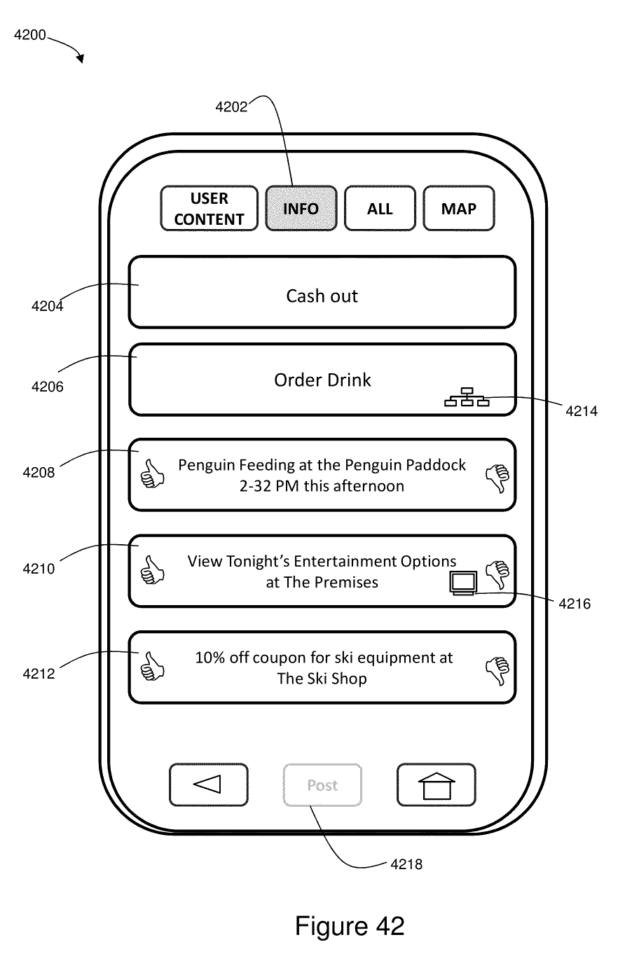

Referring now to FIG. 42, an illustrative “Info” page 4200 of the device content interface is shown. The info page displays premises content items that provide information about the premises, such as information about events, services, and promotions available on the premises. Unlike user content items, the content items on the info page are typically created by a content administrator affiliated with the premises. In FIG. 42, info button 4202 is highlighted, indicating that info is the selected item from the top menu. When the info menu item is selected, the user interface displays the info page. The info page comprises one or more premises content items. Illustrative premises content items 4204-4212 are displayed on the illustrative user content page. Premises content items may comprise timestamps and feedback input prompts.

Illustrative premises content item 4204 indicates a “Cash Out” service offered by the premises. If a user has been gambling and wishes to cash out, the user may select the content item 4204. When content item 4204 is selected, the application sends a message to data processing module 1104, the message comprising an identifier for the content item and a location message indicating the location of the wireless device. The data processing module interprets the identifier for the content item and alerts the premises of the cash out request and user location so that the user may be provided with the cash out service.

Premises content items may comprise additional content such as video, audio, images, external website links, maps, menus, and content to be shown on a display. In some embodiments, an icon is shown proximate to the premises content item to indicate a type of additional content associated with the premises content item. For example, icon 4214 is a parent link icon indicating that content item 4206 is a parent content item having a link to more than one child content item. Multiple child content items may be linked to a parent content item to create a menu. When the user selects premises content item 4206, the user is presented with a user interface page comprising a list of drink options. Each drink option may be a premises content item that is a child content item of the Order Drink parent content item. Icon 4216 is a display icon indicating that the additional content associated with content item 4210 will be shown on a display proximate to the wireless device when the content item is selected. When a user selects content item 4210, the wireless device sends a message to data processing module 1104, the message comprising an identifier for the content item and a location message indicating the location of the wireless device. The remote server interprets the identifier for the content item and sends the child content associated with the content item to a display proximate to the wireless device. Typically, the display is located in the same geofence within which the wireless device is located.

Because content items 4204 and 4206 indicate services offered by the premises that are always to be shown at the top of the menu, feedback inputs are not displayed in conjunction with these content items.

In FIG. 42, post control 4218 is shown grayed out to indicate that it cannot be selected by the user. Typically, the user is not enabled to post user content when the user interface is displaying the info page because the info page displays premises content items but not user-created content items.

Referring to FIG. 43, an illustrative “All” page 4300 of the device content interface is shown. The all page displays premises content items and user-created content items. The content items shown are typically the highest ranked content items as determined from the relevance weight value of content items filtered by one or more of attribute group, location and time. Alternatively, the content items shown may be a preset number of content items exceeding a predetermined threshold relevance weight value or all content items exceeding a predetermined threshold relevance weight value. Accordingly, the all page allows the user to view the most highly ranked content items from both the user content page and the info page. In FIG. 43, all button 4302 is highlighted, indicating that all is the selected item from the top menu. When the all menu item is selected, the user interface displays the all page.

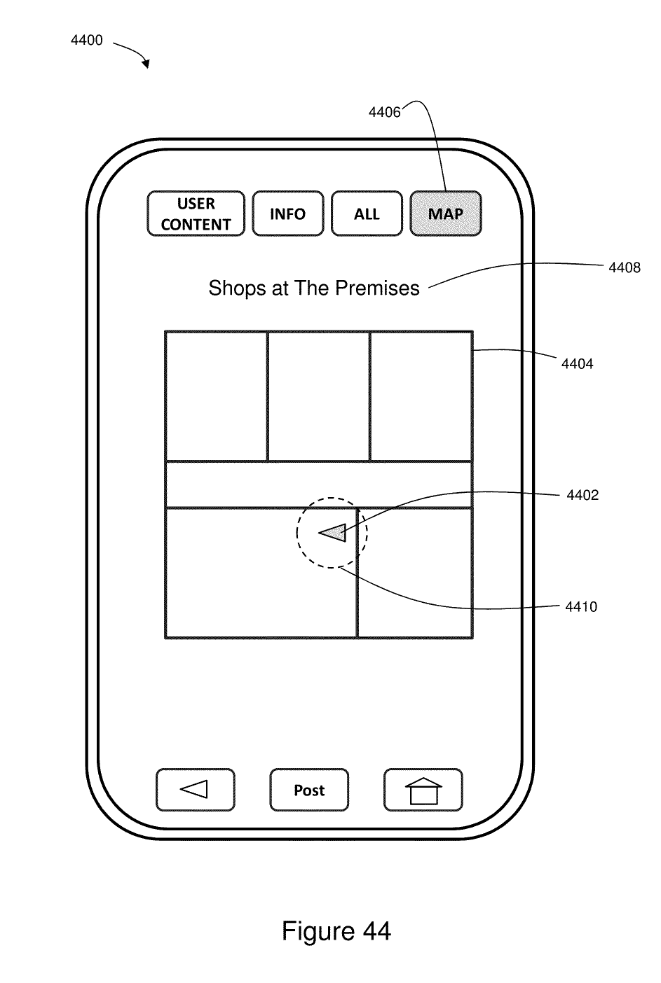

Referring now to FIG. 44, an illustrative map page 4400 of the device content interface is shown. The map page displays the user location 4402 on a premises map 4404. In FIG. 44, map button 4406 is highlighted, indicating that map is the selected item from the top menu. When the map menu item is selected, the user interface displays the map page.

The user location icon may be an arrow icon with the arrow indicating the direction of travel of the user, as shown at 4402. In some embodiments, the map shows radius 4410 that indicates a radius around the estimated location of the wireless device indicating the potential actual location of the wireless device. The radius may be based on a calculated margin of error for the calculated location of the wireless device. The map page may also comprise map title 4408.

In some embodiments, the interval at which a location message is sent from the wireless device to the remote server when the map page is shown is different from the interval at which the location message is sent when the other pages of the user interface are shown. Typically, a faster interval is required for updating the location on the map than is required for updating content items.

Referring now to FIG. 45, an illustrative user profile interface page 4500 is shown. In some embodiments, the user is prompted to register. The user may be prompted to register prior to viewing the device content interface for the first time, when attempting to post a comment for the first time, or at another time. The user is shown the user profile interface page, where the user is prompted to enter a display name in display name field 4502. The user may be prompted to enter additional information such as gender in gender field 4504, age group in age group field 4506, zip code in zip code field 4508 or other information including contact or demographic information and information about the user's interests. One or more fields may be required for the user registration submission to be accepted. If the user wishes to erase entered information, the user selects clear button 4510 and all entered information will clear. When all of the required information is entered, the user selects submit button 4512 to submit the information. When the submit button is selected, the entered user profile information is transmitted to data storage module 1108 and stored, for example, in a table having a structure illustrated in FIG. 30.

In some embodiments, the content items transmitted from the data processing module 1104 to the wireless device are filtered according to one or more fields of the user profile. For example, if the user entered “Female” in the gender field of the user profile, the remote server may filter the content items to select only those content items associated with the user attribute group gender female. The remote server then transmits the selected content items to the wireless device. The content items transmitted from the remote server to the wireless device may be further filtered by relevance weight value, such that a predetermined number of highest ranked content items are returned, or such that all content items exceeding a predetermined threshold are returned, or a predetermined number of content items exceeding a predetermined threshold are returned.

In an alternative embodiment, the content items transmitted from data processing module 1104 to the wireless device are filtered according to both geofence and one or more user attribute groups. For example, the remote server may filter the content items to select only those content items associated with the gender female and also associated with the geofence in which the wireless device is located. Relevance weight filtering may also be applied.

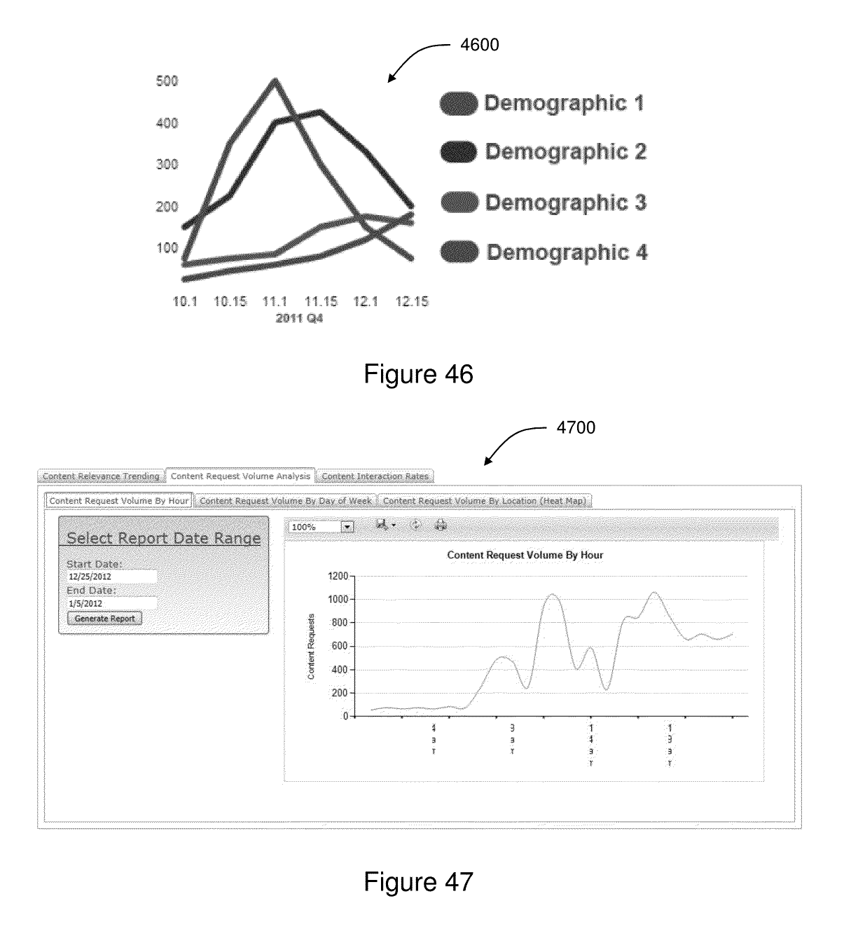

An illustrative set of business analytics are presented in FIG. 46-49. These business analytics assist in determining what end users determine as the most relevant content. Thus, an illustrative mobile marketer may determine that they need to adjust their messaging based on the particular trending of a content link.

Referring to FIG. 46, there is shown a time series plot of the relevance weight for a particular content link. The time series plot 4600 presents the popularity of a particular content link for four different demographic profiles. The time series plot 4600 is similar to the time series plot in FIG. 35B, however in FIG. 46, the time series is captured over a span of months, whereas in FIG. 35B the time series is captured over a span of minutes. Each demographic profile in FIG. 4600 is associated with user attributes that are collected from the user profiles.

In FIG. 47, there is shown the content requests for a particular content link over a particular date range. The content request volume plot 4700 identifies the total number of content requests that are made for an illustrative content link. The total number of requests provides the total number of requests, in hourly increments, for the illustrative link by all the end users.

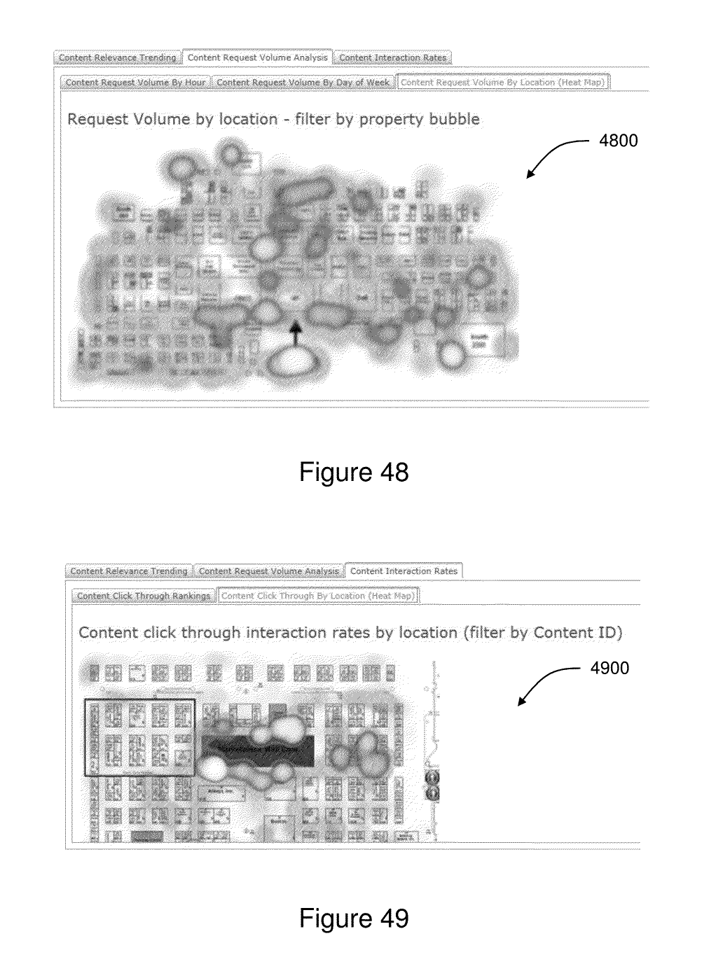

In FIG. 48 a heat map is presented of the request volume by location. The heat map 4800 shows the most active locations for content requests, which is also referred to as serving the MADGUI to a wireless device. The most active locations for serving the MADGUI are indicated in red and the least active locations show little or no color changes. The locations with intermediate activity may be presented with green and blue colors.

In FIG. 49 a heat map is presented of the content click through interaction rates by location. The heat map 4900 shows the most active locations where a click-through interaction, which is also referred to as a responsive input, is received for an illustrative content link. The most active locations are indicated in red and the least active locations show little or no color changes. The locations with intermediate activity may be presented with green and blue colors.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A system for serving relevant content comprising:
a wireless device configured to wirelessly communicate with a network, the wireless device configured to download a software application module;
at least one server communicatively coupled to the wireless device via the network, wherein the server authenticates the wireless device;
a positioning module integrated with the wireless device that is configured to determine a location for the wireless device;
a user profile module integrated with the wireless device, wherein the user profile module includes at least one user attribute that is associated with each particular user;
a content module stored on the wireless device, wherein the content module is configured to serve at least one content link that is associated with a content item;
a ranking content module integrated with the wireless device, wherein the ranking content module ranks each content link based on location of the wireless device and the user profile;
a content delivery module integrated with the wireless device, the content delivery module configured to deliver the ranked content links to the software application module associated with the wireless device;
a display corresponding to the wireless device, wherein the display presents the ranked content links in the software application module;
a responsive input received by the wireless device corresponding to one of the content links that results in displaying the corresponding content item; and
the server configured to periodically update the software application module with at least one of an updated positioning module, an updated content module, an updated user profile module, and an updated ranking module.

2. The system of claim 1 wherein the positioning module is configured to determine the indoor location of the wireless device, the ranking module is configured to rank each content link based on the indoor location of the wireless device, and the content delivery module delivers the ranked content links to the display as a plurality of content links that change autonomously based on the indoor location of the wireless device.

3. The system of claim 1 wherein the ranking module is configured to rank each content link based on the user profile for the wireless device, and the content delivery module delivers the ranked content links to the display as a plurality of content links that change autonomously based on the user profile associated with the wireless device.

4. The system of claim 1 wherein the responsive input is received by the user profile module and the user attribute is updated based on the responsive input and the ranking module adjusts the ranking of each content link based on the responsive input, and the content delivery module delivers the ranked content links to the display as a plurality of content links that change autonomously based on the responsive input.

5. The system of claim 1 wherein the server is configured to communicate with a plurality of wireless devices and each wireless device has a corresponding user profile, so that when a plurality of responsive inputs are generated by the plurality of wireless devices,
the responsive inputs received by the user profile module updates the user attribute for each user profile,
the ranking module adjusts the ranking of each content link based on the responsive inputs from the plurality of wireless devices, and
the content delivery module delivers the ranked content links to the display as a plurality of content links that change autonomously based on the responsive inputs from the plurality of wireless devices.

6. The system of claim 1 wherein the software application module includes a news feed that receives a plurality of content links and the content links change based on the location of the wireless device and the user profile associated with the wireless device.

7. The system of claim 1 wherein the content item served to the wireless device after receiving the responsive input includes,
a plurality of second level content links that do not change based on the location of wireless device; and
the second level content links change autonomously based on the user profile associated with the wireless device.

8. A system for serving relevant content comprising:
a wireless device configured to wirelessly communicate with a network, the wireless device configured to run a web browser;
at least one server communicatively coupled to the wireless device via the network, wherein the server authenticates at least one of the wireless device and the web browser;
a positioning module integrated with the wireless device configured to determine the location of at least one of the wireless device and the web browser;
a user profile module integrated with the wireless device, wherein each user profile includes at least user attribute that is associated with at least one of the wireless device and the web browser;
a content module integrated with the wireless device, the content module configured to communicate at least one content link that is associated with a content item;
a ranking content module integrated with the wireless device that ranks each content link based on the user profile and the location of the web browser;
a content delivery module integrated with the wireless device that is configured to deliver the ranked content links to the web browser associated with the wireless device;
a display corresponding to the wireless device, wherein the display presents the ranked content links as a web page on the web browser;
a responsive input received by the wireless device corresponding to one of the content links that results in displaying the corresponding content item; and
the server configured to periodically update the web browser with at least one of an updated positioning module, an updated content module, an updated user profile module, and an updated ranking module.

9. The system of claim 8 wherein the positioning module is configured to determine the indoor location of the wireless device, the ranking module is configured to rank each content link based on the indoor location of the wireless device, and the content delivery module delivers the ranked content links to the display as a plurality of content links on the web page that change autonomously based on the indoor location of the wireless device.

10. The system of claim 8 wherein the ranking module is configured to rank each content link based on the user profile, and the content delivery module delivers the ranked content links to the display as a plurality of content links on the web page that change autonomously based on the user profile.

11. The system of claim 8 wherein the responsive input is received by the user profile module and the user attribute is updated based on the responsive input and the ranking module adjusts the ranking of each content link based on the responsive input, and the content delivery module delivers the ranked content links to the display as a plurality of content links on the web page that change autonomously based on the responsive input.

12. The system of claim 8 wherein the server is configured to communicate with a plurality of wireless devices and each wireless device has a corresponding user profile, so that when a plurality of responsive inputs are generated by the plurality of wireless devices,
the responsive inputs received by each user profile module updates the user attribute for each user profile,
the ranking module adjusts the ranking of each content link based on the responsive inputs from the plurality of wireless devices, and
the content delivery module is updated so the ranked content links change autonomously based on the responsive inputs from the plurality of wireless devices.

13. The system of claim 8 wherein the software application module includes a news feed that receives a plurality of content links on the web page and the content links change based on the location of the wireless device and the user profile associated with the wireless device.

14. The system of claim 8 wherein the content item served to the wireless device after receiving the responsive input includes,
a plurality of second level content links that do not change based on the location of wireless device, and
the second level content links displayed on another web page change autonomously based on the user profile associated with the wireless device.

15. A digital signage system comprising:
a digital signage configured to communicate with a network, the digital signage configured to receive at least one of a digital signage downloadable software application module and a digital signage web browser;
a wireless device configured to wirelessly communicate with a network, the wireless device configured to receive at least one of a wireless device downloadable software application module and a wireless device web browser;
at least one server communicatively coupled to the wireless device and the digital signage via the network, wherein the server authenticates the wireless device and the digital signage;
the digital signage configure to perform operations that include assisting the determining the indoor positioning of the wireless device, accessing a user profile that corresponds to the wireless device, ranking content links based on the location of the wireless device and the user profile; and
the wireless device configured to provide a user interface that is configured to receive a responsive input to the ranked content links presented on the wireless device.

16. The digital signage system of claim 15 wherein the digital signage communicates the ranked content links to the server, which then communicates the ranked content links to the wireless device.

17. The digital signage system of claim 16 wherein the server introduces additional content to the ranked content links generated by the digital signage.

18. The digital signage system of claim 16 wherein the server anonymizes the responsive input to ranked content links communicated by the wireless device.

19. The digital signage system of claim 15 wherein the digital signage communicates the ranked content links directly to the wireless device.

20. The digital signage system of claim 15, wherein the digital signage is presented on a gaming machine having a picture-in-picture module that converts the gaming machine to digital signage.

21. The digital signage system of claim 20, wherein the gaming machine is communicatively coupled to a casino loyalty program.
